(19) United States
(12) Patent Application Publication
(10) Pub. No.: US 2026/0303297 A1
(43) Pub. Date: Oct. 1, 2026

(54) REFERENCE SIGNAL TRANSMISSION FOR MULTIPLE SERVICES

(71) Applicant: Lenovo (United States) Inc., Morrisville, NC (US)

(72) Inventors: Robin Rajan Thomas, Bad Nauheim (DE); Ahmed Hindy, Aurora, IL (US)

(73) Assignee: Lenovo (United States) Inc., Morrisville, NC (US)

(21) Appl. No.: 19/086,931

(22) Filed: Mar. 21, 2025

(51) Int. Cl. H04L 5/00; H04B 7/06; H04W 72/0446

(52) U.S. Cl. CPC H04L 5/0053; H04B 7/0626; H04W 72/0446

(57) ABSTRACT

Various aspects of the present disclosure relate to reference signal transmission for multiple services. A user equipment (UE) may receive signaling that indicates a subset of resources of a set of resources allocated for a reference signal transmission is associated with zero transmit power. The reference signal transmission is associated with a first service corresponding to communications at the UE (e.g., channel estimation and/or beamforming) and a second service corresponding to a location determination of the UE and/or one or more sensing targets (e.g., positioning and/or sensing). The UE performs one or more measurements based on the one or more resources. The measurements are for the second service. The UE transmits the one or more measurements associated with the second service to a network equipment (NE).

### TECHNICAL FIELD

The present disclosure relates to wireless communications, and more specifically to configuring reference signals.

### BACKGROUND

A wireless communications system may include one or more network communication devices, which may be otherwise known as network equipment (NE), supporting wireless communications for one or more user communication devices, which may be otherwise known as user equipment (UE), or other suitable terminology. The wireless communications system may support wireless communications with one or more user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive signaling that indicates a subset of resources of a set of resources allocated for a reference signal transmission is associated with zero transmit power (e.g., muted resources), where the reference signal transmission is associated with a first service corresponding to communications at the UE and a second service corresponding to a location determination of the UE and/or one or more sensing targets (e.g., a position of the UE and/or one or more sensing targets), perform, based on the set of resources, one or more measurements associated with the second service, and transmit the one or more measurements associated with the second service.

A processor (e.g., a standalone processor chipset, or a component of a UE) for wireless communication is described. The processor may be configured to, capable of, or operable to perform one or more operations as described herein. For example, the processor may be configured to, capable of, or operable to receive signaling that indicates a subset of resources of a set of resources allocated for a reference signal transmission is associated with zero transmit power, where the reference signal transmission is associated with a first service corresponding to communications at the UE and a second service corresponding to a location determination of the UE and/or one or more sensing targets, perform, based on the set of resources, one or more measurements associated with the second service, and transmit the one or more measurements associated with the second service.

A method performed or performable by a UE for wireless communication is described. The method may include receiving signaling that indicates a subset of resources of a set of resources allocated for a reference signal transmission is associated with zero transmit power, where the reference signal transmission is associated with a first service corresponding to communications at the UE and a second service corresponding to a location determination of the UE and/or one or more sensing targets, performing, based on the set of resources, one or more measurements associated with the second service, and transmitting the one or more measurements associated with the second service.

In some implementations of the UE, the processor, and the method described herein, the UE, the processor, and the method may further be configured to, capable of, or operable to receive additional signaling that indicates the reference signal transmission is scheduled within respective slots of a set of slots in a time domain, where the respective slots are associated with a single beam, and where the signaling indicates one or more resource elements (REs) of the respective slots including the subset of resources are associated with the zero transmit power and one or more slots of the set of slots including the subset of resources are associated with the zero transmit power. In some implementations of the UE, the processor, and the method described herein, at least one of one or more additional REs of the respective slots or one or more additional slots of the set of slots include an additional subset of resources of the set of resources that is associated with a non-zero transmit power, where the one or more additional REs are nonoverlapping with the one or more REs and the one or more additional slots are nonoverlapping with the one or more slots. In some implementations of the UE, the processor, and the method described herein, the UE, the processor, and the method may further be configured to, capable of, or operable to receive additional signaling that indicates the reference signal transmission is scheduled across respective slots of a set of slots in a time domain, where the respective slots are associated with a set of beams, and where the signaling indicates one or more slots of the respective slots including the subset of resources are associated with the zero transmit power. In some implementations of the UE, the processor, and the method described herein, one or more additional slots of the set of slots include an additional subset of resources of the set of resources that is associated with a non-zero transmit power, where the one or more additional slots are nonoverlapping with the one or more slots.

In some implementations of the UE, the processor, and the method described herein, to receive the signaling, the UE, the processor, and the method may further be configured to, capable of, or operable to transmit an indication of a capability of the UE to support at least one of the reference signal transmission being scheduled within respective slots of a set of slots in a time domain or the reference signal transmission being scheduled across the respective slots. In some implementations of the UE, the processor, and the method described herein, the signaling indicates respective priority values corresponding to an order to perform the one or more measurements, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources. In some implementations of the UE, the processor, and the method described herein, the UE, the processor, and the method may further be configured to, capable of, or operable to determine respective priority values corresponding to an order to perform the one or more measurements based on the reference signal transmission including a set of identifiers, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources. In some implementations of the UE, the processor, and the method described herein, the set of identifiers includes a reference signal identifier corresponding to the respective resources, a physical cell identity (PCI) corresponding to the respective resources, a cell global identity (CGI) identifier corresponding to the respective resources, a channel state information-reference signal (CSI-RS) resource identifier, an absolute radio frequency channel number (ARFCN), and a resource set identifier.

In some implementations of the UE, the processor, and the method described herein, the reference signal transmission is from a first NE, and where the UE, the processor, and the method may further be configured to, capable of, or operable to perform, based on an additional set of resources allocated for an additional reference signal transmission from a second NE, one or more additional measurements, where a subset of resources of the additional set of resources is within a threshold duration from the subset of resources of the set of resources, and where the subset of resources of the additional set of resources is associated with a non-zero transmit power, and transmit, to the second NE, the one or more additional measurements. In some implementations of the UE, the processor, and the method described herein, the first service includes at least one of a channel estimation service or a beamforming service, and where the second service includes at least one of a positioning service corresponding to a position of one or more target UEs or a sensing service corresponding to one or more objects (e.g., sensing targets) in an environment of the UE or in an absence of any UE. In some implementations of the UE, the processor, and the method described herein, the reference signal transmission includes at least one of a CSI-RS transmission, a synchronization signal block (SSB) transmission, or a sounding reference signal (SRS) transmission. In some implementations of the UE, the processor, and the method described herein, the signaling is received from an NE, and where the signaling includes at least one of downlink control information (DCI), radio resource control (RRC) signaling, a medium access control-control element (MAC-CE), a long-term evolution positioning protocol (LPP) signaling, a new radio positioning protocol (NRPPa) signaling, a new sensing protocol signaling, or an NE to NE interface protocol signaling.

An NE (e.g., a base station) for wireless communication is described. The NE may be configured to, capable of, or operable to perform one or more operations as described herein. For example, the NE may be configured to, capable of, or operable to transmit signaling that indicates a subset of resources of a set of resources allocated for a reference signal transmission is associated with zero transmit power, where the reference signal transmission is associated with a first service corresponding to communications at a UE and a second service corresponding to a location determination of the UE and/or one or more sensing targets, transmit, responsive to the signaling, the reference signal transmission using the set of resources allocated for the reference signal transmission, and receive, based on the set of resources, one or more measurements associated with the second service.

A processor (e.g., a standalone processor chipset, or a component of a UE) for wireless communication is described. The processor may be configured to, capable of, or operable to perform one or more operations as described herein. For example, the processor may be configured to, capable of, or operable to transmit signaling that indicates a subset of resources of a set of resources allocated for a reference signal transmission is associated with zero transmit power, where the reference signal transmission is associated with a first service corresponding to communications at a UE and a second service corresponding to a location determination of the UE and/or one or more sensing targets, transmit, responsive to the signaling, the reference signal transmission using the set of resources allocated for the reference signal transmission, and receive, based on the set of resources, one or more measurements associated with the second service.

A method performed or performable by an NE (e.g., a base station) for wireless communication is described. The method may include transmitting signaling that indicates a subset of resources of a set of resources allocated for a reference signal transmission is associated with zero transmit power, where the reference signal transmission is associated with a first service corresponding to communications at a UE and a second service corresponding to a location determination of the UE and/or one or more sensing targets, transmitting, responsive to the signaling, the reference signal transmission using the set of resources allocated for the reference signal transmission, and receiving, based on the set of resources, one or more measurements associated with the second service.

In some implementations of the NE, the processor, and the method described herein, the NE, the processor, and the method may further be configured to, capable of, or operable to select, prior to transmitting the signaling, at least one of to transmit the reference signal transmission within respective slots of a set of slots in a time domain or to transmit the reference signal transmission across the respective slots. In some implementations of the NE, the processor, and the method described herein, the NE, the processor, and the method may further be configured to, capable of, or operable to transmit additional signaling that indicates the reference signal transmission is scheduled within respective slots of a set of slots in a time domain, where the respective slots are associated with a single beam, and where the signaling indicates one or more REs of the respective slots including the subset of resources are associated with the zero transmit power and one or more slots of the set of slots including the subset of resources are associated with the zero transmit power. In some implementations of the NE, the processor, and the method described herein, at least one of one or more additional REs of the respective slots or one or more additional slots of the set of slots include an additional subset of resources of the set of resources that is associated with a non-zero transmit power, where the one or more additional REs are nonoverlapping with the one or more REs and the one or more additional slots are nonoverlapping with the one or more slots.

In some implementations of the NE, the processor, and the method described herein, the NE, the processor, and the method may further be configured to, capable of, or operable to transmit additional signaling that indicates the reference signal transmission is scheduled across respective slots of a set of slots in a time domain, where the respective slots are associated with a set of beams, and where the signaling indicates one or more slots of the respective slots including the subset of resources are associated with the zero transmit power. In some implementations of the NE, the processor, and the method described herein, one or more additional slots of the set of slots include an additional subset of resources of the set of resources that is associated with a non-zero transmit power, where the one or more additional slots are nonoverlapping with the one or more slots. In some implementations of the NE, the processor, and the method described herein, to transmit the signaling, the NE, the processor, and the method may further be configured to, capable of, or operable to receive, from the UE, an indication of a capability of the UE to support at least one of the reference signal transmission being scheduled within respective slots of a set of slots in a time domain or the reference signal transmission being scheduled across the respective slots.

In some implementations of the NE, the processor, and the method described herein, the signaling indicates respective priority values corresponding to an order to perform the one or more measurements, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources. In some implementations of the NE, the processor, and the method described herein, the reference signal transmission includes a set of identifiers, where the one or more measurements are associated with an angle of departure of the reference signal transmission, and where the set of identifiers includes a reference signal identifier corresponding to respective resources of the set of resources, a PCI corresponding to the respective resources, a CGI identifier corresponding to the respective resources, a CSI-RS resource identifier, an ARFCN, and a resource set identifier.

In some implementations of the NE, the processor, and the method described herein, the first service includes at least one of a channel estimation service or a beamforming service (e.g., or other communication-related services, including but not limited to mobility, interference management, time offset and/or frequency offset tracking, among other examples), and where the second service includes at least one of a positioning service corresponding to a position of one or more target UEs or a sensing service corresponding to one or more sensing targets (e.g., objects in an environment of the UE or in the absence of any UE). In some implementations of the NE, the processor, and the method described herein, the reference signal transmission includes at least one of a CSI-RS transmission, an SSB transmission, or an SRS transmission. In some implementations of the NE, the processor, and the method described herein, the signaling includes at least one of DCI, RRC signaling, a MAC-CE, an LPP signaling, an NRPPa signaling, a new sensing protocol signaling, or an NE to NE interface protocol signaling.

### BRIEF DESCRIPTION OF THE DRAWINGS

FIGS. 1 and 2 illustrate example of wireless communications systems in accordance with aspects of the present disclosure.

FIG. 3 illustrates an example of a time-frequency resource diagram, in accordance with aspects of the present disclosure.

FIG. 4 illustrates an example of a scenario for an aperiodic trigger state defining a list of CSI report settings, in accordance with aspects of the present disclosure.

FIG. 5 illustrates an example aperiodic trigger state indicating a resource set and quasi co-located (QCL) information, in accordance with aspects of the present disclosure.

FIG. 6 illustrates an example of an RRC configuration for non-ZP-CSI-reference signals (NZP-CSI-RSs), in accordance with aspects of the present disclosure.

FIG. 7 illustrates an example of an RRC configuration for CSI-interference management (CSI-IM) resources, in accordance with aspects of the present disclosure.

FIG. 8 illustrates an example of a scenario for partial CSI omission, in accordance with aspects of the present disclosure.

FIG. 9 illustrates an example of a CSI configuration, in accordance with aspects of the present disclosure.

FIGS. 10 through 16 illustrate examples of time-frequency resource diagrams, in accordance with aspects of the present disclosure.

FIG. 17 illustrates an example of a wireless communications system in accordance with aspects of the present disclosure

FIGS. 18 and 19 illustrate examples of resource diagrams, in accordance with aspects of the present disclosure.

FIGS. 20 through 22 illustrate examples of signaling diagrams, in accordance with aspects of the present disclosure.

FIG. 23 illustrates an example of a UE in accordance with aspects of the present disclosure.

FIG. 24 illustrates an example of a processor in accordance with aspects of the present disclosure.

FIG. 25 illustrates an example of an NE in accordance with aspects of the present disclosure.

FIG. 26 illustrates a flowchart of a method performed by a UE in accordance with aspects of the present disclosure.

FIG. 27 illustrates a flowchart of a method performed by an NE in accordance with aspects of the present disclosure.

### DETAILED DESCRIPTION

A wireless communications system may include one or more devices, such as UEs and NEs, that transmit and receive signaling. In some cases, the UE and the NE may support positioning services and/or sensing services, including the exchange of dedicated reference signals (e.g., positioning reference signals (PRSs)). The positioning services, also referred to as positioning operations, can include determining (e.g., by a UE or an NE) an absolute position of the UE or a position of the UE relative to the NE and/or to one or more other devices in the wireless communications system or one or more sensing targets in the wireless communication system. The sensing services, also referred to as sensing operations, can include determining (e.g., by the UE or the NE) an absolute position of a sensing target (e.g., an object in an environment of the UE or an object in the wireless communications system) or a position of the sensing target relative to the UE, the NE, another device, or another sensing target (e.g., another object in the wireless communications system). A sensing target may refer to sensing of an object, including organic or non-organic objects, among other examples. Exchanging dedicated reference signals to perform the positioning services and/or the sensing services leads to increased signaling overhead and inefficient use of communication resources that could otherwise be used to exchange other control signaling and/or data, referred to as communications services.

To reduce latency and improve resource allocation efficiency related to the positioning services and sensing services, the NE and the UE may use signaling, including one or more reference signals, used for communications to also indicate information for the positioning services and sensing services. For example, the NE and the UE may exchange tracking reference signals (TRSs) and/or other types of channel state information-reference signals (CSI-RSs) for managing time and frequency variations in signaling between the NE and the UE. However, the TRSs, CSI-RS, or other signaling may be sparse in the time domain and/or may be susceptible to interference when there are multiple transmitting devices in the wireless communications system, which leads to inaccurate information and inefficient positioning services and sensing services when the TRSs, CSI-RSs, or the other signaling is also used for the positioning services and sensing services.

As described herein, to reduce interference when there are multiple transmitting devices in the wireless communications system, an NE may configure a UE with a subset of resources (e.g., time and/or frequency resources) allocated for one or more reference signals that have zero transmit power. The resources that have zero transmit power may be referred to as muted resources. The UE and/or the NE may use the reference signals for a first service for communications at the UE and a second service for a location determination of the UE and/or one or more sensing targets. Examples of the first service include, but are not limited to, a channel estimation service or a beamforming service. Examples of the second service include, but are not limited to, a positioning service to determine a position of the UE or a sensing service to determine one or more sensing targets (e.g., objects in an environment of the UE or in an absence of any UE). The UE may perform measurements according to one or more reference signals that are sent using non-zero transmit power, such as UE reception-transmission time difference measurements, reference signal received power (RSRP) measurements, reference signal received path power (RSRPP) measurements, downlink reference signal time difference (RSTD) measurements, angle of arrival (AoA) measurements, reference signal carrier phase measurements, reference signal carrier phase difference measurements, Doppler measurements, Doppler difference measurements, path-based measurements, sample-based measurements, power delay profile measurements, angle delay profile measurements, Doppler range measurements, or Doppler delay measurements, among other examples. The resources allocated for the reference signals that have zero transmit power may not cause interference to the reference signals that are sent using non-zero transmit power. The UE can transmit the measurements to the NE for the first service and/or the second service (e.g., to establish or maintain communication services and/or for location related services, including positioning and sensing).

By performing the described techniques, a device in a wireless communications system can explicitly configure resources (e.g., time-frequency resources, spatial resources) with zero transmit power for reference signal transmissions (e.g., including repetitions) for different services. Allocating resources with zero transmit power for different services provides for an NE and/or a UE to reduce interference from an NE when there are multiple NEs transmitting the reference signals, while providing for the UE and/or the NE to perform reference signal measurements for multiple services using reference signals sent from another NE.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

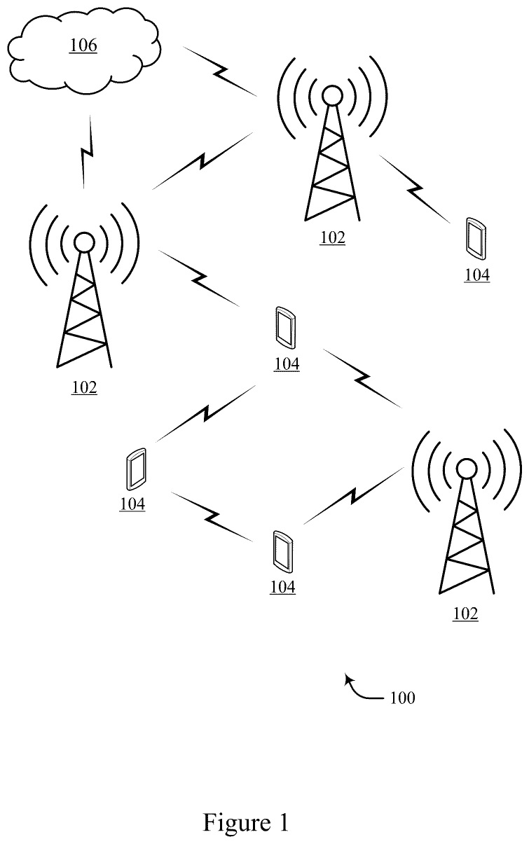

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or more radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or more operating frequency bands, such as frequency range designations Frequency Range 1 (FR1) (410 MHz-7.125 GHz), Frequency Range 2 (FR2) (24.25 GHz-52.6 GHz), Frequency Range 3 (FR3) (7.125 GHz-24.25 GHz), Frequency Range 4 (FR4) (52.6 GHz-114.25 GHz), Frequency Range 4a (FR4a) or Frequency Range 4-1 (FR4-1) (52.6 GHz-71 GHz), and Frequency Range 5 (FR5) (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or more numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or more numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, the wireless communications system 100 may include one or more transmission points (TPs), reception points (RPs), and/or one or more TRPs. A TP may include a set of geographically co-located transmit antennas (e.g., an antenna array with one or more antenna elements) for one cell, part of one cell, or one PRS TP. TPs can include base station (e.g., eNodeB) antennas, remote radio heads, a remote antenna of a base station, an antenna of a PRS TP, etc. One cell can be formed by one or more TPs. For a homogeneous deployment, each TP may correspond to one cell. An RP can include a set of geographically co-located receive antennas (e.g., an antenna array with one or more antenna elements) for one cell, part of one cell, or one uplink SRS RP. RPs can include base station (e.g., ng-eNB or gNB) antennas, remote radio heads, a remote antenna of a base station, an antenna of an uplink SRS RP, etc. One cell can include one or more RPs. For a homogeneous deployment, each RP may correspond to one cell. A TRP can include a set of geographically co-located antennas (e.g., an antenna array with one or more antenna elements) supporting TP and/or RP functionality. A PRS TP (e.g., a PRS-only TP) may include a TP that transmits PRS signals or downlink PRSs for PRS-based transport block size (TBS) positioning and may not be associated with a cell.

In some examples, the devices in the wireless communications system 100 may support multiple services. For example, the devices may support hybrid services. Hybrid services can be implemented in a joint, simultaneous (e.g., concurrent), or integrated manner without the services being considered to be independent or separate (e.g., joint communication and positioning or joint communication and sensing). Example services include, but are not limited to, services that support communications between the devices or services that support a location determination related to the devices or sensing targets. Services that support communications between devices may include channel estimation, beamforming, and link adaptation. For channel estimation, the devices can determine the quality and characteristics of a wireless channel between the devices. For example, a UE 104 may receive reference signals from an NE 102 and measure parameters, such as signal strength, delay spread, and frequency response to estimate the channel conditions. The UE 104 may then report the estimated channel conditions in a channel state information (CSI) report back to the NE 102, providing for the NE 102 to select transmission parameters for communications. Beamforming may be implemented by devices to focus the transmission and/or reception of signaling in one or more defined directions, improving signal quality and reducing interference. An NE 102 with multiple antenna elements may adjust the phase and amplitude of signals transmitted from each element to generate a focused beam towards a target UE 104. The NE 102 and UE 104 may engage in beam management procedures, where the devices exchange information about beam pairs to use for communications. Link adaptation provides for devices to dynamically adjust transmission parameters based on channel conditions. For example, an NE 102 may modify a modulation and coding scheme (MCS), transmit power, or a number of spatial layers used for transmission to a UE 104 based on reported channel quality indicators. The services may be implemented using various signaling, such as CSI-RS for channel estimation, SRS for uplink channel sounding, and downlink control information (DCI) for exchanging control information (e.g., a CSI report or other control information).

Services that support location determination may include positioning services and sensing services. Positioning services may include determining an absolute and/or a relative location of a UE 104 within a wireless network. In some cases, a target UE 104 may be referred to as a UE 104 of interest whose position (e.g., absolute or relative) is to be obtained by the NE 102 and/or by the UE 104. Reference made herein to a device or UE position or to location information may refer to either a two dimensional (2D) or three dimensional (3D) absolute position, a 2D or 3D relative position, a distance, a relative direction with respect to another node or entity, range in terms of distance, range in terms of direction, or any combination thereof. An NE 102 may transmit one or more reference signals, such as PRSs, that a UE 104 can measure to estimate a distance from multiple NEs 102. The UE 104 may report the measurements to one or more NEs 102, which can calculate the position of the UE 104 using the measurements. In some cases, the UE 104 may perform the position calculation using the measurements and additional information provided by the NEs 102. Sensing services may provide for devices to detect and characterize sensing targets (e.g., objects in an environment of the devices or in an absence of any devices). For example, an NE 102 or UE 104 may transmit signals and analyze the reflections to determine the presence, location, and movement of sensing targets (e.g., organic and/or non-organic objects). The devices may measure the time-of-flight and Doppler shift of reflected signals to estimate the range and velocity of sensing targets. The devices may implement signal processing techniques to extract location information from one or more reference signals. The signal processing techniques may include AoA estimation, time-difference-of-arrival (TDOA) measurements, or implementation of machine learning algorithms to improve location accuracy in environments with multipath propagation. In some cases, multiple NEs 102 may coordinate to perform positioning or sensing, including by performing time-synchronized transmission of reference signals from the multiple NEs 102, providing for more improved precision related to timing measurements and improved location accuracy.

In some examples, the devices may implement a beam management framework to perform beam selection and/or beam refinement. For example, beam selection may include an NE 102 sweeping a TRP beam and a UE 104 sweeping a UE beam. The UE 104 selects a beam (e.g., TRP beam measured by the UE beam) and reports the beam to the NE 102. The NE 102 may refine the beam (e.g., by sweeping a narrower beam over a narrower range) and the UE 104 detects a beam to report to the NE 102. The NE 102 fixes a beam (e.g., transmits on the same beam repeatedly) and the UE 104 refines a receiver beam. For example, the UE 104 sets a spatial filter on a receiver antenna array if the UE 104 supports beamforming.

A CSI report may include one or more parameters and/or quantities, including at least one of a CSI-RS resource index (CRI), an SSB resource index (SSBRI), a Layer 1 (L1)-RSRP, and and/or or a capability index. In some cases, if a parameter groupBasedBeamReporting is set to a value disabled, then the UE 104 reports K values of each report quantity. Additionally, or alternatively, if the parameter groupBasedBeamReporting is set to a value enabled, then the UE 104 reports two values of each report quantity for each CSI report setting, where the CSI-RS and/or SSB are received simultaneously at the UE 104 by either a same receive spatial filter or multiple simultaneous receive spatial filters. Additionally, or alternatively, if the UE 104 is configured with a parameter groupBasedBeamReporting-r17, then the UE 104 reports K groups of two values of each report quantity, with one CRI and/or SSBRI selected from each of the two CSI resource sets for the report setting, where the CSI-RS and/or SSB can be received simultaneously at the UE 104. Additionally, or alternatively, if the UE 104 is configured with a parameter groupBasedBeamReporting-v18 set to a value JointULandDL, then the UE 104 reports K groups of two values of each report quantity, with one CRI and/or SSBRI selected from each of the two CSI resource sets for the report setting, where the CSI-RS and/or SSB can be received simultaneously at the UE 104 and applied for simultaneous transmission with receive spatial filters and transmit spatial filters at the UE 104, respectively, subject to a capability of the UE 104. Additionally, or alternatively, if the UE 104 is configured with the parameter groupBasedBeamReporting-v18 set to a value ULOnly, then the UE 104 reports K groups of two values of each report quantity, with one CRI and/or SSBRI selected from each of the two CSI resource sets for the report setting, where the CSI-RS and/or SSB can be applied for simultaneous uplink transmission with transmit spatial filter at the UE 104, subject to a capability of the UE 104. For report quantities including RSRP, the UE 104 may not update measurements for more than a defined numerical quantity (e.g., 64) CSI-RS and/or SSB resources. If the UE 104 is configured with a configuration, CSI-ReportConfig with the higher layer parameter reportQuantity set to a value cri-RSRP-Index or ssb-Index-RSRP-Index, then an index of UE capability value set indicating the maximum supported number of SRS antenna ports is reported along with the pair of SSBRI and/or CRI and L1-RSRP.

In some examples, the terms antenna, panel, and antenna panel are used interchangeably. An antenna panel may be a hardware that is used for transmitting and/or receiving radio signals at frequencies lower than 6 GHz (e.g., frequency range 1 (FR1)) or higher than 6 GHz (e.g., frequency range 2 (FR2) or millimeter wave (mmWave)). In some cases, an antenna panel may include an array of antenna elements, where each antenna element is connected to hardware such as a phase shifter that provides for a control module to apply spatial parameters for transmission and/or reception of signals. The resulting radiation pattern may be referred to as a beam, which may or may not be unimodal and may provide for the device to amplify signals that are transmitted or received from spatial directions. In some cases, an antenna panel may or may not be virtualized as an antenna port. An antenna panel may be connected to a baseband processing module through a radio frequency (RF) chain for each of transmission (e.g., egress) and reception (e.g., ingress) directions. A capability of a device in terms of the number of antenna panels, duplexing capabilities, beamforming capabilities, and so on, may or may not be transparent to other devices. In some cases, capability information may be communicated via signaling or, in some cases, capability information may be provided to devices without signaling. In the case that such information is available to other devices, the capability information can be used for signaling or local decision making.

In some examples, a device (e.g., a UE 104, a node) antenna panel may be a physical or logical antenna array including a set of antenna elements or antenna ports that share a common or a relatively large portion (e.g., greater than a threshold) of an RF chain (e.g., in-phase/quadrature (I/Q) modulator, analog to digital (A/D) converter, local oscillator, phase shift network). The device antenna panel or device panel may be a logical entity with physical device antennas mapped to the logical entity. The mapping of physical device antennas to the logical entity may be up to device implementation. Communicating (e.g., receiving or transmitting) on at least a subset of antenna elements or antenna ports active for radiating energy (e.g., also referred to as active elements) of an antenna panel includes biasing or powering on of the RF chain, which leads to current drain or power consumption at the device associated with the antenna panel (e.g., including power amplifier/low noise amplifier (LNA) power consumption associated with the antenna elements or antenna ports). The phrase active for radiating energy, as used herein, is not meant to be limited to a transmit function but also encompasses a receive function. Accordingly, an antenna element that is active for radiating energy may be coupled to a transmitter to transmit RF energy or to a receiver to receive RF energy, either simultaneously or sequentially, or may be coupled to a transceiver, for performing intended functionality. Communicating on the active elements of an antenna panel enables generation of radiation patterns or beams.

In some cases, a device panel can have at least one of the following functionalities as an operational role of Unit of antenna group to control a transmit beam independently, Unit of antenna group to control a transmission power independently, or Unit of antenna group to control a transmission timing independently. The device panel may be transparent to an NE 102 (e.g., a gNB). For one or more conditions, an NE 102 can assume the mapping between physical antennas of a device to a logical entity device panel may not be changed. For example, the condition may include until the next update or report from device or include a duration of time over which the NE 102 assumes there will be no change to the mapping. A device may report a capability with respect to the device panel to the NE 102. The device capability may include at least the number of device panels. In some examples, the device may support uplink transmission from one beam within a panel. With multiple panels, more than one beam (e.g., one beam per panel) may be used for uplink transmission. In some other examples, more than one beam per panel may be supported and/or used for uplink transmission.

In some examples, an antenna port is defined such that the channel over which a symbol on the antenna port is conveyed can be inferred from the channel over which another symbol on the same antenna port is conveyed. Two antenna ports are said to be QCL if the large-scale properties of the channel over which a symbol on one antenna port is conveyed can be inferred from the channel over which a symbol on the other antenna port is conveyed. The large-scale properties include, but are not limited to, one or more of delay spread, Doppler spread, Doppler shift, average gain, average delay, or spatial receive parameters. Two antenna ports may be quasi-located with respect to a subset of the large-scale properties and different subset of large-scale properties may be indicated by a QCL type. The QCL type can indicate which channel properties are the same between the two reference signals (e.g., on the two antenna ports). Thus, the reference signals can be linked to each other with respect to what the UE 104 can assume about channel statistics or QCL properties. For example, a parameter qcl-Type may take a value, including, but not limited to, ‘QCL-TypeA’: {Doppler shift, Doppler spread, average delay, delay spread}, ‘QCL-TypeB’: {Doppler shift, Doppler spread}, ‘QCL-TypeC’: {Doppler shift, average delay}, or ‘QCL-TypeD’: {Spatial receive parameter}. Spatial receive parameters may include one or more of an AoA, a dominant AoA, an average AoA, an angular spread, a power angular spectrum (PAS) of an AoA, an average AoD, a PAS of an AoD, a transmit and/or receive channel correlation, a transmit and/or receive beamforming, a spatial channel correlation, etc. In some cases, the QCL-TypeA, QCL-TypeB and QCL-TypeC may be applicable for all carrier frequencies, but the QCL-TypeD may be applicable in higher carrier frequencies (e.g., mmWave, FR2 and beyond), where the UE 104 may not be able to perform omni-directional transmission (e.g., the UE 104 would form beams for directional transmission). For a QCL-TypeD between two reference signals A and B, the reference signal A is considered to be spatially co-located with reference signal B, and the UE 104 may assume that the reference signals A and B can be received with the same spatial filter (e.g., with the same receive beamforming weights).

An antenna port may be a logical port that may correspond to a beam (e.g., resulting from beamforming) or may correspond to a physical antenna on a device. In some cases, a physical antenna may map directly to a single antenna port, in which an antenna port corresponds to an actual physical antenna. In some other cases, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices. In some cases, a transmission configuration indication (TCI) state associated with a target transmission can indicate parameters for configuring a QCL relationship between the target transmission (e.g., target reference signal of a demodulation reference signal (DMRS) ports of the target transmission during a transmission occasion) and one or more source reference signals (e.g., SSB, CSI-RS, and/or SRS) with respect to one or more QCL type parameters indicated in the corresponding TCJ state. The TCJ state describes which reference signals are used as a QCL source, and the QCL properties that can be derived from each reference signal. A device can receive a configuration of a set of transmission configuration indicator states for a serving cell for transmissions on the serving cell. In some cases, a TCJ state includes at least one source reference signal to provide a reference (e.g., UE assumption) for determining QCL and/or spatial filter.

In some examples, a spatial relation information associated with a target transmission can indicate parameters for configuring a spatial setting between the target transmission and a defined reference signal (e.g., SSB, CSI-RS, and/or SRS). For example, the device may transmit the target transmission with the same spatial domain filter used for reception the defined reference signal (e.g., downlink RS such as SSB and/or CSI-RS). In some other examples, the device may transmit the target transmission with the same spatial domain transmission filter used for the transmission of the defined reference signal (e.g., an uplink reference signal, including an SRS). A device can receive a configuration of a set of spatial relation information configurations for a serving cell for transmissions on the serving cell. In some cases, an uplink TCJ state is provided if a device is configured with separate downlink and/or uplink TCJ by RRC signaling. The uplink TCJ state may include a source reference signal, which provides a reference for determining uplink spatial domain transmission filter for the uplink transmission (e.g., dynamic-grant/configured-grant based physical uplink shared channel (PUSCH), dedicated physical uplink control channel (PUCCH) resources) in a component carrier (CC) or across a set of configured CCs and/or bandwidth parts (BWPs). In some cases, a joint downlink/uplink TCJ state is provided if the device is configured with joint downlink/uplink TCJ by RRC signaling (e.g., configuration of joint TCJ or separate downlink/uplink TCJ is based on RRC signaling). The joint downlink/uplink TCJ state refers to at least a common source defined reference signal used for determining both the downlink QCL information and the uplink spatial transmission filter. The source reference signal determined from the indicated joint (e.g., or common) TCJ state provides QCL Type-D indication (e.g., for device-dedicated PDCCH/PDSCH) and is used to determine uplink spatial transmission filter (e.g., for UE-dedicated PUSCH/PUCCH) for a CC or across a set of configured CCs and/or BWPs. In some cases, the uplink spatial transmission filter is derived from the reference signal of downlink QCL Type D in the joint TCJ state. The spatial setting of the uplink transmission may be according to the spatial relation with a reference to the source reference signal configured with qcl-Type set to a value typeD in the joint TCJ state.

A positioning framework provides location services for advanced high positioning accuracy precision use cases, such as an indoor factory and V2X deployments. The implementation of the positioning framework may use dedicated infrastructure and signaling resources that are separate from communication services, leading to inefficient resource utilization and increased system complexity. The dedicated infrastructure and signaling resources for location services being separate from communication services leads to inefficient technical integration into existing communication networks. Thus, an NE 102 and/or other devices in the wireless communications system 100 may enable joint communication and non-communication or hybrid services (e.g., positioning, sensing, and communication under a unified framework). The integration provides for more efficient resource utilization by leveraging existing communication infrastructure and signals, such as using communication reference signals to perform positioning functions without using separate dedicated positioning signals.

A tracking reference signal (TRS), which may be an example of a CSI-RS for tracking, may be used to track and compensate for time and frequency variations of a local oscillator. The TRS represents a communication reference signal candidate to achieve similar positioning functionality criterion in terms of performing timing-based or angle-based measurements on the downlink. The current TRS framework, which is based on CSI-RS, may be enhanced from a physical layer configuration perspective to achieve the goals of hybrid services, (e.g., joint communication and positioning). For example, an NE 102 may enhance a time domain configuration of the TRS to improve the performance and reliability of timing-based measurement used for non-communication services, including location services. In some examples, a current TRS configuration is sparse in the time domain in terms of repetition configuration, as well as periodicity. The enhanced TRS configuration adapts the current TRS configuration for the location services to improve a lack of reliability of the transmission of a TRS in terms of an enhanced repetition configuration for performing positioning measurements. Additionally, or alternatively, the enhanced TRS configuration improves timing-based measurements and tracking of UE position by increasing the consecutive slot transmission, as well as reducing the periodicity of the TRS. Additionally, or alternatively the enhanced TRS configuration introduces aperiodic TRS transmissions, and an associated configurable slot offset, which can support one shot and/or dynamic positioning functionality.

In some examples, the NE 102 may enhance a current TRS configuration to support communication scenarios with multiple NEs 102 (e.g., multi-gNB, multi-TRP). For example, the enhanced TRS configuration may support measurements in the communication scenarios with multiple NEs 102, where the measurements are used for non-communication services and/or communication services. The non-communication services include positioning measurements, which use a paired time-of-arrival (TOA) from a serving and neighboring cell (e.g., downlink-RSTD measurement). The current TRS configuration is transmitted by a serving cell and therefore may be enhanced to enable adaptation of the current TRS configuration to perform positioning. The enhanced TRS configuration may reduce or prevent ambiguity in a TRS by introducing unambiguous identification of TRS resources from different cells. Additionally, or alternatively, the enhanced TRS configuration may improve a robustness of the TRS to inter-cell interference by enhancing the ability to mute resources to provide for a greater degree of control. Additionally, or alternatively, depending on a geometric dilution of precision (GDOP), the TRS resources (e.g., beams) from different TRPs originating from a same or different gNBs may be prioritized for a positioning measurement. The UE 104 may use the prioritization for angular-based positioning techniques, such as downlink-AoD.

The enhanced positioning framework may include a new CSI-RS bundle, including multiple CSI-RS symbols, that have correlation properties similar to those of PRS. The bundled CSI-RS can be used for positioning and/or communication. The enhanced positioning framework may include a modified CSI-RS sequence generation that enables a CSI-RS bundle to maintain relatively small cross correlation values for the sequences within the same set (e.g., less than a threshold cross correlation). Additionally, or alternatively, the enhanced positioning framework may include a set of CSI-RS resource mapping configurations that provide a reference signal bundle that is similar to PRS configurations. Additionally, or alternatively, the enhanced positioning framework may include a nested CSI-RS that enables partial reuse of a subset of reference signals for both channel measurements and positioning measurements concurrently or simultaneously.

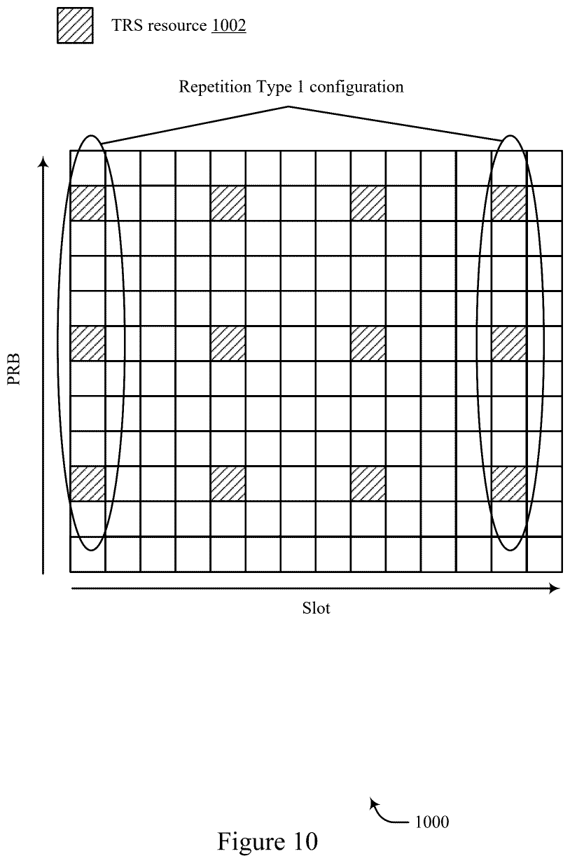

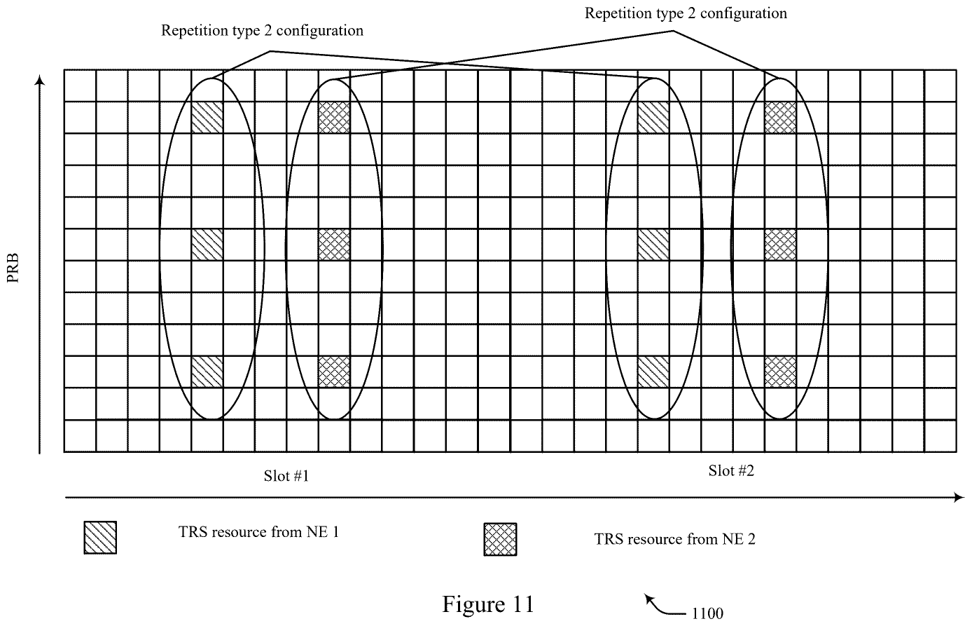

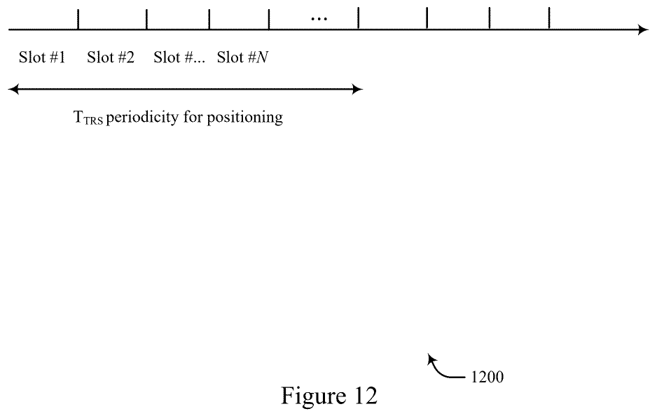

According to implementations, one or more of the NEs 102 and the UEs 104 are operable to implement various aspects of the techniques described with reference to the present disclosure. For example, a UE 104 may receive a repetition configuration for one or more reference signals (e.g., TRSs, SSBs, SRSs, a new sensing reference signal, and/or CSI-RSs, among other examples), which is described in further detail with respect to FIGS. 10 and 11. The UE 104 and/or the NE 102 may support reference signal consecutive slot transmissions and enhanced reference signal periodicity values for non-communication measurements (e.g., sensing and/or positioning measurements), which is described in further detail with respect to FIG. 12. Additionally, or alternatively, the UE 104 and/or the NE 102 may support aperiodic reference signal configurations for instantaneous or dynamic non-communication measurements, which is described in further detail with respect to FIG. 12.

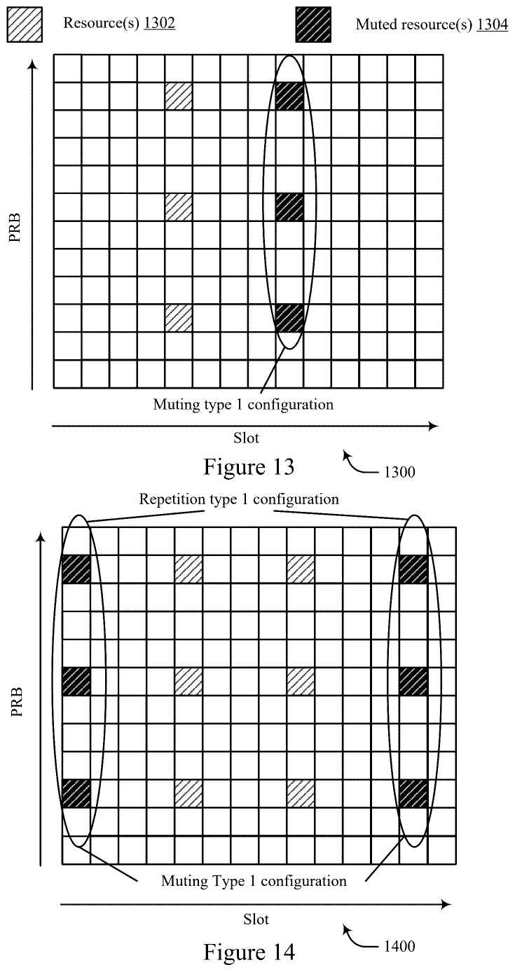

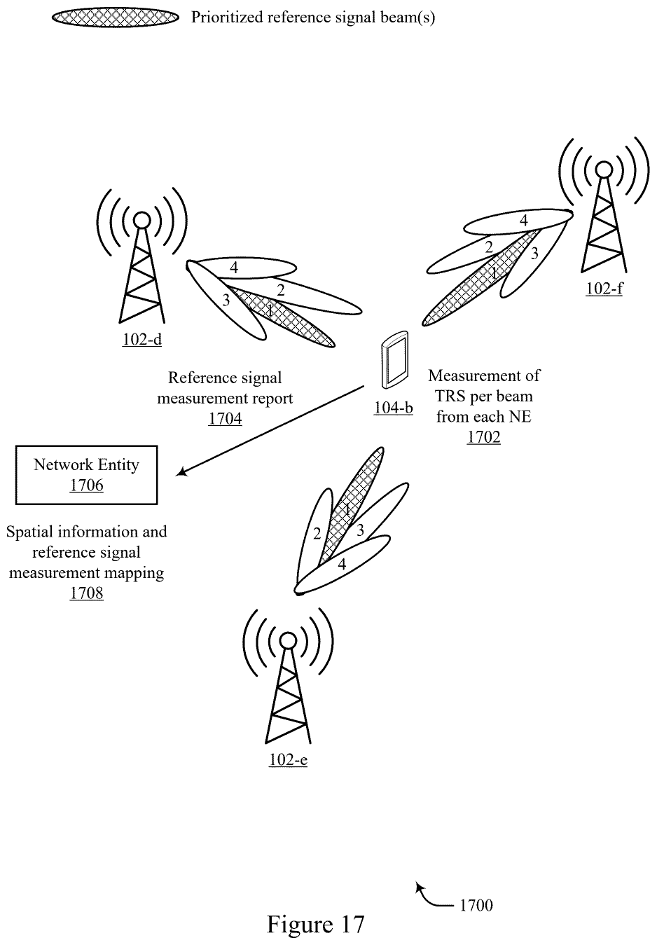

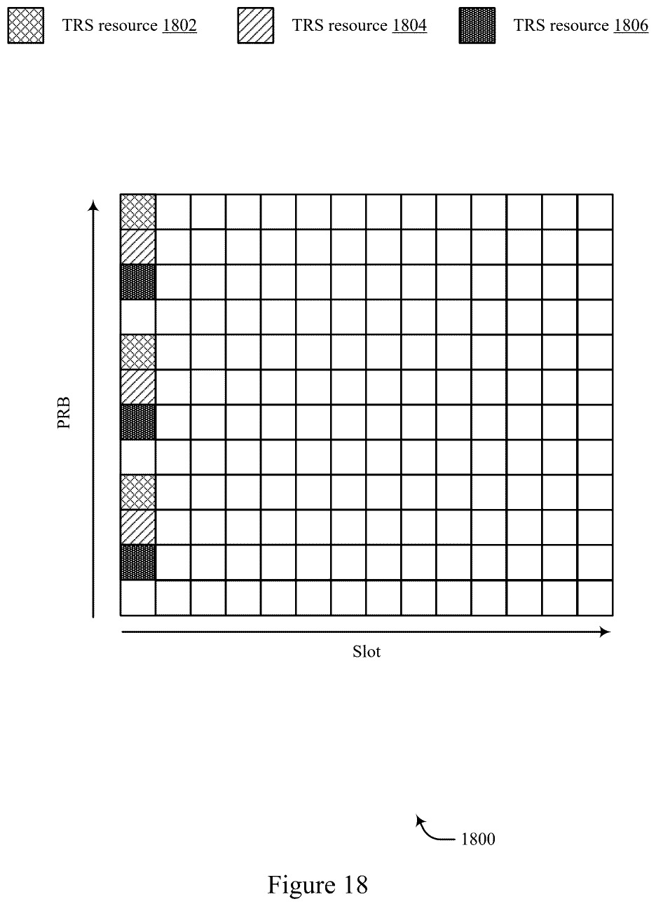

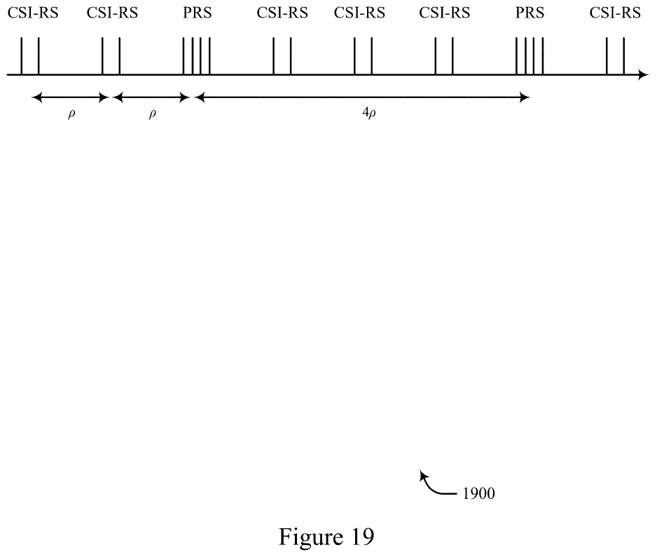

In some cases, a UE 104 may receive a muting configuration related to one or more reference signals (e.g., TRSs, SSBs, SRSs, and/or CSI-RSs, among other examples) for joint communication and non-communication services, which is described in further detail with respect to FIGS. 13 through 16. Additionally, or alternatively, the UE 104 and the NE 102 may support unambiguous identification of reference signals for joint communication and non-communication services for multi-cell and/or multi-gNB transmissions, which is described in further detail with respect to FIGS. 13 through 17. Additionally, or alternatively, the UE 104 and/or the NE 102 may support enhancing the efficient measurement of beams carrying reference signal resources based on the relative location of the target UE 104, which is described in further detail with respect to FIG. 17. The enhanced reference signal configuration for hybrid services is described in further detail with respect to FIGS. 18 and 19.

Although reference is made herein to the adaptation of TRSs or CSI resources for hybrid services, other communication reference signals may be adapted in addition to, or as an alternative to, TRSs and/or CSI resources (e.g., CSI-RSs, phase tracking reference signals (PTRSs), SSBs, sensing reference signals, and/or SRS, among other examples). Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

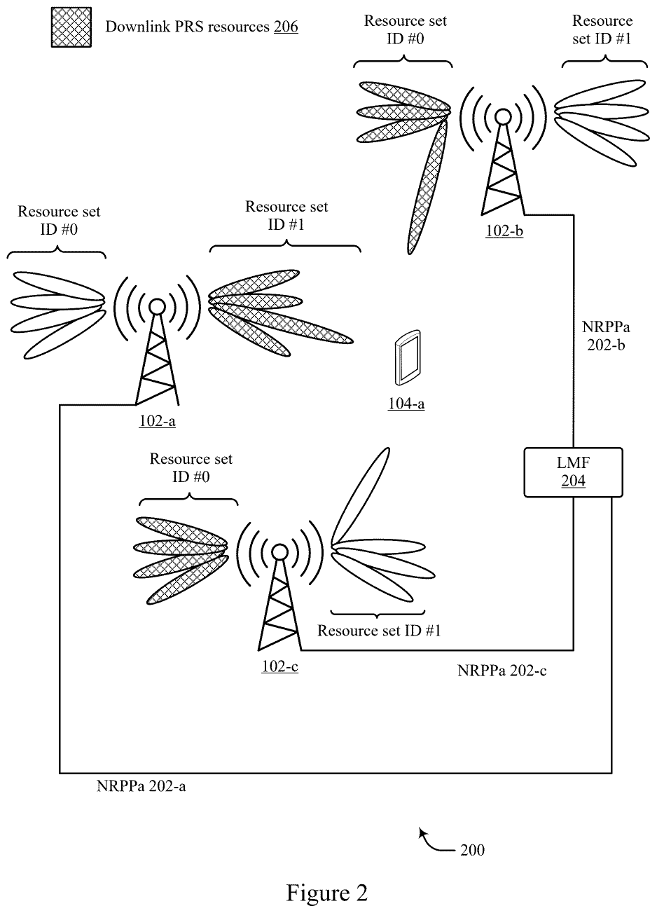

FIG. 2 illustrates an example wireless communications system 200 in accordance with aspects of the present disclosure. In some examples, the wireless communications system 200 implements or is implemented by aspects of the wireless communications system 100. For example, the wireless communications system 200 may include a UE 104-a, an NE 102-a, an NE 102-b, and an NE 102-c, which may be an example of a UE 104 and NEs 102 as described with reference to FIG. 1.

The UE 104-a and the NE 102-a may exchange signaling (e.g., control signaling and/or data) via an NRPPa interface 202-a. The UE 104-a and the NE 102-b may exchange signaling (e.g., control signaling and/or data) via an NRPPa interface 202-b. The UE 104-a and the NE 102-c may exchange signaling (e.g., control signaling and/or data) via an NRPPa interface 202-c. The wireless communications system 200 may use a protocol, such as an NRPPa, to support location services, including positioning and sensing, at one or more devices in the wireless communications system 200 (e.g., the UE 104-a, the NE 102-a, the NE 102-b, and/or the NE 102-c). NRPPa defines signaling procedures and information exchange between a location server (e.g., an LMF 204) and the NEs. The LMF 204 may be a network entity that manages and coordinates location-based services within the wireless communications system 200. In some cases, the LMF 204 may receive location measurements from the UE 104-a and the NEs, process the measurements, and calculate the position of the UE 104-a, the NEs 102, and/or one or more sensing targets (e.g., objects) in the wireless communications system 200. The LMF 204 may also manage the configuration and scheduling of PRSs across multiple NEs to support the location services.

In some cases, the UE 104-a may support one or more positioning techniques, as shown in Table 1. Assisted-global navigation satellite system (A-GNSS) may refer to a positioning method that combines satellite-based positioning with assistance data provided by the cellular network to improve location accuracy and reduce time-to-first-fix. Observed TDOA (OTDOA) may refer to a positioning technique including the UE 104-a measuring the time differences between signals received from multiple NEs to determine a location. Enhanced cell identifier (E-CID) may refer to a cell-based positioning technique that uses a cell identifier and additional measurements, such as timing advance and received signal strength, to improve location estimation accuracy. Sensor may refer to a positioning technique that uses various sensors at the UE 104-a, such as accelerometers, gyroscopes, and barometers, to estimate location or enhance other positioning techniques. Wireless land area network (WLAN) may refer to a positioning technique that uses Wi-Fi access points and known locations to determine the position of a device.

Bluetooth may refer to a positioning technique that uses Bluetooth beacons or other Bluetooth-enabled devices to estimate the location of a device. Terrestrial beacon system (TBS) may refer to a positioning technique that uses fixed terrestrial transmitters to broadcast signals for location determination, which can complement or augment other positioning techniques in areas where satellite or cellular signals may be reduced. Downlink TDOA may refer to a positioning technique including the UE 104-a measuring TDOA of signals from multiple NEs (e.g., the NE 102-a, the NE 102-b, and/or the NE 102-c). Downlink AoD may refer to a positioning technique that uses the AoD of signals from NEs (e.g., the NE 102-a, the NE 102-b, and/or the NE 102-c) to determine a location of the UE 104-a. Multi-round trip time (RTT) may refer to a positioning technique that measures the RTT of signals between the UE 104-a and multiple NEs (e.g., the NE 102-a, the NE 102-b, and/or the NE 102-c) to determine location information. NR E-CID may refer to a positioning technique adapted for 5G NR networks, using measurements and parameters defined for NR. Uplink TDOA may refer to a positioning technique where multiple NEs (e.g., the NE 102-a, the NE 102-b, and/or the NE 102-c) measure the TDOA of signals transmitted by the UE 104-a. Uplink AoA may refer to a positioning technique where multiple NEs (e.g., the NE 102-a, the NE 102-b, and/or the NE 102-c) measure the AoA of signals transmitted by the UE 104-a to determine a location of the UE 104-a.

TABLE 1
Supported UE positioning methods.

| | UE- | UE-assisted, | Next generation (NG)- | Secure user plane |
|---|---|---|---|---|
| Method | based | LMF-based | RAN node assisted | location (SUPL) |
| A-GNSS | Yes | Yes | No | Yes (UE-based and UE- |
| | | | | assisted) |
| OTDOA ^{Note1} | No | Yes | No | Yes (UE-assisted) |
| E-CID ^{Note 2} | No | Yes | Yes | Yes for E-UTRA (UE- |
| | | | | assisted) |
| Sensor | Yes | Yes | No | No |
| WLAN | Yes | Yes | No | Yes |
| Bluetooth | No | Yes | No | No |
| TBS | Yes | Yes | No | Yes (multicast- |
| | | | | broadcast service |
| | | | | (MBS)) |
| Downlink | Yes | Yes | No | No |
| TDOA | | | | |
| Downlink | Yes | Yes | No | No |
| AoD | | | | |
| Multi-RTT | No | Yes | Yes | No |
| NR E-CID | No | Yes | FFS | No |
| Uplink | No | No | Yes | No |
| TDOA | | | | |
| Uplink AoA | No | No | Yes | No |

^{Note1}:
This includes TBS positioning based on PRSs.
^{Note 2}:
This includes Cell-ID for NR method.

Separate positioning techniques as indicated in Table 1 can be currently configured and performed based on the criterion of the LMF and UE capabilities. The transmission of PRSs in downlink PRS resources 206 enables the UE 104-a to perform UE positioning-related measurements to enable the computation of a location estimate of the UE 104-a and are configured per TRP, where a TRP may transmit one or more beams. The PRSs can be transmitted by different NEs (e.g., serving and neighboring) using beams over FR1 and FR2, as illustrated in FIG. 2. The PRSs can be locally associated with a PRS resource identifier and a resource set identifier (e.g., resource set ID #0 and/or resource set ID #1) for an NE (e.g., TRP). The UE 104-a may perform one or more positioning measurements, such as RSTD and PRS RSRP measurements, on a per beam basis (e.g., based on the downlink PRS resources 206 or downlink PRS resource sets). Additionally, or alternatively, there are additional uplink positioning methods for the network to use to compute a location of the UE 104-a (e.g., a target UE). Table 2 and Table 3 show the reference signal to measurements mapping for each of the supported RAT-dependent positioning techniques at the UE 104-a and the NEs, respectively. RAT-dependent positioning techniques involve the RAT and CN entities to perform the position estimation of the UE 104-a, which are differentiated from RAT-independent positioning techniques that rely on GNSS, inertial measurement unit (IMU) sensor, WLAN, and Bluetooth technologies for performing target device (e.g., the UE 104-a) positioning.

TABLE 2
UE measurements to enable RAT-
dependent positioning techniques.

| Downlink/uplink | | Positioning |
|---|---|---|
| reference signals | UE measurements | techniques |
| Downlink PRS | Downlink RSTD | Downlink-TDOA |
| Downlink PRS | Downlink PRS | Downlink-TDOA, |
| | RSRP/RSRPP | Downlink-AoD, Multi- |
| | | RTT |
| Downlink PRS/SRS | UE receive-transmit | Multi-RTT |
| for positioning | time difference | |
| SSB/CSI-RS for | Synchronization signal | E-CID |
| radio resource | (SS)-RSRP(RSRP for | |
| management (RRM) | RRM), SS-RSRQ(for | |
| | RRM), CSI-RSRP (for | |
| | RRM), CSI-RSRQ (for | |
| | RRM), SS-RSRPB | |
| | (for RRM) | |

TABLE 3
NE measurements to enable RAT-
dependent positioning techniques.

| Downlink/uplink | | Positioning |
|---|---|---|
| reference signals | NE measurements | techniques |
| SRS for positioning | Uplink RTOA | Uplink-TDOA |
| SRS for positioning | Uplink SRS- | Uplink-TDOA, |
| | RSRP/SRS-RSRPP | Uplink-AoA, Multi- |
| | | RTT |
| SRS for positioning, | NE receive-transmit | Multi-RTT |
| DL PRS | time difference | |
| SRS for positioning | AoA and ZoA | Uplink-AoA, Multi- |
| | | RTT |

The different downlink measurements, including downlink PRS-RSRP, downlink RSTD, and UE receive-transmit time difference, are used for the supported RAT-dependent positioning techniques, as shown in Table 4. In some cases, four pairs of downlink RSTD measurements can be performed per pair of cells. Each measurement is performed between a different pair of downlink PRS resources 206 and/or resource sets with a single reference timing. In some examples, eight downlink PRS RSRP measurements and/or PRS RSRPP measurements can be performed on different downlink PRS resources from the same cell.

TABLE 4
Positioning measurement definitions for downlink-based and uplink-based positioning.
Downlink PRS-RSRP

| | |
|---|---|
| Definition | Downlink PRS-RSRP, is defined as the linear average over the power |
| | contributions (in Watts (W)) of the REs that carry downlink PRSs configured |
| | for RSRP measurements within the considered measurement frequency |
| | bandwidth. |
| | For FR1, the reference point for the downlink PRS-RSRP is the antenna |
| | connector of the UE 104-a. For FR2, downlink PRS-RSRP is measured based |
| | on the combined signal from antenna elements corresponding to a given |
| | receiver branch. For FR1 and FR2, if receiver diversity is in use by the UE |
| | 104-a, then the reported Downlink PRS-RSRP value is not lower than the |
| | corresponding downlink PRS-RSRP of any of the individual receiver branches. |
| Applicable for | RRC_CONNECTED intra-frequency, |
| | RRC_CONNECTED inter-frequency |

Downlink RSTD

| | |
|---|---|
| Definition | Downlink RSTD is the downlink relative timing difference between the |
| | positioning node j and the reference positioning node i, defined as T_{SubframeRxj} − |
| | T_{SubframeRxi}, where: |
| | T_{SubframeRxj} is the time when the UE 104-a receives the start of one subframe |
| | from positioning node j. |
| | T_{SubframeRxi} is the time when the UE 104-a receives the corresponding start of |
| | one subframe from positioning node i that is closest in time to the subframe |
| | received from positioning node j. |
| | Multiple downlink PRS resources 206 can be used to determine the start of one |
| | subframe from a positioning node. |
| | For FR1, the reference point for the downlink RSTD is the antenna connector of |
| | the UE 104-a. For FR2, the reference point for the downlink RSTD is the |
| | antenna of the UE 104-a. |
| Applicable for | RRC_CONNECTED intra-frequency |
| | RRC_CONNECTED inter-frequency |

UE receive-transmit time difference

| | |
|---|---|
| Definition | The UE receive-transmit time difference is defined as T_{UE-RX} − T_{UE-TX}, where: |
| | T_{UE-RX} is the UE received timing of downlink subframe #i from a TP, defined |
| | by the first detected path in time. |
| | T_{UE-TX} is the UE transmit timing of uplink subframe #j that is closest in time to |
| | the subframe #i received from the TP. |
| | Multiple Downlink PRS or CSI-RS for tracking resources, as instructed by |
| | higher layers, can be used to determine the start of one subframe of the first |
| | arrival path of the TP. The time of the beginning of a subframe is determined by |
| | assuming the time durations of the OFDM symbols at the receiver are the same. |
| | For FR1, the reference point for T_{UE-RX} measurement is the Rx antenna |
| | connector of the UE 104-a and the reference point for T_{UE-TX} measurement is |
| | the transmit antenna connector of the UE 104-a. For FR2, the reference point |
| | for T_{UE-RX} measurement is the Rx antenna of the UE 104-a and the reference |
| | point for T_{UE-TX} measurement is the transmit antenna of the UE 104-a. |
| Applicable for | RRC_CONNECTED intra-frequency |
| | RRC_CONNECTED inter-frequency |

Downlink PRS RSRPP

| | |
|---|---|
| Definition | Downlink PRS-RSRPP is defined as the power of the linear average of the |
| | channel response at the i-th path delay of the REs that carry downlink PRS |
| | signal configured for the measurement, where downlink PRS-RSRPP for the |
| | first path delay is the power contribution corresponding to the first detected path |
| | in time. |
| | For FR1, the reference point for the downlink PRS-RSRPP is the antenna |
| | connector of the UE 104-a. For FR2, downlink PRS-RSRPP is measured based |
| | on the combined signal from antenna elements corresponding to a given |
| | receiver branch. |
| Applicable for | RRC_CONNECTED, |
| | RRC_INACTIVE |

Uplink AoA

| | |
|---|---|
| Definition | Uplink AoA is defined as the estimated azimuth angle (A-AoA) and vertical |
| | angle (Z-AoA) of a UE 104-a with respect to a reference direction, where the |
| | reference direction is defined: |
| | In the global coordinate system (GCS), where A-AoA is measured |
| | relative to geographical north and is positive in a counterclockwise |
| | direction and estimated vertical angle is measured relative to zenith and |
| | positive to horizontal direction. |
| | In the local coordinate system (LCS), where A-AoA is measured relative |
| | to an x-axis of LCS and positive in a counterclockwise direction and |
| | estimated vertical angle is measured relative to z-axis of LCS and positive |
| | to x-y plane direction. The bearing, down tilt, and slant angles of LCS are |
| | defined. |
| | The uplink-AoA is determined at the NE antenna for an uplink channel |
| | corresponding to the UE 104-a. |

Uplink RTOA (T_{Uplink-RTOA})

| | |
|---|---|
| Definition | The T_{Uplink-RTOA} is the beginning of subframe i including SRS received at an RP |
| | j, relative to the RTOA reference time. |
| | The Uplink RTOA reference time is defined as T₀ + t_{SRS}, where |
| | T₀ is the nominal beginning time of system frame number (SFN) zero |
| | provided by SFN initialization time |
| | t_{SRS} = (10n_{f} + n_{sf}) × 10⁻³, where n_{f} and n_{sf} are the SFN and the |
| | subframe number of the SRS, respectively. |
| | Multiple SRS resources can be used to determine the beginning of one subframe |
| | including an SRS received at an RP. |
| | The reference point for T_{Uplink-RTOA} is: |
| | for a type 1-C NE: the receive antenna connector, |
| | for a type 1-O or 2-O NE: the receive antenna (e.g., the location of the |
| | radiating region of the receive antenna), |
| | for type 1-H NE: the receive transceiver array boundary connector. |

NE receive-transmit time difference

| | |
|---|---|
| Definition | The NE receive-transmit time difference is defined as T_{gNB-RX} − T_{gNB-TX}, where: |
| | T_{gNB-RX} is the TRP received timing of uplink subframe #i including an SRS |
| | associated with a UE 104-a, defined by the first detected path in time. |
| | T_{gNB-TX} is the TRP transmit timing of downlink subframe #j that is closest in |
| | time to the subframe #i received from the UE 104-a. |
| | Multiple SRS resources can be used to determine the start of one subframe |
| | including an SRS. |
| | The reference point for T_{gNB-RX} is: |
| | for a type 1-C NE: the receive antenna connector, |
| | for a type 1-O or 2-O NE: the receive antenna (e.g., the location of the |
| | radiating region of the receive antenna), |
| | for type 1-H NE: the receive transceiver array boundary connector. |
| | The reference point for T_{gNB-TX} is: |
| | for a type 1-C NE: the transmit antenna connector, |
| | for a type 1-O or 2-O NE: the transmit antenna (e.g., the location of the |
| | radiating region of the transmit antenna), |
| | for type 1-H NE: the transmit transceiver array boundary connector. |

Uplink SRS-RSRPP

| | |
|---|---|
| Definition | Uplink SRS-RSRPP is defined as the power of the linear average of the channel |
| | response at the i-th path delay of the REs that carry the received uplink SRS |
| | signal configured for the measurement, where uplink SRS-RSRPP for a first |
| | path delay is the power contribution corresponding to the first detected path in |
| | time |
| | The reference point for Uplink SRS-RSRPP is: |
| | for a type 1-C NE: the receive antenna connector, |
| | for a type 1-O or 2-O NE: the receive antenna (e.g. the location of the |
| | radiating region of the receive antenna), |
| | for type 1-H NE: the receive transceiver array boundary connector. |
| | For FR1 and FR2, if receiver diversity is in use by the NE for uplink SRS- |
| | RSRPP measurements: |
| | The reported uplink SRS-RSRPP value for the first and additional paths is |
| | provided for the same receiver branch(es) as applied for uplink SRS- |
| | RSRP measurements, or |
| | The reported uplink SRS-RSRPP value for the first path is not lower than |
| | the corresponding uplink SRS-RSRPP for the first path of any of the |
| | individual receiver branches and the reported uplink SRS-RSRPP for the |
| | additional paths is provided for the same receiver branch(es) as applied |
| | uplink SRS-RSRPP for the first path. |

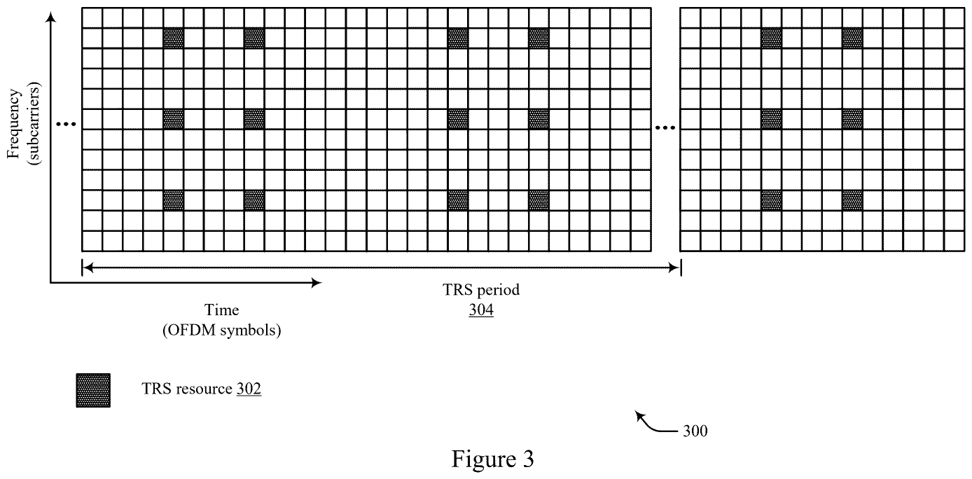

FIG. 3 illustrates an example of a time-frequency resource diagram 300 in accordance with aspects of the present disclosure. In some examples, the time-frequency resource diagram 300 implements or is implemented by aspects of the wireless communications system 100 and the wireless communications system 200. For example, the time-frequency resource diagram 300 may be implemented by a UE and an NE, which may be an example of a UE 104 and an NE 102, as described with reference to FIGS. 1 and 2. The time-frequency resource diagram 300 illustrates an example of one or more communication resources in the time and frequency domains. For example, the resources in the time domain include one or more OFDM symbols, while the resources in the frequency domain include one or more subcarriers. The OFDM symbols represent discrete time intervals during which signaling is transmitted using one or more subcarriers. Subcarriers are individual frequency components within a signal bandwidth that carry the signaling (e.g., data and/or control signaling).

In some examples, an NE may transmit one or more reference signals to a UE in control signaling, such that the UE may perform one or more services using the reference signals. For example, the NE may transmit a TRS and one or more repetitions of the TRS in one or more allocated or scheduled TRS resources 302. Scheduling may include an allocation of time-frequency locations of the transmitted reference signal with repetitions. A TRS is a type of CSI-RS used in wireless communication systems to enable precise tracking and synchronization between an NE and a UE. The NE may periodically transmit a TRS to assist one or more UE in maintaining accurate time and frequency synchronization. One or more UEs and/or NEs may use one or more TRS for various services, including time and frequency tracking, channel estimation, and mobility management. For example, a UE and/or an NE may use TRSs to perform fine timing synchronization, providing for the UE to accurately determine the start of OFDM symbols and maintain alignment with timing of the network. Additionally, or alternatively, the UE and/or the NE may use the TRSs for frequency offset estimation and correction, such that the UE and/or the NE can compensate for frequency drift that degrades communication quality. In some cases, the UE and/or the NE may use TRSs for channel estimation services, enabling more accurate assessment of channel conditions and facilitating improved link adaptation. The TRSs may also support mobility-related services, such as cell selection and handover procedures, by providing a reliable reference for measuring signal strength and quality from different NEs.

In some examples, to accurately receive downlink transmissions, a UE may adjust for time and frequency variations at a local oscillator. An NE can configure a TRS resource 302, which may include a set of one or more NZP-CSI-RS resources. NZP-CSI-RS resources may be used for various purposes in wireless communication systems. For example, they may be employed for channel quality assessment, where a UE measures the received signal strength and quality of NZP-CSI-RS transmissions to evaluate the current channel conditions. The UE may report the measured information related to the current channel conditions to the NE. A TRS resource 302 may include four CSI-RSs spread across two consecutive slots, with two CSI-RS per slot as shown in FIG. 3. The CSI-RSs are single-port and have a density, ρ, of three REs. The TRS resources 302 can also be configured with two CSI-RS within a single slot. The time separation of the CSI-RS within a slot reduces the compensable frequency error, while the frequency separation reduces the compensable timing error. The TRS resources 302 have a configurable periodicity, referred to as a TRS period 304, of 10, 20, 40, or 80 ms. FIG. 3 illustrates an example of a TRS time-frequency domain structure (e.g., single-port, ρ=3, two slot transmission). A TRS may have a relatively low signaling overhead (e.g., less than a threshold signaling overhead), uses a single antenna port, and is present in relatively few slots (e.g., less than a threshold number) within a TRS period 304.

The TRS resources 302 are configured for time and/or frequency tracking, as well as path delay spread and Doppler spread estimation. The TRS resources 302 are signaled (e.g., configured, scheduled, allocated) to a UE via a trs-Info RRC information element (IE) parameter. The UE determines the TRS is transmitted from the same antenna port as the configured NZP CSI-RS resources. In FR1, the TRS may include four CSI-RSs across two slots, while in FR2, the TRS may include either two CSI-RS in one slot or four CSI-RS across two slots. The CSI-RS within a TRS resource set (e.g., including one or more TRS resources 302) shares periodicity, bandwidth, and subcarrier location. The time-domain location is determined by the CSI-RS resources and RRC signaling. The TRS can be time-division multiplexed (TDM) with an SSB. Although reference is made herein to a TRS, an NE and/or a UE may additionally, or alternatively, exchange signaling including other types of reference signals, including, but not limited to, CSI-RSs other than TRSs, SSBs, SRSs, and the like.

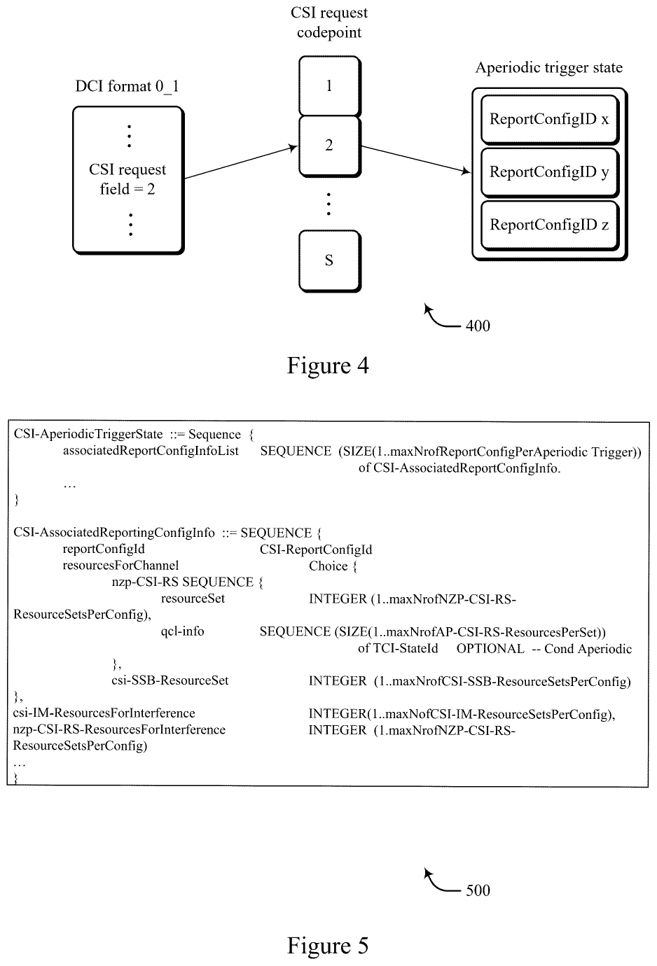

FIG. 4 illustrates an example of a scenario 400 for an aperiodic trigger state defining a list of CSI report settings, in accordance with aspects of the present disclosure. In some examples, the scenario 400 implements or is implemented by aspects of the wireless communications system 100, the wireless communications system 200, and the time-frequency resource diagram 300. For example, the scenario 400 may be implemented by a UE, which may be an example of a UE 104 as described with reference to FIG. 1.

In some cases, for CSI reporting, a codebook report is partitioned into two parts based on the priority of information reported. Each part is encoded separately (e.g., part 1 may have a higher code rate). Different types of codebooks (e.g., Type I codebook and/or Type II codebook) may include different of parameters. A CSI report for a Type II codebook may include, but is not limited to, a part 1 and a part 2. The part 1 may include a rank indicator (RI), a channel quality indicator (CQI), and a total number of coefficients. The part 2 may include a spatial domain basis indicator, a frequency domain basis indicator or layer, a bitmap or layer, a coefficient amplitude information or layer, a coefficient phase information or layer, and a strongest coefficient indicator or layer. Part 2 CSI can be decomposed into sub-parts, each with different priority (e.g., higher priority information listed first). Such partitioning provides for dynamic reporting size for codebook based on available resources in the uplink phase. A Type II codebook can be based on aperiodic CSI reporting and is reported in a PUSCH via DCI triggering. A Type I codebook can be based on periodic CSI reporting (e.g., PUCCH), semi-persistent CSI reporting (e.g., PUSCH or PUCCH), and/or aperiodic reporting (PUSCH).

In some cases, multiple CSI reports may be transmitted with different priorities, as shown in Table 5. The priority of a numerical quantity of repetitions, N_{Rep}, for CSI reports may be defined or configured. For example, a CSI report corresponding to one CSI reporting setting for one cell may have higher priority compared with another CSI report corresponding to one other CSI reporting setting for the same cell. Additionally, or alternatively, CSI reports intended for one cell may have higher priority compared with other CSI reports intended for another cell. Additionally, or alternatively, CSI reports may have higher priority based on the CSI report content (e.g., CSI reports carrying L1-RSRP information have higher priority). Additionally, or alternatively, CSI reports may have higher priority based on a type (e.g., whether the CSI report is aperiodic, semi-persistent or periodic, and whether the report is sent via PUSCH or PUCCH, may impact the priority of the CSI report). CSI reports may be prioritized according to Equation 1, where CSI reports with lower identifiers have a higher priority.

$$P r {i}_{iCSI} ( y , k , c , s ) = 2 \cdot {N}_{c e l l s} \cdot {M}_{s} \cdot y + {N}_{c e l l s} \cdot {M}_{s} \cdot k + {M}_{s} \cdot c + s , \qquad ( 1 )$$

where s is a CSI reporting setting index, M is a maximum number of CSI reporting settings, c is a cell index, N_{cells} is a number of serving cells, k has a value of 0 for CSI reports carrying L1-RSRP or L1-SNR and 1 otherwise, and y has a value of 0 for aperiodic reports, 1 for semi-persistent reports on PUSCH, 2 for semi-persistent reports on PUCCH, or 3 for periodic reports.

TABLE 5
Priority reporting levels for part 2 CSI

Priority 0: For CSI reports 1 to N_{Rep}, Group 0 CSI for CSI reports configured as typeII-r16 or
typeII-PortSelection-r16; Part 2 wideband CSI for CSI reports configured otherwise
Priority 1: Group 1 CSI for CSI report 1, if configured as typeII-r16 or typeII-PortSelection-r16;
Part 2 subband CSI of even subbands for CSI report 1, if configured otherwise
Priority 2: Group 2 CSI for CSI report 1, if configured as typeII-r16 or typeII-PortSelection-r16;
Part 2 subband CSI of odd subbands for CSI report 1, if configured otherwise
Priority 3: Group 1 CSI for CSI report 2, if configured as typeII-r16 or typeII-PortSelection-r16;
Part 2 subband CSI of even subbands for CSI report 2, if configured otherwise
Priority 4: Group 2 CSI for CSI report 2, if configured as typeII-r16 or typeII-PortSelection-r16.
Part 2 subband CSI of odd subbands for CSI report 2, if configured otherwise
.
.
.
Priority 2N_{Rep} − 1: Group 1 CSI for CSI report N_{Rep}, if configured as typeII-r16 or typeII-
PortSelection-r16; Part 2 subband CSI of even subbands for CSI report N_{Rep}, if configured
otherwise
Priority 2N_{Rep}: Group 2 CSI for CSI report N_{Rep}, if configured as typeII-r16 or typeII-
PortSelection-r16; Part 2 subband CSI of odd subbands for CSI report N_{Rep}, if configured
otherwise

In some cases, a UE may report CSI information to an NE using a configured or defined CSI framework. The triggering mechanism between a report setting and a resource setting is shown in Table 6.

TABLE 6
Triggering mechanism between a report setting and a resource setting.

| | | Periodic | Semi- | Aperiodic |
|---|---|---|---|---|
| | | CSI | persistent CSI | CSI |
| | | reporting | reporting | reporting |
| Time domain | Periodic | RRC configured | MAC CE (PUCCH) | DCI |
| resource | CSI-RS | | DCI (PUSCH) | |
| setting | Semi-persistent | Not Supported | MAC CE (PUCCH) | DCI |
| | CSI-RS | | DCI (PUSCH) | |
| | Aperiodic | Not Supported | Not Supported | DCI |
| | CSI-RS | | | |

In some cases, one or more (e.g., all) associated resource settings for a CSI report setting may have a same time domain behavior. Periodic CSI-RS and/or interference measurement (IM) resource and CSI reports are present and active once configured by RRC. Aperiodic and semi-persistent CSI-RS and/or IM resources and CSI reports may be explicitly triggered or activated. For aperiodic CSI-RS and/or IM resources and aperiodic CSI reports, the triggering is done jointly by transmitting a DCI Format 0-1. Semi-persistent CSI-RS and/or IM resources and semi-persistent CSI reports are independently activated.

For aperiodic CSI-RS and/or IM resources and aperiodic CSI reports, the triggering is done jointly by transmitting a DCI Format 0-1. The DCI Format 0_1 includes a CSI request field (e.g., 0 to 6 bits). A non-zero request field points to a so-called aperiodic trigger state configured by RRC, as shown in FIG. 4. An aperiodic trigger state in turn is defined as a list of up to 16 aperiodic CSI report settings, identified by a CSI report setting ID for which a UE calculates concurrently CSI and transmits the CSI on the scheduled PUSCH transmission. When the CSI report setting is linked with an aperiodic resource setting (e.g., includes multiple resource sets), the aperiodic NZP CSI-RS resource set for channel measurement, the aperiodic CSI-IM resource set (e.g., if used), and the aperiodic NZP CSI-RS resource set for IM (e.g., if used) to use for a given CSI report setting are also included in the aperiodic trigger state definition, which is described in further detail with respect to FIG. 5. For aperiodic NZP CSI-RS, the QCL source to use is also configured in the aperiodic trigger state. The UE determines that the resources used for the computation of the channel and interference can be processed with the same spatial filter (e.g., QCL with respect to “QCL-TypeD”).

Table 7 shows the type of uplink channels used for CSI reporting as a function of a CSI codebook type.

TABLE 7
Uplink channels used for CSI reporting
as a function of the CSI codebook type

| | Periodic CSI | SP CSI | AP CSI |
|---|---|---|---|
| | reporting | reporting | reporting |
| Type I | PUCCH Format | PUCCH Format 2 | PUSCH |
| wideband (SB) | 2, 3, 4 | PUSCH | |
| Type I | | PUCCH Format 3, 4 | PUSCH |
| subband (SB) | | PUSCH | |
| Type II WB | | PUCCH Format 3, 4 | PUSCH |
| | | PUSCH | |
| Type II SB | | PUSCH | PUSCH |
| Type II Part 1 | | PUCCH Format 3, 4 | |

FIG. 5 illustrates an example aperiodic trigger state 500 indicating a resource set and QCL information, in accordance with aspects of the present disclosure. In some examples, the aperiodic trigger state 500 implements or is implemented by aspects of the wireless communications system 100, the wireless communications system 200, the time-frequency resource diagram 300, and the scenario 400. For example, the aperiodic trigger state 500 may be sent from an NE to a UE, which may be an example of an NE 102 and a UE 104 as described with reference to FIG. 1. The aperiodic trigger state 500, for example, can be utilized for configuring CSI reported by UE. A UE may use the aperiodic trigger state 500 to generate and transmit CSI reports based on the described CSI framework.

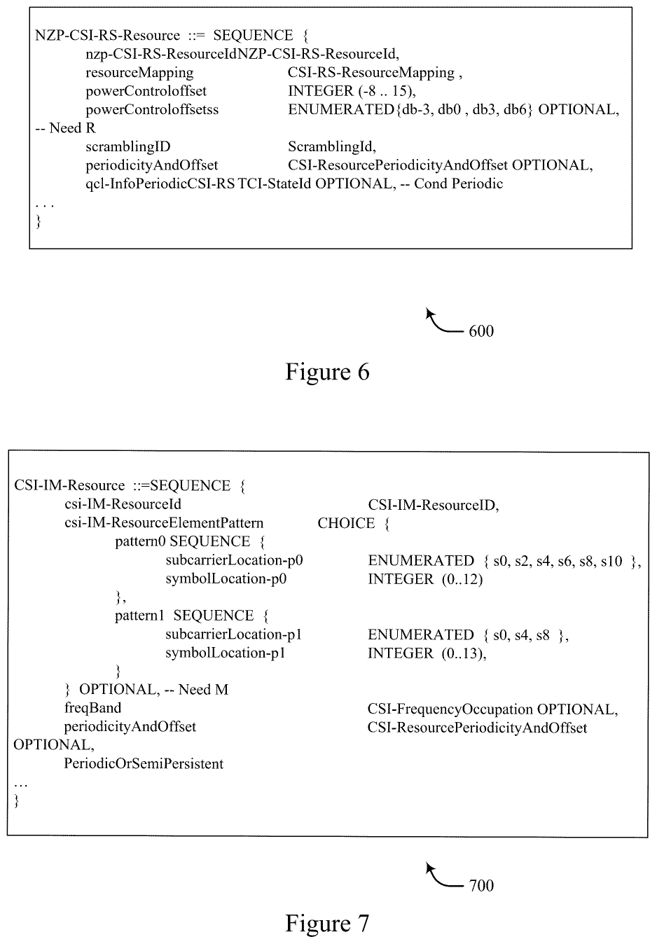

FIG. 6 illustrates an example of an RRC configuration 600 for NZP-CSI-RSs, in accordance with aspects of the present disclosure. In some examples, the RRC configuration 600 implements or is implemented by aspects of the wireless communications system 100, the wireless communications system 200, the time-frequency resource diagram 300, the scenario 400, and the aperiodic trigger state 500. For example, the RRC configuration 600 may be sent from an NE to a UE, which may be an example of an NE 102 and a UE 104 as described with reference to FIG. 1. In some examples, the RRC configuration 600 can be used by a UE to identify NZP-CSI-RS resources, such as NZP-CSI-RS resources that correspond to one or more beams that a UE uses to receive signaling.

FIG. 7 illustrates an example of an RRC configuration 700 for CSI-IM resources, in accordance with aspects of the present disclosure. In some examples, the RRC configuration 700 implements or is implemented by aspects of the wireless communications system 100, the wireless communications system 200, the time-frequency resource diagram 300, the scenario 400, the aperiodic trigger state 500, and the RRC configuration 600. For example, the RRC configuration 700 may be sent from an NE to a UE, which may be an example of an NE 102 and a UE 104 as described with reference to FIG. 1. The RRC configuration 700 can be used to identify IM resources, such as for identifying and managing signal interference between an NE and a UE.

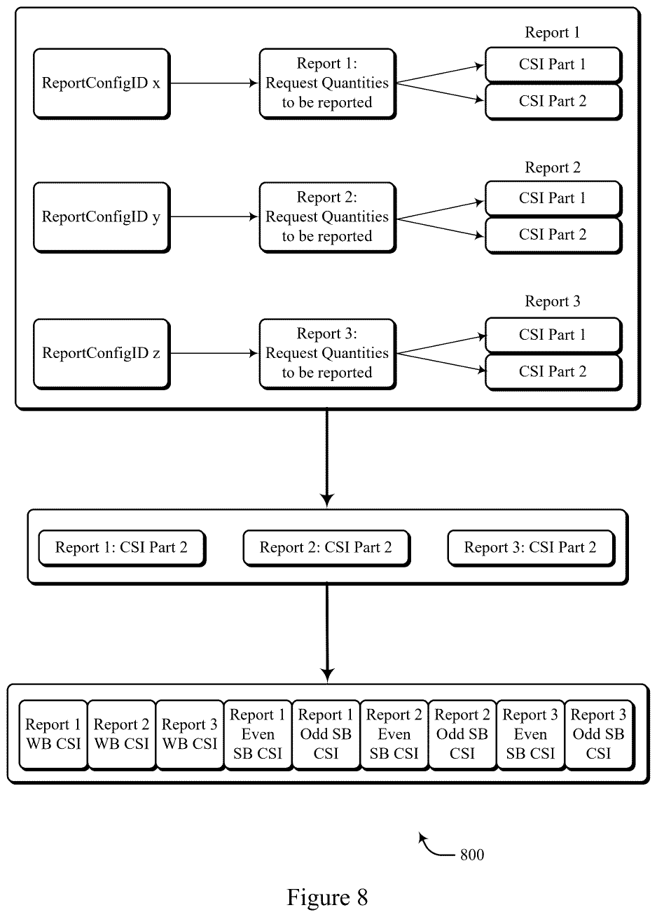

FIG. 8 illustrates an example of a scenario 800 for partial CSI omission, in accordance with aspects of the present disclosure. In some examples, the scenario 800 implements or is implemented by aspects of the wireless communications system 100, the wireless communications system 200, the time-frequency resource diagram 300, the scenario 400, the aperiodic trigger state 500, the RRC configuration 600, and the RRC configuration 700. For example, the scenario 800 may be implemented by an NE and/or a UE, which may be an example of an NE 102 and a UE 104 as described with reference to FIG. 1. The scenario 800, for example, illustrates a packing order of CSI parts within the CSI report to be transmitted within uplink control information (UCI). The CSI measured from one or more reference signals is mapped to one or more CSI reports, where the packing of the CSI is as illustrated in the scenario 800.

For aperiodic CSI reporting, PUSCH-based reports are divided into two CSI parts, including CSI Part 1 and CSI Part 2. The size of CSI payload varies, and therefore a worst-case UCI payload size design may lead to a relatively large signaling overhead (e.g., greater than a threshold signaling overhead). In some cases, CSI Part 1 has a fixed payload size and can be decoded by an NE without prior information. The CSI Part 1 may include, but is not limited to, an RI (e.g., if reported), CRI (e.g., if reported), CQI for a first codeword, and a number of non-zero wideband amplitude coefficients per layer for Type II CSI feedback on PUSCH. CSI Part 2 has a variable payload size that can be derived from the CSI parameters in CSI Part 1 and includes PMI and the CQI for the second codeword (e.g., when RI>4). For example, if the aperiodic trigger state indicated by DCI format 0_1 defines 3 report settings x, y, and z, then the aperiodic CSI reporting for CSI part 2 will be ordered as indicated in FIG. 8.

CSI reports may be prioritized according to time-domain behavior and physical channel, where more dynamic reports are given precedence over less dynamic reports and PUSCH has precedence over PUCCH. Additionally, or alternatively, CSI reports may be prioritized according to CSI content, where beam reports (e.g., L1-RSRP reporting) has priority over other CSI reports. Additionally, or alternatively, CSI reports may be prioritized according to a serving cell to which the CSI corresponds (e.g., in case of carrier aggregation (CA) operation). A CSI corresponding to a primary cell (PCell) may have priority over CSI corresponding to one or more secondary cells (Scells). Additionally, or alternatively, CSI reports may be prioritized according to the reportConfigID parameter.

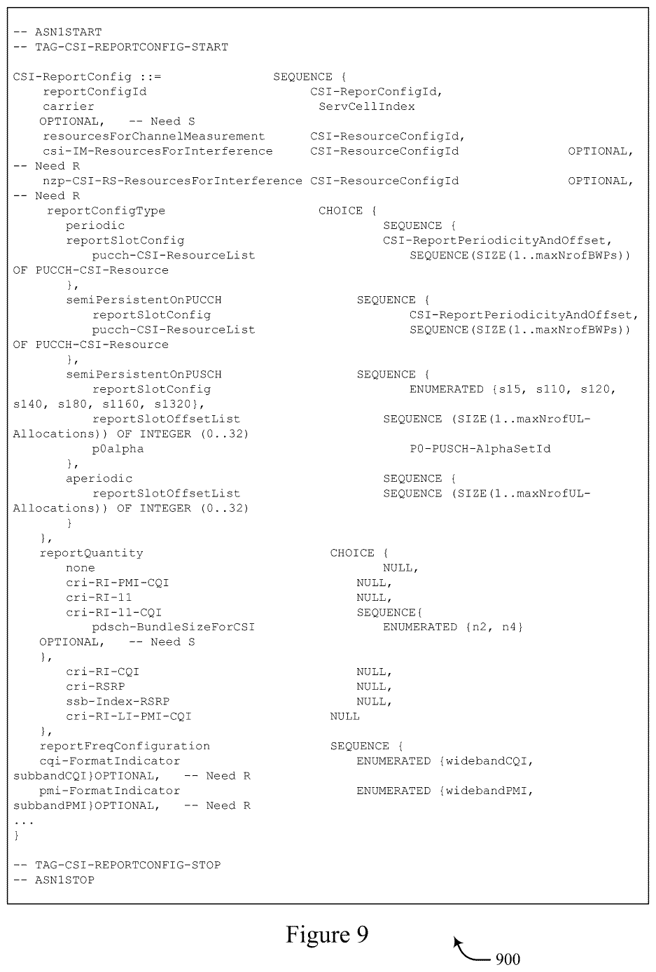

FIG. 9 illustrates an example of a CSI configuration 900 in accordance with aspects of the present disclosure. In some examples, the CSI configuration 900 implements or is implemented by aspects of the wireless communications system 100, the wireless communications system 200, the time-frequency resource diagram 300, the scenario 400, the aperiodic trigger state 500, the RRC configuration 600, the RRC configuration 700, and the scenario 800. For example, the CSI configuration 900 may be sent from an NE to a UE, which may be an example of an NE 102 and a UE 104 as described with reference to FIG. 1. The CSI configuration 900 can be used to configure a UE with CSI measurements based on resources for channel measurement (e.g., resourcesForChannelMeasurement). For example, the NE may transmit the CSI configuration 900 to the UE. In some cases, each CSI reporting setting is associated with an identifier (e.g., reportConfigId). The CSI reporting setting may additionally, or alternatively, be configured with a CSI report quantity (e.g., reportQuantity), including values from none, and other values including at least PMI.

FIG. 10 illustrates an example of a time-frequency resource diagram 1000 in accordance with aspects of the present disclosure. In some examples, the time-frequency resource diagram 1000 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, and the CSI configuration 900. For example, the time-frequency resource diagram 1000 may be implemented by an NE or a UE, which may be an example of an NE 102 and a UE 104 as described with reference to FIG. 1. For example, the NE may configure the UE to perform CSI-RS repetition type 1 for non-communication based measurements.

The NE may transmit a new configuration enhancement for CSI-RS to a UE. The new configuration enhancement is defined for a TRS (e.g., a CSI-RS for tracking purposes) to enable repetitions of the transmitted reference signal according to different methods. In some cases, a current communication framework related to time-frequency offset estimation may not support repetitions. For a non-data or a non-communication service (e.g., positioning or sensing), the use of repetitions of one or more reference signals leads to an enhanced or more accurate positioning or sensing measurement. In some examples, the new configuration enhancement may provide for a UE and/or an NE to support repetitions within a TRS resource 1002 (e.g., TRS repetitions within a beam sweep). Additionally, or alternatively, the new configuration enhancement may provide for the UE and/or the NE to support repetitions of one or sweeps of one or more TRS resources 1002.

In some cases, an NE may transmit one or more repetitions within a defined TRS resource 1002, where a TRS resource 1002 may be associated to a beam within a slot, which is referred to as a repetition type 1 configuration. FIG. 10 is an exemplary diagram of the method in which a TRS resource may configured based on a repetition type 1 configuration. The repetition configuration can also be enhanced to map out the additional REs which are occupied by TRS due to the repetition type 1 configuration. In some cases, the NE may transmit (e.g., to one or more UEs) a physical mapping of the CSI-RS locations within a slot in the repetition type 1 configuration, where k₀ and l₀ refer to the reference location of CSI-RS in the time and frequency domain, respectively. The UE and/or the NE may select kᵢ based on the bitmap [b₃, b₂, b₁, b₀], kᵢ=f(i), where f(i) is the bit position in the bitmap set to value 1 (e.g., assuming the bitmap is set to [1 0 0 0], then the subcarrier k₀=3 corresponding to the third bit position set to 1). The UE and/or the NE may select l₀ from the set of {0, . . . , 13} defined by the IE firstRepetitionType1OFDMSymbollnTimeDomain. In row 1-1 shown in FIG. 10, the bitmap is set to [1 0 0 0], indicating that k₀=3 and l₀=0. In row 1-2 shown in FIG. 10, the bitmap is set to [1 0 0 0], indicating that k₀=3 while l₀=4 is the same as the original TRS configuration in row 1 without repetition. The physical mapping is based on the parameters from Table 8.

TABLE 8
Example of CSI-RS locations with repetition
type 1 configuration appliable to TRS

| | | | | | CDM | | | |
|---|---|---|---|---|---|---|---|---|
| | Ports | Density | cdm- | | group | | | Repetition |
| Row | X | ρ | Type | (k̅, l̅) | index j | k′ | l′ | Type1 |
| 1 | 1 | 3 | noCDM | (k₀, l₀), (k₀ + | 0, 0, 0 | 0 | 0 | No |
| | | | | 4, l₀), (k₀ + 8, l₀) | | | | |
| | | | | (k₀, l₀ + 4), (k₀ + | | | | |
| | | | | 4, l₀ + 4), (k₀ + | | | | |
| | | | | 8, l₀ + 4) | | | | |
| 1-1 | 1 | 3 | noCDM | (k₀, l₀), (k₀ + | 0, 0, 0 | 0 | 0 | Yes |
| | | | | 4, l₀), (k₀ + 8, l₀) | | | | (two |
| | | | | (k₀, l₀ + 12), (k₀ + | | | | additional |
| | | | | 4, l₀ + 12), (k₀ + | | | | repetitions) |
| | | | | 8, l₀ + 12) | | | | |
| 1-2 | 1 | 3 | noCDM | (k₀, l₀ − 4), (k₀ + | 0, 0, 0 | 0 | 0 | Yes |
| | | | | 4, l₀ − 4), (k₀ + | | | | (two |
| | | | | 8, l₀ − 4) | | | | additional |
| | | | | (k₀, l₀ + 8), (k₀ + | | | | repetitions) |
| | | | | 4, l₀ + 8), (k₀ + | | | | |
| | | | | 8, l₀ + 8) | | | | |

The NE may include one or more parameters in the configuration to the UE, including

$${T}_{Symbgap}^{TRS} and {T}_{NumRep}^{TRS} , where {T}_{Symbgap}^{TRS}$$

indicates the symbol gap (e.g., a gap or offset in the time domain) for the repetition, while

$${T}_{NumRep}^{TRS}$$

indicates the number of repetitions within a resource. According to the example provided in FIG. 10,

$${T}_{Symbgap}^{TRS} = 4 and {T}_{NumRep}^{TRS} = 2.$$

In some examples, the configuration may also include the relative position of the newly repeated TRS REs relative to a TRS configuration without repetition.

FIG. 11 illustrates an example of a time-frequency resource diagram 1100 in accordance with aspects of the present disclosure. In some examples, the time-frequency resource diagram 1100 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, and the time-frequency resource diagram 1000. For example, the time-frequency resource diagram 1100 may be implemented by an NE or a UE, which may be an example of an NE 102 and a UE 104 as described with reference to FIG. 1. For example, the NE may configure the UE to perform CSI-RS repetition type 2 for non-communication based measurements.

In some examples, one or more NEs may transmit one or more repetitions of a defined reference signal resource, where a reference signal resource may be associated with a beam, across multiple beams or slots, which is referred to as a repetition type 2 configuration. For example, an NE 1 may transmit a TRS resource 1 in a slot #1 and in a slot #2, while an NE 2 may transmit a TRS resource 2 in the slot #1 and the slot #2 (e.g., across the slot #1 and the slot #2). In some cases, the repetitions may include TRS repetitions of a defined TRS resource (e.g., CSI-RS for tracking purposes), while in another example the repetitions may include CSI-RS repetitions of a defined CSI-RS for beam management (e.g., CSI-RS or any other CSI-RS type). FIG. 11 is an exemplary diagram of the method in which a TRS resource may configured based on a repetition type 2 configuration. The repetition configuration can also be enhanced to map out the additional REs which are occupied by TRS due to the repetition type 2 configuration.

In some cases, the NE may transmit (e.g., to one or more UEs) a physical mapping of the CSI-RS locations within a slot in a repetition type 2 configuration, where k₀ and l₀ refer to the reference location of CSI-RS in the time and frequency domain, respectively. In some cases, the NE and/or the UE may select kᵢ based on a bitmap [b₃, b₂, b₁, b₀], kᵢ=f(i), where f(i) is the bit position in the bitmap set to value 1 (e.g., if the bitmap is set to [1 0 0 0], then the subcarrier k₀=3 corresponding to the third bit position set to 1). The NE and/or the UE may select l₀ from a set of {0, . . . , 13} defined by the IE firstRepetitionType1OFDMSymbolInTimeDomain. In row 1-1 shown in FIG. 11, the bitmap is set to [1 0 0 0], indicating that k₀=3 and an additional term taking into account the slot number and repetition is given by:

$${l}_{0} + {n}_{s , f}^{μ} * 14.$$

The physical mapping may be based on one or more parameters, as shown in Table 9.

TABLE 9
Example of CSI-RS locations with repetition type 1 configuration appliable to TRS

| | | | | | CDM | | | |
|---|---|---|---|---|---|---|---|---|
| | Ports | Density | cdm- | | group | | | Repetition |
| Row | X | ρ | Type | (k̅, l̅) | index j | k′ | l′ | Type2 |
| 1 | 1 | 3 | noCDM | TRS Resource 1: | 0, 0, 0 | 0 | 0 | No |
| | | | | (k₀, l₀), (k₀ + 4, l₀), (k₀ + 8, l₀) | | | | |
| | | | | TRS Resource 2: | | | | |
| | | | | (k₀, l₀ + 4), (k₀ + 4, l₀ + 4), (k₀ + 8, l₀ + 4) | | | | |
| 1-1 | 1 | 3 | noCDM | TRS Resource 1 | 0, 0, 0 | 0 | 0 | Yes |
| | | | | $Repetition : ( {k}_{0} , {l}_{0} ) , ( {k}_{0} + 4 , {l}_{0} + {n}_{s , f}^{μ} * 13 ) , ( {k}_{0} + 8 , {l}_{0} + {n}_{s , f}^{μ} * 13 )$ | | | | (two additional repetitions) |
| | | | | TRS Resource 2 | | | | |
| | | | | $Repetition : ( {k}_{0} , {l}_{0} + 4 + {n}_{s , f}^{μ} * 13 ) , ( {k}_{0} + 4 , {l}_{0} + 4 + {n}_{s , f}^{μ} * 13 ) , ( {k}_{0} + 8 , {l}_{0} + 4 + {n}_{s , f}^{μ} * 13 )$ | | | | |

The NE may include one or more pin the configuration to the U, including

$${T}_{Symbgap}^{TRS} and {T}_{NumRep}^{TRS} , where {T}_{Symbgap}^{TRS}$$

indicates the symbol gap (e.g., a gap or offset in the time domain) for the repetition, while

$${T}_{NumRep}^{TRS}$$

indicates the number of repetitions within a resource. According to the example provided in FIG. 11,

$${T}_{Symbgap}^{TRS} = {n}_{s , f}^{μ} * 13 and {T}_{NumRep}^{TRS} = 2 .$$

In some cases, the configuration may also include the relative position of the newly repeated TRS REs relative to the TRS configuration without repetition.

In some cases, repetition type 1 and repetition type 2 configurations can reflect repetitions of TRS and/or CSI-RS resources within a TRS and/or CSI-RS resource set. The repetitions may then extend to multiple resource sets, which are transmitted periodically based on a configured periodicity set by an NE. In some examples, the UE may receive a repetition type 1 or repetition type 2 configuration from an NE. The NE may include a base station, a gNB, an NG-RAN node, or a network function (e.g., LMF or co-located LMF with a gNB). A variety of signaling mechanisms may be employed depending on which network entity transmits the configuration for performing positioning measurements, e.g., DCI, RRC, DL MAC CE, LPP, NAS-based signaling and so forth. In some cases, the following field IEs, as shown in Table 10, may define the number of TRS repetitions within a TRS resource applicable to the repetition type 1 and repetition type 2 configurations.

TABLE 10
Exemplary TRS Resource Repetition Configuration Parameter

| Exemplary Parameter | Exemplary Value | Additional Comments |
|---|---|---|
| >TRS-resource-repetition- | {2, 4, 6, 8, 16, 32, . . . } | This field specifies how many |
| factor (T_{NumRep}^{TRS}) | corresponding to an integer | times each TRS or CSI-RS |
| | number of TRS resource | resource is repeated for a |
| | repetitions. | single instance of the TRS or |
| | | CSI-RS resource set. The field |
| | | is applied to all resources of |
| | | the TRS resource set (e.g., |
| | | resources may not have |
| | | different repetitions in a TRS |
| | | or CSI-RS resource set). |
| | | Enumerated values n2, n4, n6, |
| | | n8, n16, n32, n . . . correspond |
| | | to 2, 4, 6, 8, 16, 32 resource |
| | | repetitions, respectively. If this |
| | | field is absent, then the value |
| | | for TRS-resource-repetition- |
| | | factor is 1 (e.g., no resource |
| | | repetition). |
| >TRS-ResourceTimeGap | {1, 2, 4, 8, 16, 32, . . . } | This field specifies the offset |
| (T_{Symbgap}^{TRS}) | corresponding to an integer | in units of slots between two |
| | number of slots in time units, | repeated instances of a TRS or |
| | (e.g., ms). | CSI-RS resource |
| | | corresponding to a same TRS |
| | | or CSI-RS resource ID within |
| | | a single instance of the TRS or |
| | | CSI-RS resource set. The time |
| | | duration spanned by one TRS |
| | | or CSI-RS resource set |
| | | including repeated TRS or |
| | | CSI-RS resources may not |
| | | exceed a TRS periodicity |
| | | (T_{TRS}) |

In some examples, the new configuration enhancement is defined for a CSI-RS signal for beam management (e.g., CSI-RS) configured with repetition to enable repetitions of the transmitted reference signal according to different methods. The different repetition configurations are also applicable to CSI-RS for beam management. The symbol or slot spacings for repetitions for intra-slot or inter-slot scenarios may or may not be uniform depending on the desired repetition configuration. The non-uniform repetition may be configured depending on whether a repetition type 1 or a repetition type 2 configuration is configured.

FIG. 12 illustrates an example of a time-frequency resource diagram 1200 in accordance with aspects of the present disclosure. In some examples, the time-frequency resource diagram 1200 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, the time-frequency resource diagram 1000, and the time-frequency resource diagram 1100. For example, the time-frequency resource diagram 1200 may be implemented by an NE or a UE, which may be an example of an NE 102 and a UE 104 as described with reference to FIG. 1. For example, the NE may configure the UE with a numerical quantity (e.g., number, amount) of consecutive slot transmissions for performing joint communication and non-communication services.

An NE may transmit a TRS configuration with a configurable number of consecutive slot transmissions. The consecutive slot transmissions can enhance the measurement accuracy of a configured positioning technique, such as a downlink-RSTD or a UE receive-transmit time difference measurement. The NE may increase a number of consecutive slot transmissions and increase an overall number of TRS occasions relative to current TRS configuration, providing a robust measurement framework. In some examples, a TRS occasion can include multiple TRSs in consecutive slots, such as slot #1, slot #2, through slot #N.

According to one aspect of this embodiment, a number of N slots may be configured to transmit N consecutive slots of transmission for a TRS or a CSI-RS for tracking. A total number of consecutive slot transmissions may be subject to a UE capability depending on how many consecutive slots of TRS that may be transmitted. The UE may transmit signaling to an NE (e.g., UCI) that indicates the capability. The NE may select the number of N slots according to the signaled capability. A set of consecutive of slots may be associated with a periodicity, in the case of periodical non-communication service measurements (e.g., positioning).

In some cases, configurable number of N slots may be referred to as TRS occasion over which a non-communication measurement may be derived, where a TRS occasion may include TRSoccasion={Slot #1, Slot #2, . . . , Slot #N}. A total number of TRS occasion may be configured by the NE (e.g., NG-RAN node, gNB, base station, LMF) and/or may be based on a UE capability, both of which may be defined. For example, a TRS occasion may include TRSoccasion={1, 2, 3, 4} or any integer number which may be supported by the NE and/or the UE. An NE may adapt a TRS resource periodicity, T_{TRS}, such that additional periodicity values are introduced to increase the frequency of the TRS occasions for which an accurate positioning measurement may be derived. The TRS configuration is enhanced such that a target UE or device intending to perform hybrid services (e.g., joint communication and positioning), may receive a TRS configuration that is configured to be aperiodic. An aperiodic TRS configuration can support one shot positioning tasks, where a coarse location may be derived from a measurement derived based on an aperiodic TRS transmission (e.g., UE receive-transmit time difference measurement).

In some cases, if the field TRS resource periodicity (T_{TRS}) is missing or is set to 0, then the TRS is configured to be aperiodic or a one-shot transmission according to the transmitted TRS resource. In some examples, the TRS and/or CSI-RS configuration for non-communication services is defined by a flag, (e.g., aperiodic flag) that indicates the TRS configuration may be transmitted in a one shot or dynamic manner to support one shot positioning measurements that use an immediate location fix. The TRS configuration may be enhanced such that target UE or device intending to perform hybrid services (e.g., joint communication and positioning) may receive a TRS configuration that is configured to be semi-persistent for the purposes of performing timing-based or angle-based positioning measurements (e.g., AoD measurements). Semi-persistent transmissions of TRS enables activation and deactivation of TRS transmissions with supported periodicities via dedicated lower layer signaling, such as DCI, a downlink MAC-CE, or higher-layer signaling (e.g., RRC or LPP). The semi-persistent transmissions enable quicker and flexible activation and deactivation of TRS transmissions for non-communication services.

In some examples, the aperiodic or semi-persistent transmission is triggered by identification of a use case for performing a non-communication service (e.g., positioning or sensing). The NE may receive a trigger from a network function (e.g., location server or sensing function) via an applicable interface (e.g., NRPPa) or any defined protocol between a sensing function and an NE (e.g., NG-RAN node, base station, gNB). Subsequent to receiving the trigger the NE may transmit an aperiodic, semi-persistent, or periodic TRS transmission to the UE. For a semi-persistent TRS transmission, the NE can activate and deactivate the TRS transmission via DCI, a downlink MAC-CE, or any physical layer or lower layer signaling. The described enhanced reference signal configuration for performing hybrid services (e.g., joint location and communication services) enhance current TRS or CSI-RS for tracking to support various repetition types, enhance a number of consecutive slot transmissions and periodicities for TRS-based positioning measurements, and enhance a TRS configuration to support one shot positioning via aperiodic TRS and flexible non-communication services (e.g., positioning via semi-persistent transmissions).

FIG. 13 illustrates an example of a time-frequency resource diagram 1300 in accordance with aspects of the present disclosure. In some examples, the time-frequency resource diagram 1300 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, the time-frequency resource diagram 1000, the time-frequency resource diagram 1100, and the time-frequency resource diagram 1200. For example, the time-frequency resource diagram 1300 may be implemented by an NE or a UE, which may be an example of an NE 102 and a UE 104 as described with reference to FIG. 1. For example, the NE may configure the UE with a muting type 1 configuration for non-communication based measurements.

In some cases, the NE may transmit (e.g., to one or more UEs) a new configuration enhancement for TRS or a CSI-RS for tracking to enable muting of the TRS and/or CSI-RS resource transmission from one or more serving or neighboring cells to reduce or mitigate intra-cell or inter-cell interference. The intra-cell and inter-cell interference can degrade a performance (e.g., accuracy, precision) of non-communication service measurements (e.g., positioning, sensing). The proposed muting enhancements are different from current zero-power (ZP) CSI-RS features. For example, for CSI-IM, the NZP CSI-RSs are protected from inter-cell-interference by allocating either CSI-IM or ZP CSI-RS to the REs overlapping with NZP CSI-RSs from other NEs. However, these are configured per transmission instance for a single CSI-RS measurement either transmitted from a serving or neighboring NEs, which have overlapped RE transmissions but may not be applicable to TRS resources and do not take into account TRS repetitions or TRS periodical transmissions.

A current ZP CSI-RS defines a set of REs where a PDSCH is not mapped, and the UE may not determine the content of the resources. The ZP CSI-RS may be for muting a TRS from other NE that is configured but transmitted with zero power. Current communication frameworks related to time-frequency offset estimation may not support muting of existing and/or ongoing configurations. For non-communication services muting one or more reference signals leads to an enhanced and/or more accurate positioning or sensing measurement by reducing or mitigating residual interference caused by similar or overlapped TRS and/or CSI-RS transmissions from serving or neighboring NEs. Muting of resources includes setting a transmit power for a transmission using the resource to zero to reduce or avoid interference with overlapping or closely overlapping reference signal measurements. In some examples, an NE may configure a UE to mute TRS or CSI-RS related signaling, such as by transmitting control signaling to the UE that includes different muting configurations. The UE may mute a TRS within a TRS resource set (e.g., TRS repetitions within a one beam sweep). Additionally, or alternatively, the UE may mute one more TRS resource sets within a carrier.

In some cases, the NE and/or the UE may select various muting options for a defined TRS resource, where a TRS resource may be associated to a beam within a slot, which is referred to as a muting type 1 configuration. The muting configuration can also be enhanced to mute out existing or additional REs which are occupied by a TRS due to an ongoing repetition configuration (e.g., repetition type 1 and/or repetition type 2 configuration). In some examples, the UE and/or the NE may mute one or more resources within a TRS resource based on an ongoing or received TRS configuration within a slot. For example, an NE may transmit a repetition configuration or other configuration to a UE that allocates (e.g., schedules) one or more resources 1302 for one or more reference signals in a slot to use for hybrid services. Additionally, or alternatively, the NE may transmit a muting configuration that indicates a muting type 1 configuration. The NE may mute one or more of the resources 1302 (e.g., the muted resources 1304) according to the muting type 1 configuration. That is, the NE may transmit one or more reference signals and/or reference signal repetitions with zero power during the muted resources 1304 to reduce or eliminate interference at the UE. Thus, a portion of the resources 1302 may be muted for one or more slot transmissions, which may also be indicated by the transmitted configuration to the UE or device.

FIG. 14 illustrates an example of a time-frequency resource diagram 1400 in accordance with aspects of the present disclosure. In some examples, the time-frequency resource diagram 1400 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, the time-frequency resource diagram 1000, the time-frequency resource diagram 1100, the time-frequency resource diagram 1200, and the time-frequency resource diagram 1300. For example, the time-frequency resource diagram 1400 may be implemented by an NE or a UE, which may be an example of an NE 102 and a UE 104 as described with reference to FIG. 1. For example, the NE may configure the UE with a muting type 1 configuration for non-communication based measurements.

In some examples, the time-frequency resource diagram 1400 may illustrate an example of one or more resource repetitions being muted within a slot. The NE may mute one or more of the resources 1302 (e.g., the muted resources 1304) according to the muting type 1 configuration. That is, the NE may transmit one or more reference signals and/or reference signal repetitions with zero power during the muted resources 1304 to reduce or eliminate interference at the UE. Thus, a portion of the resources 1302 may be muted for one or more slot transmissions, which may also be indicated by the transmitted configuration to the UE or device. The muting of repetitions may extend to one or more slots indicated by the transmitted configuration to the UE or device. The transmitted configuration may be signaled using DCI, RRC DL MAC CE, LPP, new sensing protocol or combination thereof.

In some cases, the muting applies to TRS and/or CSI-RS resources transmitted within one or more slots and when the resources are unmuted the same TRS and/or CSI-RS resources are transmitted with a configured power. A centralized entity, such as a location server or sensing function, may coordinate the muting for multiple NE and transfer the muting configuration to a measurement entity (e.g., a UE device or another NE). Additionally, or alternatively, a decentralized entity, such as an NE, may coordinate the muting for neighboring NEs via an NE to NE interface (e.g., Xn interface, gNB-gNB interface). In some examples, the NE may transmit one or more fields or parameters that indicate the muting type 1 configuration, according to Table 11.

TABLE 11
Exemplary TRS Resource Muting Type 1 Configuration Parameter

| Exemplary Parameter | Exemplary Value | Additional Comments |
|---|---|---|
| >TRS-MutingOption1 | | This field specifies the TRS |
| | | muting configuration of the |
| | | TRP, beam, or slot for the |
| | | Option-1 muting (e.g., muting |
| | | type 1 configuration), and |
| | | includes one or more sub- |
| | | parameters, as shown below. |
| >>TRS-option1-BitMap | Example (1): A 14-bit bitmap | This fled a bitmap of the time |
| | corresponding to OFDM | locations where the TRS |
| | symbol locations, where a TRS | resource is transmitted (e.g., |
| | resource may be muted. | value 1) or not (e.g., value 0). |
| | Example (2): A bitmap | The time locations may be |
| | corresponding to a length of the | OFDM symbols within a slot. |
| | time density of a TRS resource | Each bit of the bitmap |
| | may also indicate which | corresponds to a sub-set of |
| | resource is muted or not (e.g., | TRS and/or CSI-RS resources |
| | the bitmap can be signaled: [1 | or repetition of the TRS and/or |
| | 0] for FIG. 13 or [0 1 1 0] for | CSI-RS resource within an |
| | FIG. 14) | instance of a TRS and/or |
| | | CSI-RS resource set. If this |
| | | field, TRS-option1-BitMap, is |
| | | absent, muting option 1 is not |
| | | in use for the TRP(s) |

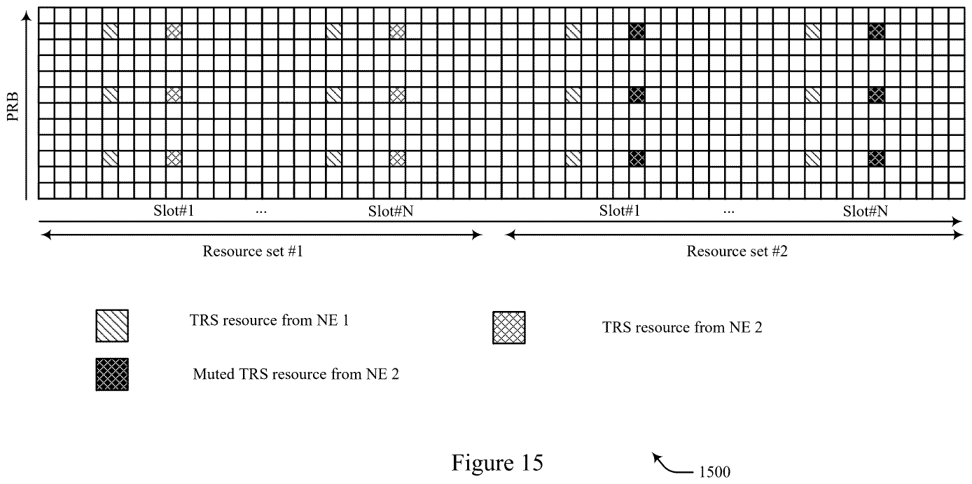

FIG. 15 illustrates an example of a time-frequency resource diagram 1500 in accordance with aspects of the present disclosure. In some examples, the time-frequency resource diagram 1500 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, the time-frequency resource diagram 1000, the time-frequency resource diagram 1100, the time-frequency resource diagram 1200, the time-frequency resource diagram 1300, and the time-frequency resource diagram 1400. For example, the time-frequency resource diagram 1500 may be implemented by an NE or a UE, which may be an example of an NE 102 and a UE 104 as described with reference to FIG. 1. For example, the NE may configure the UE with a muting type 2 configuration for non-communication based measurements.

An NE may define a muting type 2 configuration enhancement for one or more reference signals, such as CSI-RSs. The NE may transmit the muting type 2 configuration to a UE. The NE and/or the UE may apply the muting type 2 configuration to TRSs (e.g., CSI-RS for tracking) and/or to CSI-RSs for beam management (e.g., CSI-RS or any other CSI-RS type), among other examples. One or more instances of a TRS resource set may be muted based on an ongoing or received TRS configuration. In some examples, the NE may configure a CSI-RS by transmitting signaling to the UE, such as RRC signaling, a MAC-CE, and/or a DCI. The NE may configure the muting at a same level as the signaling configuring the CSI-RS or at a lower level. For example, the NE may configure muting for a MAC-CE triggered CSI-RS either via a MAC-CE or DCI. The transmitted configuration may be signaled using DCI, RRC signaling, a downlink MAC-CE, LPP signaling, NRPPa signaling, a new sensing protocol, an NE to NE interface protocol (e.g., Xn, gNB-gNB interface), or any combination thereof.

In some examples, a UE may mute an instance of a resource set including TRS transmissions from another NE (e.g., NE 2). For example, the UE may mute one or more TRS resources in a resource set #2 from NE 2 to reduce or prevent interference to the TRS resources from NE 1 caused by the TRS resources from NE 2 in the resource set #2. In some cases, a centralized entity, such as a location server or sensing function, may coordinate the muting for multiple NEs and transfer the muting configuration to a measurement entity (e.g., a UE, device, or another NE). In some other cases, a decentralized entity, such as an NE, may coordinate the muting for neighboring NEs via the NE to NE interface. The muting may apply to TRS and/or CSI-RS resources transmitted within one or more slots. If the resources are unmuted, then the same TRS and/or CSI-RS resources are transmitted with a configured power. In some examples, the NE may transmit one or more fields or parameters that indicate the muting type 2 configuration, according to Table 12.

TABLE 12
Exemplary TRS resource muting type 1 configuration parameter.

| Exemplary Parameter | Exemplary Value | Additional Comments |
|---|---|---|
| >TRS-MutingOption2 | | This field specifies the TRS |
| | | muting configuration of TRS |
| | | resource set for Option-2 |
| | | muting (e.g., muting type 2), |
| | | and includes one or more sub- |
| | | parameters |
| >>TRS-option2-BitMap | Example (1): A 14-bit bitmap | Defines a bitmap of the time |
| | corresponds to OFDM symbol | locations where the TRS |
| | locations, where a TRS | resource is transmitted (e.g., |
| | resource may be muted within | value 1) or not (e.g., value 0) |
| | a slot, which remains | for a TRS resource set. |
| | consistent for a resource set. | |
| | Example (2): A bit map | |
| | corresponding to the length of | |
| | the time density of TRS | |
| | resource may indicate which | |
| | resource is muted or not within | |
| | a slot, which remains | |
| | consistent for an entire | |
| | resource set | |
| | Example (3): A bitmap of | |
| | resource sets may be indicated | |
| | to illustrate which resource set | |
| | is muted (e.g., According to | |
| | FIG. 15, the bitmap to be | |
| | signaled: [1 0] on resource set | |
| | granularity) | |
| >>TRS- | {1, 2, 4, 8, 16, 32, . . . } | This field indicates a number |
| MutingRepetitionFactor | | of consecutive instances of the |
| | | TRS resource set |
| | | corresponding to a single bit of |
| | | the TRS-option2-BitMap field. |
| | | The field is enabled for |
| | | periodic or repetitive resource |
| | | sets. Enumerated values n1, |
| | | n2, n4, n8 correspond to 1, 2, |
| | | 4, 8 consecutive instances, |
| | | respectively. If the field is |
| | | absent, then the value for |
| | | TRS-RepetitionFactor is n1. |

In some examples, the described muting configuration enhancement is defined for a CSI-RS signal for beam management (e.g., CSI-RS) configured to enable muting of the transmitted reference signal according to different transmissions from various NEs.

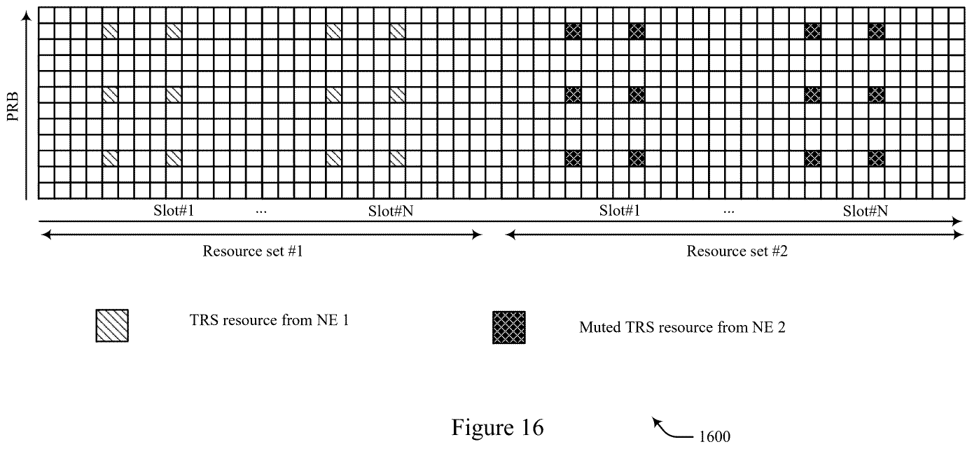

FIG. 16 illustrates an example of a time-frequency resource diagram 1600 in accordance with aspects of the present disclosure. In some examples, the time-frequency resource diagram 1600 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, the time-frequency resource diagram 1000, the time-frequency resource diagram 1100, the time-frequency resource diagram 1200, the time-frequency resource diagram 1300, the time-frequency resource diagram 1400, and time-frequency the time-frequency resource diagram 1500. For example, the time-frequency resource diagram 1600 may be implemented by an NE or a UE, which may be an example of an NE 102 and a UE 104 as described with reference to FIG. 1. For example, the NE may configure the UE with a muting type 2 configuration for non-communication based measurements.

In some examples, a UE may mute an instance of a resource set including TRS transmissions from another NE (e.g., NE 2). For example, the UE may mute one or more TRS resources in a resource set #2 from NE 2 to reduce or prevent interference to the TRS resources from NE 1 in the resource set #1 caused by the TRS resources from NE 2 in the resource set #2. In some cases, a centralized entity, such as a location server or sensing function, may coordinate the muting for multiple NEs and transfer the muting configuration to a measurement entity (e.g., a UE, device, or another NE). In some other cases, a decentralized entity, such as an NE, may coordinate the muting for neighboring NEs via the NE to NE interface. The muting may apply to TRS and/or CSI-RS resources transmitted within one or more slots. If the resources are unmuted, then the same TRS and/or CSI-RS resources are transmitted with a configured power. In some examples, the NE may transmit one or more fields or parameters that indicate the muting type 2 configuration, according to Table 12.

FIG. 17 illustrates an example of a wireless communications system 1700 in accordance with aspects of the present disclosure. In some examples, the wireless communications system 1700 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, the time-frequency resource diagram 1000, the time-frequency resource diagram 1100, the time-frequency resource diagram 1200, the time-frequency resource diagram 1300, the time-frequency resource diagram 1400, the time-frequency resource diagram 1500, and the time-frequency resource diagram 1600. For example, the wireless communications system 1700 may include a UE 104-b, an NE 102-d, an NE 102-e, and an NE 102-f, which may be examples of a UE 104 and NEs 102 as described with reference to FIGS. 1 and 2. For example, the NE 102-d, the NE 102-e, and/or the NE 102-f may configure the UE 104-b to prioritize one or more reference signal resources (e.g., CSI-RS resources and/or TRS resources) and/or one or more reference signal resource sets or subsets for hybrid services.

In some examples, a configuration entity (e.g., an NE, location server, sensing function) may configure a measurement entity (e.g., the UE 104-a) to prioritize the measurement of a set or subset of resources, depending on the NE (e.g., gNB or TRP) beam relative to the location of the measurement entity. The UE may use the configured prioritization to perform angle-based positioning techniques, such as downlink AoD, where the correct AoD of a transmitted reference signal (e.g., TRS and/or CSI-RS) is mapped relative to a location of the measurement entity (e.g., the UE 104-b). Reference signal resources mapped to a particular beam may be configured in a prioritized manner for UE measurement. For example, the UE 104-b may be configured to measure a set of reference signal resources from each NE, including beams 1 through 4 for NE 102-d, beams 1 through 4 for NE 102-e, and beams 1 through 4 for NE 102-f. The prioritization can indicate an order of the beams to measure for each NE, including {Beam 1, Beam 2, Beam 3, Beam 4} for NE 102-d, {Beam 1, Beam 2, Beam 3, Beam 4} for NE 102-e, and {Beam 1, Beam 2, Beam 3, Beam 4} for NE 102-f. An example parameter for the configuration that indicates the prioritization for reference signal measurements (e.g., for angle-based techniques) is shown in Table 13.

TABLE 13
Exemplary TRS prioritization configuration parameter

| Exemplary Parameter | Exemplary Value(s) | Description |
|---|---|---|
| >TRS/CSI-RS resource | Example (1): A single | This field provides a subset of |
| priority | reference signal resource or | reference signal resources (e.g., |
| | resource set | TRS and/or CSI-RS resources), |
| | Example (2): A list of reference | which is associated with a |
| | signal resources or resource | reference signal resource ID for |
| | sets in descending order (e.g., | the purpose of prioritization of |
| | resource and resource set at top | measurements and reporting of |
| | of the list with highest priority) | angle-based position or sensing |
| | or ascending order (e.g., | techniques. |
| | resource and resource set at | |
| | bottom of the list) | |
| | Example (3): Explicit priority | |
| | indicator assigned to a resource | |
| | and resource set (e.g., value 1) | |
| | associated to a reference signal | |
| | resource and resource set X has | |
| | a highest priority or equivalent | |
| | bitmap representation ‘001’ | |
| | considering a number of | |
| | priority level (e.g., 8). | |

In some cases, the UE 104-b may perform measurements of a reference signal (e.g., a TRS) per beam from each NE according to the prioritization. For example, at 1702, the UE 104-b may perform a measurement of a TRS per beam from the NE 102-d, the NE 102-e, and the NE 102-f. The UE 104-b may transmit a reference signal measurement report 1704 to a network entity 1706, which may be an example of an LMF and/or a sensing function, among other examples. At 1708, the network entity 1706 may perform spatial information and reference signal measurement mapping to determine a position of the UE 104-b and/or a position of one or more sensing targets (e.g., objects in an environment of the UE 104-b and/or in an absence of any UE). In some examples, the UE 104-b may transmit the reference signal measurement report 1704 to the network entity 1706 via an NE (e.g., one of the NE 102-d, the NE 102-e, and/or the NE 102-f). Additionally, or alternatively, the UE 104-b may be in direct communication with the network entity 1706.

In some examples, the NE may configure the UE 104-b to unambiguously identify one or more TRS resources and/or transmissions during a TRS configuration and subsequently when performing any non-communication measurement (e.g., positioning, sensing). According to a current communication framework, CSI-RS resources transmitted from other NEs are distinguished based on an absolute RF channel number (ARFCN). In some other cases, in current communication framework, the CSI-RS resources are part of a serving cell configuration. The CSI-RS resources being distinguished by an ARFCN or being part of a servicing cell configuration may lead to different neighboring NEs using same TRS configurations, which may lead to configuration ambiguity and measurement inaccuracies. Therefore, in addition to the CSI-RS resource identifier, ARFCN, and resource set identifier, the NE may include one or more additional parameters to maintain unambiguous identification of TRS resources and transmissions across multiple cells. The additional parameters are defined in Table 14. Thus, the combination of the identifiers unambiguously identifies the CSI-RS resources and transmissions originating from different cells and/or NEs (e.g., the NE 102-d, the NE 102-e, and/or the NE 102-f).

TABLE 14
Proposed list of additional identifiers for multi-
gNB/multi-cell (e.g., multiple Nes) TRS transmissions

| Exemplary | |
|---|---|
| Parameter | Description |
| >TRS/CSI-RS ID | This field is used along with a TRS/CSI-RS |
| | resource set ID and a CSI resource ID to |
| | uniquely identify a TRS and/or CSI-RS |
| | resource. This ID can be associated with |
| | multiple TRS and/or CSI-RS resource sets |
| | associated with a single TRP. Each TRP should |
| | be associated with one ID. |
| >PCI | This field specifies the physical cell identity |
| | (PCI) of the associated TRP. |
| >CGI ID | This field specifies the cell global identity |
| | (CGI), the globally unique identity of a cell (e.g., |
| | this can apply to E-UTRA, NR or next |
| | generation (6G) cell) of the associated TRP. A |
| | configuration entity, such as an NE, location |
| | server, sensing function includes this field if the |
| | configuration entity determines to resolve |
| | ambiguity in the TRP indicated by PCI. |

In some cases, a configuration entity (e.g., an NE, location server, sensing function) may configure a measurement entity (e.g., the UE 104-b) with a TRS and/or CSI-RS identifier, each of which is defined such that the identifier is associated with multiple TRS and/or CSI-RS resource sets. A UE 104-b may determine that one of these TRS and/or CSI-RS identifier and a TRS and/or CSI-RS resource set identifier and a TRS and/or CSI-RS resource identifier can be used to uniquely identify a TRS and/or CSI-RS resource. In some examples, a UE 104-b may identify a CSI-RS/TRS resource from a serving cell (e.g., unless not contained in the serving cell configuration for non-communication purposes) based on a PCI identifier, CGI identifier, and ARFCN.

If a received PCI identifier or CGI identifier is the same as the PCI identifier, CGI identifier, and ARFCN associated with a TRS and/or CSI-RS resource for non-communication purposes, then the measurement entity (e.g., UE 104-b) determines that the TRS and/or CSI-RS is a serving cell transmission. If the a received PCI identifier or CGI identifier is different from the PCI identifier, CGI identifier, and ARFCN associated with a TRS and/or CSI-RS resource for non-communication purposes, then the UE 104-b determines that the TRS and/or CSI-RS is transmitted from another cell, another NE, or a non-serving cell. In some cases, if the measurement entity (e.g., UE 104-b) determines that the TRS and/or CSI-RS is transmitted from a serving cell, and if the serving cell is the same as the serving cell defined by an SSB, a physical broadcast channel (PBCH) block, or synchronization-related reference signals, then the measurement entity (e.g., the UE 104-b) determines that both the TRS and/or CSI-RS and the SSB and/or PBCH block are transmitted from a same serving cell. If the measurement entity (e.g., UE 104-b) determines that the TRS and/or CSI-RS is transmitted from a non-serving cell, and if the PCI is the same as the PCI for SSB and/or PBCH block or synchronization-related reference signals, then the measurement entity (e.g., the UE 104-b) may determine that both the TRS/CSI-RS and SSB and/or PBCH block or synchronization-related reference signals are transmitted from the same non-serving cell.

The described enhanced reference signal configuration for performing hybrid services (e.g., joint location and communication services) with multiple NEs can enhance the TRS or CSI-RS for tracking robustness against multi-cell interference using the various muting configurations. The UE implementing muting configurations leads to an enhanced non-communication measurement (e.g., positioning, sensing). Additionally, or alternatively, the enhanced reference signal configuration enables unambiguous identification of TRS and/or CSI-RS for tracking resources and transmission from multiple cells or NEs. Additionally, or alternatively, the enhanced reference signal configuration enables prioritization of TRS and/or CSI-RS resources for efficient angles-based methods (e.g., AoD measurements) applicable to location services.

FIG. 18 illustrates an example of a resource diagram 1800 in accordance with aspects of the present disclosure. In some examples, the resource diagram 1800 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, the time-frequency resource diagram 1000, the time-frequency resource diagram 1100, the time-frequency resource diagram 1200, the time-frequency resource diagram 1300, the time-frequency resource diagram 1400, the time-frequency resource diagram 1500, the time-frequency resource diagram 1600, and the wireless communications system 1700. For example, the resource diagram 1800 may be implemented by an NE or a UE, which may be an example of an NE 102 and a UE 104 as described with reference to FIG. 1. For example, the NE may generate one or more reference signals and a mapping between the reference signals and one or more resources (e.g., time-frequency resources and/or spatial resources) for transmission to UEs.

In some examples, an NE may configure an NZP CSI-RS resource set with multiple usage values (e.g., a usage value or use case per resource in the NZP CSI-RS resource set). The usage values (e.g., use cases) may include, but are not limited to, channel measurement, beam management, tracking, and/or positioning. The NE may associate a higher-layer parameter corresponding to a usage value with an NZP CSI-RS resource set IE, the usage value taking a value of at least one of channel measurement (e.g., CSI), beam management (e.g., repetition), tracking (e.g., trs-Info), or positioning (e.g., pos). Additionally, or alternatively, each of the usage values is associated with a distinct higher-layer parameter (e.g., a channel measurement parameter). For example, the higher-layer parameter can include, but is not limited to, a value of CSI for channel management, a value of repetition for beam management, a value of trs-Info for tracking, or a value of pos for positioning, where each of the parameters can be either enabled or disabled.

An NZP CSI-RS resource set configured with positioning may include one or more NZP CSI-RS resources, where each NZP CSI-RS resource occupies at least one RE. In some cases, the NZP CSI-RS resource set corresponds to a TRS. Additionally, or alternatively, the NZP CSI-RS resource set includes one or more CSI-RS resources, including a density value per CSI-RS resource. Additionally, or alternatively, the one or more NZP CSI-RS resources in the NZP CSI-RS resource set span multiple symbols in a same slot and a same resource block (RB). Additionally, or alternatively, each NZP CSI-RS resource of the one or more NZP CSI-RS resources is equipped with a single port.

In some cases, the NE may configure a density value associated with a CSI-RS resource. For example, the NE may configure different density values for different usage values or use cases. A density value equal to (e.g., with a value of) one indicates a presence of one CSI-RS symbol block in each RB of a configured frequency band. The CSI-RS symbol block in an RB corresponds to a set of contiguous REs occupying a single symbol in time. For example, a configured frequency band including 12 RBs at a density value ρ=1 includes 12 CSI-RS symbol blocks. A density value equal to p, where p is an integer value larger than one, indicates a presence of p CSI-RS symbol blocks in each RB of a configured frequency band. The CSI-RS symbol block in an RB corresponds to a set of contiguous REs occupying a single symbol in time. For example, a configured frequency band including 12 RBs at ρ=3 includes 12×3=36 CSI-RS symbol blocks, three in each RB. A density value equal to lip, where p is an integer value larger than one, indicates a presence of one CSI-RS symbol block in every p RBs of a configured frequency band. The CSI-RS symbol block in an RB corresponds to a set of contiguous REs occupying a single symbol in time. For example, a configured frequency band including 12 RBs at ρ=2 includes 12/2=6 CSI-RS symbol blocks, one in every other RB.

In some examples, a starting subcarrier index depends on the configured density value. For example, an NE may configure an index of a first subcarrier carrying the CSI-RS resource by configuring the density value. A density value of two indicates that the index value is within a first half of the subcarriers (e.g., a subcarrier in the first 6 subcarriers in an RB including 12 subcarriers) corresponding to a comb-two configuration. A density value of four indicates that the index value is within a first quarter of the subcarriers (e.g., a subcarrier in the first 3 subcarriers in an RB including 12 subcarriers) corresponding to a comb-4 configuration. Additionally, or alternatively, the index of the first subcarrier carrying the CSI-RS resource may depend on the symbol index (e.g., via a configured or defined rule, an offset value depending on the symbol index, or a predetermined value).

In some cases, each CSI-RS resource in a CSI-RS resource set associated with positioning measurement is configured with a distinct start symbol in the symbols that make up a slot. For example, an index of a start symbol is configured to be any of the first 12 symbols of a slot including 14 symbols (e.g., the start symbol may not be in the last two symbols of the slot). Table 15 provides example configurations for a CSI-RS for hybrid services (e.g., positioning measurement and/or channel measurements) based on a current NR CSI-RS and NR PRS configuration or future sensing reference signal configurations. For each valid PRS configuration, an equivalent CSI-RS configuration is presented that provides a similar reference signal density and distribution within a slot, an RB, or both.

TABLE 15
Example CSI-RS configurations for positioning measurement purposes

| $\{ {L}_{PRS} , {K}_{comb}^{PRS} \}$ | $\{ {N}_{time}^{PRS} , {N}_{freq}^{PRS} \}$ | Equivalent CSI- RS Configuration | Applicability | Notes |
|---|---|---|---|---|
| {1, 2} | {1, 6} | 1 reference signal | Practical | Comb. up to 6 |
| | | density 6 | configuration | reference signals |
| | | | | Two TRSs |
| {2, 2} | {2, 6} | 2 reference signals | Practical | Comb. up to 12 |
| | | density 6 | configuration | reference signals |
| | | | | Four TRSs |
| {4, 2} | {4, 6} | 4 reference signals | Impractical | Large overhead |
| | | density 6 | configuration | |
| {6, 2} | {6, 6} | 6 reference signals | Impractical | Large overhead |
| | | density 6 | configuration | |
| {12, 2} | {12, 6} | 12 reference | Impractical | Large overhead |
| | | signals density 6 | configuration | |
| {1, 4} | {1, 3} | 1 reference signal | Applicable | TRS |
| | | density 3 | configuration | |
| {4, 4} | {4, 3} | 4 reference signals | Practical | Comb. up to 12 |
| | | density 3 | configuration | reference signals |
| | | | | Four TRSs |
| {12, 4} | {12, 3} | 12 reference | Impractical | Large overhead |
| | | signals density 3 | configuration | |
| {1, 6} | {1, 2} | 1 RS density 2 | Applicable | Two reference |
| | | | configuration | signals (two |
| | | | | resources or two |
| | | | | ports) |
| {6, 6} | {6, 2} | 6 reference signals | Practical | Comb. up to 12 |
| | | density 2 | configuration | reference signals |
| {12, 6} | {12, 2} | 12 reference | | Large overhead |
| | | signals density 2 | | |
| {1, 12} | {1, 1} | 1 reference signal | Applicable | Single port CSI-RS |
| | | density 1 | configuration | |
| {12, 12} | {12, 1} | 12 reference | Impractical | Large overhead |
| | | signals density 1 | configuration | |

Current CSI-RS configurations include up to 64 CSI-RS resources per CSI-RS resource set (e.g., a single port each). Thus, the NE and/or the UE may support any positioning configuration with 64 symbols or less, among other examples. The NE may enhance the current CSI-RS configurations to ensure sufficient density (e.g., a threshold density is satisfied) in both time domain (e.g., across symbols, slots) and a frequency domain (e.g., across subcarriers, RBs) to enable

To enable the location services, the CSI-RS for tracking can be configured with one or two additional symbols (e.g., L_{PRS}=2, 3, 4, respectively). Additionally, or alternatively, the CSI-RS for tracking can be configured with a configurable density between 1 and 3. Additionally, or alternatively, the CSI-RS for tracking can be configured with a different frequency offset per symbol to improve tracking characteristics. A PRS is configured per positioning frequency layer (PFL), which can span an entire carrier (e.g., the PFL is greater than the BWP). In some cases, the positioning measurement is based on one or more CSI-RS resources configured with repetition. Each CSI-RS resource of the one or more CSI-RS resources is received over multiple occasions to improve the reliability of signal reception.

An NE and/or a UE may perform a current CSI-RS mapping according to Equations 2 and 3:

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \qquad ( 2 )$$

$${c}_{i n i t} = ( {2}^{10} ( {N}_{symb}^{slot} {n}_{s , f}^{μ} + l + 1 ) ( 2 {n}_{ID} + 1 ) + {n}_{ID} ) mod {2}^{31} . \qquad ( 3 )$$

In some examples, c(i) is a pseudo-random sequence based on a Gold code with an initialization factor, cᵢₙᵢₜ. The variable

$${n}_{s , f}^{μ}$$

is the slot number within a radio frame, l is the OFDM symbol number within a slot, and n_{ID} is the scrambling identifier (e.g., a sequence identifier). The value of n_{ID} may be within the range {0, 1, . . . , 1023}. An NE and/or a UE may perform a current PRS mapping according to Equations 4 and 5:

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \qquad ( 4 )$$

$${c}_{i n i t} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{P R S} mod 1024 ) ) mod {2}^{31} \qquad ( 5 )$$

In some cases, c(i) is a pseudo-random sequence based on a Gold code with an initialization factor, cᵢₙᵢₜ. The variable

$${n}_{s , f}^{μ}$$

is the slot number within a radio frame, l is the OFDM symbol number within a slot, and n_{ID} is the scrambling ID or in other words the sequence ID. The value of n_{ID} may be within the range {0, 1, . . . , 4095}.

In some cases, the UE may be configured to receive a CSI-RS bundle corresponding to a set of CSI-RSs that are mapped to a set of resources over a frequency grid in a defined order. A sequence generation of each CSI-RS of the set of CSI-RSs depends on an index of the CSI-RS based on the defined order over the frequency grid. In some examples, a sequence generation formula used for generating a CSI-RS corresponding to the CSI-RS bundle depends on a number of CSI-RSs in the set of the CSI-RSs. For example, the D CSI-RSs forming the CSI-RS bundle corresponding to D CSI-RS resources each with index d, where d=0, . . . , D−1, are generated according to Equation 6:

$${r}_{d} ( m ) = \frac{1}{\sqrt{2}} ( 1 - 2 \cdot c ( 2 \cdot {m}^{′} ) ) + j \frac{1}{\sqrt{2}} ( 1 - 2 \cdot c ( 2 \cdot {m}^{′} + 1 ) ) , \qquad ( 6 )$$

where m′=m·D+d. The resource diagram 1800 illustrates an example with D=3 alternating CSI-RS resources, each with a single port. For example, the TRS resource 1802 may be repeated every three physical RBs (PRBs), the TRS resource 1804 may also be repeated every three PRBs, and the TRS resource 1806 may also be repeated every three PRBs.

In some examples, the NE may generate a CSI-RS bundle corresponding to a bundle of CSI-RS resource sets or a CSI-RS resource superset including multiple CSI-RSs from a same sequence c(m) with a common sequence (e.g., common seed). The reference signal sequence, r_{d} (m), is defined by the CSI-RS identifier. The CSI-RS bundle corresponds to an entirety of the CSI-RS resources in a CSI-RS resource set. A CSI-RS resource set associated with a CSI-RS bundle may have a threshold value for a maximum number of CSI-RS resources in the CSI-RS resource set. Additionally, or alternatively, the CSI-RS bundle corresponds to a subset of CSI-RS resources in a CSI-RS resource set. A selection of CSI-RS resources included in the CSI-RS bundle is configured using a CSI-RS resource set configuration message.

In some examples, an NE and/or a UE may map a CSI-RS bundle to an enhanced positioning reference signal (e.g., ePRS). The ePRS is used as a single signal for positioning measurement purposes, such as a CSI-RS, TRS, SRS, and/or SSB, among other example reference signals. For CSI measurement purposes (e.g., services), the NE and/or the UE may determine the CSI-RS bundle and the ePRS is a set of CSI-RSs associated with a set of single-port CSI-RS resources, each used for CSI measurement purposes, separately or independently. Additionally, or alternatively, the NE may configure the CSI-RS resources in a CSI-RS bundle with more than one usage value. The usage values include, but are not limited to, at least one of beam management, repetition, CSI measurement, initial access, tracking, synchronization, and positioning. At least one usage value of the more than one usage value is associated with positioning measurement, where a support of the positioning usage value is implied without indication to the UE. Additionally, or alternatively, at least one usage value of the more than one usage value is associated with CSI measurement, where a support of the positioning usage value is implied without indication to the UE. In some cases, the UE may transmit signaling to the NE that indicates a capability of the UE to support the hybrid services, and the NE may generate the configuration and mapping based on the capability of the UE.

FIG. 19 illustrates an example of a resource diagram 1900 in accordance with aspects of the present disclosure. In some examples, the resource diagram 1900 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, the time-frequency resource diagram 1000, the time-frequency resource diagram 1100, the time-frequency resource diagram 1200, the time-frequency resource diagram 1300, the time-frequency resource diagram 1400, the time-frequency resource diagram 1500, the time-frequency resource diagram 1600, the wireless communications system 1700, and the resource diagram 1800. For example, the resource diagram 1900 may be implemented by an NE or a UE, which may be an example of an NE 102 and a UE 104 as described with reference to FIG. 1. For example, the NE may generate one or more reference signals and a mapping between the reference signals and one or more resources (e.g., time-frequency resources and/or spatial resources) for transmission to UEs.

In some cases, an NE and/or a UE may use a same reference signal for positioning measurement and CSI measurement. However, the different usage cases may use different configurations of the reference signals. The NE may configure the UE to receive two downlink reference signals (e.g., a CSI-RS and a PRS). The NE and/or the UE may use a first reference signal of the two reference signals for channel measurement and a second reference signal of the two reference signals for positioning measurement. A density or periodicity of the two reference signals in the time domain and/or the frequency domain may be an integer multiple of the other. For example, the periodicity value of the first reference signal in the time domain is an integer multiple of the periodicity value of the second reference signal in the time domain, or vice versa. If the first reference signal is a CSI-RS and the second reference signal is a PRS, as illustrated in the resource diagram 1900, then the CSI-RS may have a periodicity or density, ρ, and the PRS may have a periodicity or density, 4ρ. In some examples, the frequency density values of the first reference signal and the second reference signal values are integer multiples of each other (e.g., the frequency density value of the first reference signal is an integer multiple of that of the second reference signal, or vice versa). A first offset value (e.g., in a time domain and/or a frequency domain) of the first reference signal and a second offset value of the second reference signal may be the same. In some cases, the two reference signals may have a same reference signal type (e.g., CSI-RS). In some other cases, the two reference signals may have a different reference signal type.

In some examples, if the first reference signal and the second reference signal are configured to be received over a same time slot, then the UE may receive one of the first reference signal or the second reference signal with a larger number of reference signal symbols over a same slot, a same RB, or any combination thereof. The first reference signal may be QCL with the second reference signal, the QCL is with respect to Type-A (e.g., average delay, delay spread, Doppler shift, Doppler spread) and with respect to and Type-D (e.g., spatial-domain receiver parameter), if applicable. A CSI-RS including two symbols with a periodicity value of p, is superimposed with a PRS including four symbols with a periodicity value of 4p. The UE may receive the PRS during the positioning occasion because the PRS has a higher density of symbols and can be used for both positioning measurement and channel measurement concurrently. In some cases, a UE can transmit signaling to one or more NEs that indicates a capability of the UE to support reception of a superposition of reference signals for both channel measurement and positioning measurement. The UE may transmit signaling that indicates the UE capability in an initial access procedure with an NE.

The NE and/or the UE may use a reference signal framework for joint positioning and channel measurements that includes sequence generation over a bundle of reference signals and/or superposition of reference signals. For example, the UE and/or the NE can use a separate reference signal for channel measurement and a bundle of reference signals for positioning measurement. Additionally, or alternatively, the UE can receive two reference signals, one corresponding to channel measurement and the other corresponding to positioning measurement. If the UE determines that the two reference signals are to be received in a same slot, RB, or both, then the UE may receive a denser of the two reference signals (e.g., with respect to a number of associated symbols) and may not receive the other of the two reference signals.

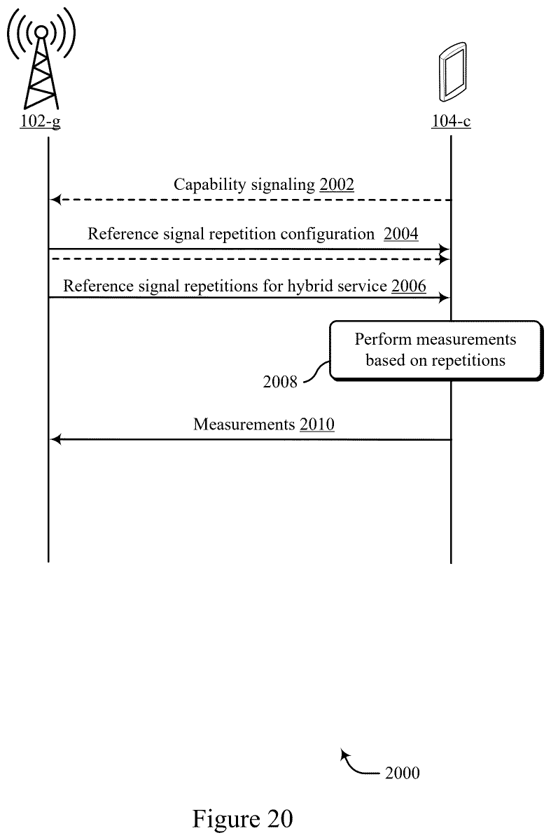

FIG. 20 illustrates an example signaling diagram 2000 in accordance with aspects of the present disclosure. In some examples, the signaling diagram 2000 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, the time-frequency resource diagram 1000, the time-frequency resource diagram 1100, the time-frequency resource diagram 1200, the time-frequency resource diagram 1300, the time-frequency resource diagram 1400, the time-frequency resource diagram 1500, the time-frequency resource diagram 1600, the wireless communications system 1700, the resource diagram 1800, and the resource diagram 1900. The signaling diagram 2000 may implement or be implemented by a UE 104-c and an NE 102-g, which may be examples of the corresponding devices as described with reference to FIGS. 1, 2, and 17. For example, the NE 102-g may transmit signaling that configures the UE 104-c with one or more reference signal repetitions for hybrid services (e.g., joint communication and non-communication services). Alternative examples of the following may be implemented, where some processes are performed in a different order than described or are not performed. In some cases, processes may include additional features not mentioned below, or further processes may be added.

In some cases, at 2002, the UE 104-c transmits capability signaling to the NE 102-g. In some cases, this capability signaling may be transmitted in response to a request received from the NE 102-g (e.g., a capability request from the either from a gNB or a centralized CN entity, such as an LMF and/or a sensing function). The capability signaling may indicate a capability of the UE 104-c to support one or more repetitions of a reference signal transmission within a resource in a time domain or across a set of resources in the time domain (e.g., repetition type 1 and/or repetitions type 2 configurations). Additionally, or alternatively, the capability signaling can indicate a capability of the UE 104-c to process the one or more repetitions in a set of consecutive resources. The resource may include at least one of a slot or a transmission time interval, and the set of resources may include at least one of a set of slots or a set of transmission time intervals.

At 2004, the NE 102-g transmits reference signal repetition configuration signaling to the UE 104-c. The signaling schedules one or more repetitions for a reference signal transmission from the NE 102-g to the UE 104-c. The UE 104-c can use the reference signal transmission for a first service for communications at the UE 104-c and a second service for a location determination of the UE 104-c and/or one or more sensing targets. The signaling may indicate a numerical quantity of resources in a set of consecutive resources in a time domain that include the repetitions. The numerical quantity of consecutive resources in the time domain can be based on the reported capability of the UE at 2002. Additionally, or alternatively, the signaling may include one or more periodicity values of the set of consecutive resources in the time domain. Additionally, or alternatively, the signaling may include one or more reference signal resource sets that include the one or more repetitions and a periodicity for performing measurements on the repetitions. Additionally, or alternatively, the signaling may include a bitmap indicating a position of the one or more repetitions within one or more resources in a time domain. Additionally, or alternatively, the signaling may include one or more parameters indicating a gap (e.g., offset) in a time domain for the one or more repetitions and a numerical quantity of repetitions within a resource in the time domain. Additionally, or alternatively, the signaling may include a parameter indicating a first RE in a time domain allocated for the one or more repetitions relative to a second RE allocated for the reference signal transmission without repetitions. Additionally, or alternatively, the signaling may include a flag indicating if the reference signal transmission is aperiodic.

In some cases, the set of consecutive resources may include at least one of a set of consecutive slots or a set of consecutive transmission time intervals. The reference signal transmission may be aperiodic if the one or more periodicity values are zero. The signaling may include at least one of DCI, RRC signaling, a MAC-CE, a LPP signaling, an NRPPa (e.g., NRPPa interface) signaling, a new sensing protocol signaling, or an NE to NE (e.g., Xn) interface protocol signaling.

In some examples, the NE 102-g transmits additional signaling prior to the signaling that indicates respective sets of resources in a time domain that are allocated for the reference signal transmission. The signaling activates at least one first set of resources in the time domain of the respective sets of resources in the time domain for the one or more repetitions or the signaling deactivates at least one second set of resources in the time domain of the respective sets of resources in the time domain for the one or more repetitions. In some cases, the first set of resources is the same as the second set of resources. In some other cases, the first set of resources and the second set of resources are different.

In some cases, the NE 102-g selects at least one of to transmit the one or more repetitions within a resource in a time domain (e.g., a slot or a transmission time interval) or to transmit the one or more repetitions across a set of resources in the time domain (e.g., one or more slots or one or more transmission time intervals) prior to transmitting the signaling. For example, the NE 102-g may determine whether to use a repetition type 1 or a repetition type 2 configuration for transmitting reference signals to the UE 104-c prior to transmission of scheduling information. The NE 102-g may perform the selection according to the capability signaling at 2002.

At 2006, the NE 102-g transmits reference signal repetitions for hybrid service to the UE 104-c based on the configuration signaling. The repetitions may be scheduled within a resource in a time domain (e.g., a slot or a transmission time interval) allocated for the reference signal transmission. In some cases, the resource can be configured for a single beam. In some other cases, the repetitions may span multiple resources in a time domain (e.g., one or more slots or one and/or more transmission time intervals) allocated for the reference signal transmission. The resources can be configured for multiple beams (e.g., multiple TRPs and/or NEs). The reference signal transmission may include, but is not limited to, at least one of a CSI-RS transmission, an SSB transmission, or an SRS transmission. For example, the reference signal may be a TRS (e.g., a CSI-RS for tracking) and/or one or more other types of reference signals. The NE 102-g and/or the UE 104-c may use the reference signals (e.g., one or more CSI-RSs) for different services (e.g., purposes), such as beam management, channel estimation, mobility, interference management, tracking, etc.

At 2008, the UE 104-c performs measurements based on the repetitions. The measurements may be for the second service corresponding to location determination of the UE 104-c and/or one or more sensing targets. For example, the measurements can include, but not limited to, UE receive-transmit time difference measurements, RSRP measurements, RSRPP measurements, downlink RSTD measurements, AoA measurements, reference signal carrier phase measurements, carrier phase difference measurements, Doppler measurements, Doppler difference measurements, path-based measurements, sample-based measurements, power delay profile measurements, angle delay profile measurements, Doppler range measurements, and Doppler delay measurements, among other examples.

At 2010, the UE 104-c transmits measurement signaling to the NE 102-g. The measurement signaling includes the measurements for the second service that were performed based on the reference signal repetitions. The first service may include at least one of a channel estimation service or a beamforming service (e.g., or other communication-related services, including but not limited to mobility, interference management, time offset and/or frequency offset tracking, among other examples). The second service may include at least one of a positioning service corresponding to a position of one or more target UEs or a sensing service corresponding to one or more sensing targets (e.g., objects in an environment of the UE 104-c or in the absence of any UE).

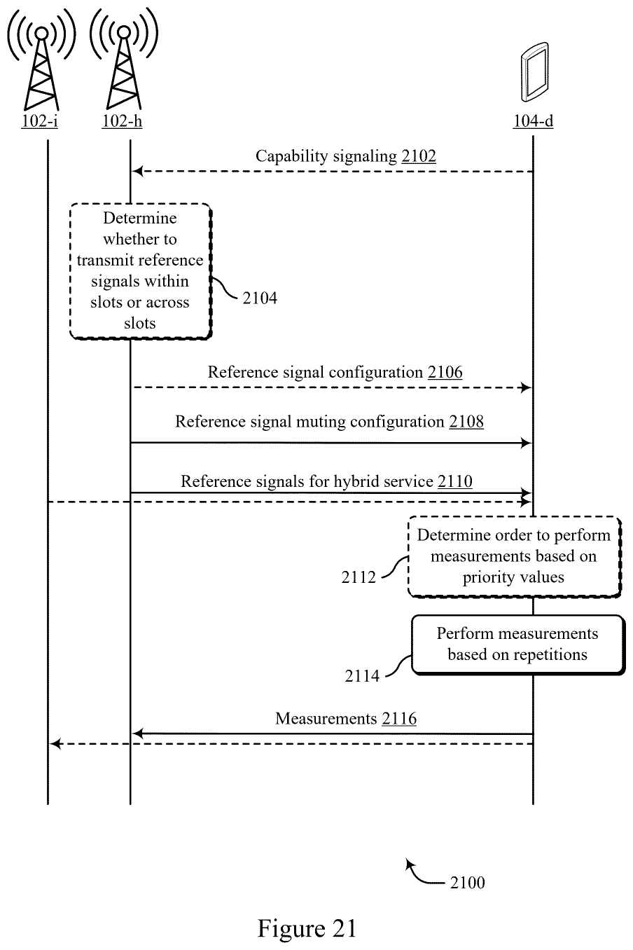

FIG. 21 illustrates an example signaling diagram 2100 in accordance with aspects of the present disclosure. In some examples, the signaling diagram 2100 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, the time-frequency resource diagram 1000, the time-frequency resource diagram 1100, the time-frequency resource diagram 1200, the time-frequency resource diagram 1300, the time-frequency resource diagram 1400, the time-frequency resource diagram 1500, the time-frequency resource diagram 1600, the wireless communications system 1700, the resource diagram 1800, the resource diagram 1900, and the signaling diagram 2000. The signaling diagram 2100 may implement or be implemented by a UE 104-d, an NE 102-h, and an NE 102-i, which may be examples of the corresponding devices as described with reference to FIGS. 1, 2, 17, and 20. For example, the NE 102-h may transmit signaling to the UE 104-d that indicates a muting configuration for one or more reference signals from the NE 102-h and/or the NE 102-i for hybrid services (e.g., joint communication and non-communication services). Alternative examples of the following may be implemented, where some processes are performed in a different order than described or are not performed. In some cases, processes may include additional features not mentioned below, or further processes may be added.

In some examples, at 2102, the UE 104-d and the NE 102-h exchange capability signaling. In some examples, this capability signaling may be transmitted in response to a request received from the NE 102-h (e.g., a capability request from the either from a gNB or a centralized CN entity, such as an LMF and/or a sensing function). The UE 104-d may transmit an indication of a capability to support reference signal transmission scheduled within or across respective slots of a set of slots in a time domain (e.g., repetition type 1 and/or repetition type 2 configurations). Additionally, or alternatively, the UE 104-d may transmit an indication of a capability to support one or more different muting configurations (e.g., a muting type 1 and/or muting type 2 configurations).

In some cases, at 2104, the NE 102-h determines whether to transmit reference signals within slots or across slots prior to transmitting signaling indicating a reference signal configuration. For example, the NE 102-h selects a repetition type 1 configuration or a repetition type 2 configuration for transmitting one or more reference signals. The NE 102-h may select the repetition configuration according to the capability signaling received at 2102.

In some examples, at 2106, the NE 102-h transmits reference signal configuration signaling to the UE 104-d. This signaling indicates a set of resources allocated for a reference signal transmission for a first service corresponding to communications at the UE 104-d and a second service corresponding to location determination of the UE 104-d and/or one or more sensing targets.

At 2108, the NE 102-h transmits reference signal muting configuration signaling to the UE 104-d. This signaling indicates a subset of resources that is has zero transmit power. The muting configuration may specify one or more REs within respective slots and/or one or more entire slots that are muted.

In some cases, the reference signal configuration signaling indicates a reference signal transmission is scheduled within respective slots of a set of slots in a time domain (e.g., repetition type 1). The respective slots are configured for a single beam. The reference signal muting configuration signaling indicates one or more REs of the respective slots including the subset of resources have the zero transmit power and one or more slots of the set of slots including the subset of resources have the zero transmit power (e.g., muting type 1 configuration). At least one of one or more additional REs of the respective slots or one or more additional slots of the set of slots include an additional subset of resources that has a non-zero transmit power. The additional REs are nonoverlapping with the REs and the one or more additional slots are nonoverlapping with the one or more slots.

Additionally, or alternatively, the reference signal configuration signaling indicates that the reference signal transmission is scheduled across respective slots of a set of slots in a time domain (e.g., repetition type 2). The respective slots are configured for multiple beams. The reference signal muting configuration signaling indicates one or more slots of the respective slots including the subset of resources have the zero transmit power (e.g., muting type 2 configuration). One or more additional slots of the set of slots include an additional subset of resources of the set of resources that have a non-zero transmit power. The one or more additional slots are nonoverlapping with the one or more slots.

At 2110, the NE 102-h and/or the NE 102-i transmit reference signal transmissions for hybrid service to the UE 104-d based on the configuration signaling. The reference signal transmissions may be scheduled within respective slots associated with a single beam or across respective slots associated with multiple beams. Some resources are transmitted with non-zero power while the subset of resources indicated in the muting configuration are transmitted with zero power.

At 2112, the UE 104-d determines the order to perform measurements based on priority values. In some cases, the signaling may indicate respective priority values corresponding to an order to perform measurements for an AoD of the reference signal transmission. The priority values may be per respective resources, subsets of resources, or NE (e.g., the NE 102-h and the NE 102-i). Additionally, or alternatively, the UE 104-d may determine the respective priority values from one or more identifiers for the reference signals. The priority values indicate an order to perform measurements for an AoD of the reference signal transmission. The identifiers can include, but are not limited to, a reference signal identifier (e.g., CSI-RS identifier), a PCI, a CGI, a CSI-RS resource identifier, an ARFCN, and/or a resource set identifier.

At 2114, the UE 104-d performs measurements based on the one or more reference signal transmissions. The measurements are for the second service corresponding to location determination of the UE 104-d (e.g., a position of the UE 104-d and/or one or more sensing targets). In some examples, the UE 104-d performs measurements using the reference signals from the NE 102-h and additional measurements using reference signals from the NE 102-i. For example, the UE 104-d may be allocated an additional set of resources for an additional reference signal transmission from the NE 102-i. In some cases, a subset of resources of the additional set of resources is within a threshold duration from the subset of resources of the set of resources allocated for the reference signal transmission from the NE 102-h. The subset of resources of the additional set of resources has a non-zero transmit power.

At 2116, the UE 104-d transmits the measurements to the NE 102-i and/or the NE 102-h. The measurement are based on the reference signal transmission and for the second service. The measurements can include, but not limited to, UE receive-transmit time difference measurements, RSRP measurements, RSRPP measurements, downlink RSTD measurements, AoA measurements, reference signal carrier phase measurements, carrier phase difference measurements, Doppler measurements, Doppler difference measurements, path-based measurements, sample-based measurements, power delay profile measurements, angle delay profile measurements, Doppler range measurements, and Doppler delay measurements, among other examples.

The reference signal transmission may include, but is not limited to, at least one of a CSI-RS transmission, an SSB transmission, or an SRS transmission. For example, the reference signal may be a TRS (e.g., a CSI-RS for tracking) and/or one or more other types of reference signals. The NE 102-g and/or the UE 104-c may use the reference signals (e.g., one or more CSI-RSs) for different services (e.g., purposes), such as beam management, channel estimation, mobility, interference management, tracking, etc. The first service may include at least one of a channel estimation service or a beamforming service (e.g., or other communication-related services, including but not limited to mobility, interference management, time offset and/or frequency offset tracking, among other examples). The second service may include at least one of a positioning service corresponding to a position of one or more target UEs or a sensing service corresponding to one or more sensing targets (e.g., objects in an environment of the UE 104-d or in the absence of any UE). The signaling including the reference signal configuration at 2106 and/or the reference signal muting configuration at 2108 may include at least one of DCI, RRC signaling, a MAC-CE, an LPP signaling, an NRPPa (e.g., NRPPa interface) signaling, a new sensing protocol signaling, or an NE to NE (e.g., Xn) interface protocol signaling.

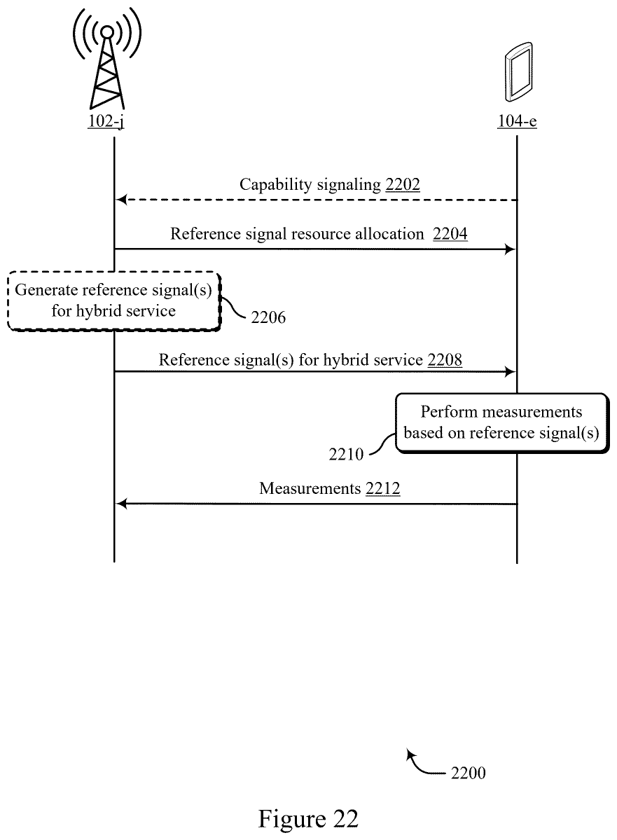

FIG. 22 illustrates an example signaling diagram 2200 in accordance with aspects of the present disclosure. In some examples, the signaling diagram 2200 implements or is implemented by aspects of the wireless communications system 100, the wireless communications system 200, the time-frequency resource diagram 300, the scenario 400, the aperiodic trigger state 500, the RRC configuration 600, the RRC configuration 700, the scenario 800, the CSI configuration 900, the time-frequency resource diagram 1000, the time-frequency resource diagram 1100, the time-frequency resource diagram 1200, the time-frequency resource diagram 1300, the time-frequency resource diagram 1400, the time-frequency resource diagram 1500, the time-frequency resource diagram 1600, the wireless communications system 1700, the resource diagram 1800, the resource diagram 1900, the signaling diagram 2000, and the signaling diagram 2100. The signaling diagram 2200 may implement or be implemented by a UE 104-e and an NE 102-j, which may be examples of the corresponding devices as described with reference to FIGS. 1, 2, 17, 20, and 21. For example, the NE 102-j may generate reference signals for transmission to a UE 104-e, where the reference signals are for hybrid services (e.g., joint communication and non-communication services). Alternative examples of the following may be implemented, where some processes are performed in a different order than described or are not performed. In some cases, processes may include additional features not mentioned below, or further processes may be added.

In some cases, at 2202, the UE 104-e and the NE 102-j exchange capability signaling. The UE 104-e may transmit an indication of a capability of the UE 104-e to receive a maximum numerical quantity of reference signals simultaneously.

At 2204, the NE 102-j transmits reference signal resource allocation signaling (e.g., a configuration signaling) to the UE 104-e. The configuration signaling indicates a set of resources allocated for one or more reference signals to be received at the UE 104-e. The reference signals are for a first service corresponding to channel estimation at the UE 104-e and a second service corresponding to location determination of the UE 104-e (e.g., a position of the UE 104-e and/or one or more sensing targets). The set of resources includes a non-zero power resource set, where respective resources of the non-zero power resource set include one or more REs. In some cases, the non-zero power resource set is allocated for a CSI-RS for the second service. Respective resources of the set of resources span multiple symbols in a same slot and a same RB, and the respective resources of the set of resources are configured for a single port.

The configuration signaling may include at least one parameter indicating one or more use cases for the reference signals for the first and second services, where the configuration signaling includes at least one of a CSI reporting setting, a reference signal configuration, or a positioning configuration. Additionally, or alternatively, the configuration signaling indicates a density value indicating a numerical quantity of RBs allocated for the reference signals in respective RBs of a frequency band. The UE 104-e may determine an index value of an initial subcarrier using the density value. Additionally, or alternatively, the configuration signaling indicates respective start symbols in a slot corresponding to the resources.

In some examples, at 2206, the NE 102-j generates reference signals for hybrid service based on one or more sequences. The sequences may be drawn from a common sequence including a common initialization value (e.g., factor) and based on alternating elements. The UE 104-e may map a resource bundle to a subset of reference signals for the second service. Consecutive entries of the common sequence include alternating reference signals in the subset of reference signals. A common sequence refers to a pseudorandom sequence generated using identical initialization parameters or seed values across multiple reference signals. The NE 102-j may use the common sequence to derive multiple reference signal sequences for hybrid services by applying the same base sequence with different offsets, phase rotations, or resource mappings.

At 2208, the NE 102-j transmits the reference signals to the UE 104-e based on the allocated resources and sequences. The reference signals may include one or more of a CSI-RS, an SSB, a sensing reference signal, and/or an SRS. In some cases, the reference signals include a first reference signal for the first service and a second reference signal for the second service. The first reference signal and the second reference signal are a same reference signal type. A periodicity value for the second reference signal is an integer multiple of a periodicity value for the first reference signal. Additionally, or alternatively, a frequency density value for the second reference signal is an integer multiple of a frequency density value for the first reference signal.

Additionally, or alternatively, the first reference signal is QCL with the second reference signal according to at least one of an average delay, a delay spread, a Doppler shift, a Doppler spread, or a spatial reception parameter. In some examples, the NE 102-j may transmit one of the first reference signal or the second reference signal using resources that span a same time slot, where a numerical quantity (e.g., number, amount) of symbols allocated for the second reference signal is greater than a numerical quantity of symbols allocated for the first reference signal in at least one of the same time slot or an RB.

At 2210, the UE 104-e performs measurements based on the received reference signals. At least one resource corresponds to measurements associated with both the first service and second service. In some cases, the UE 104-e may receive one of two reference signals in a same time slot based on symbol quantity. The measurements can include, but not limited to, UE receive-transmit time difference measurements, RSRP measurements, RSRPP measurements, downlink RSTD measurements, AoA measurements, reference signal carrier phase measurements, carrier phase difference measurements, Doppler measurements, Doppler difference measurements, path-based measurements, sample-based measurements, power delay profile measurements, angle delay profile measurements, Doppler range measurements, and Doppler delay measurements, among other examples

At 2212, the UE 104-e transmits the measurements to the NE 102-j. The measurements are associated with at least one of the first service or second service. The first service may include channel measurements, CSI computations, precoding matrix indicator calculation, or beamforming acquisition. The second service may include positioning of target UEs or sensing of one or more sensing targets (e.g., objects in the environment of the UE 104-e or in the absence of any UE).

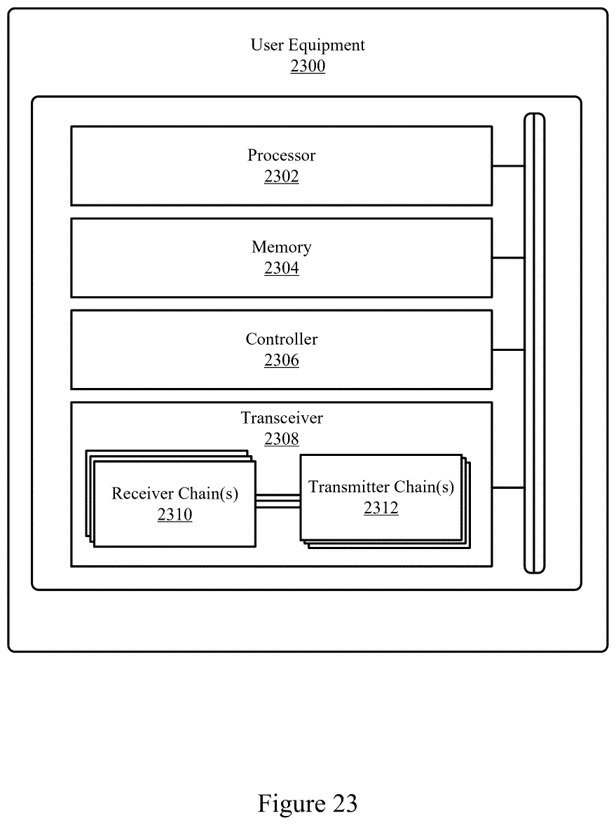

FIG. 23 illustrates an example of a UE 2300 in accordance with aspects of the present disclosure. The UE 2300 may include a processor 2302, a memory 2304, a controller 2306, and a transceiver 2308. The processor 2302, the memory 2304, the controller 2306, or the transceiver 2308, or various combinations thereof or various components thereof may be examples of means for performing various aspects of the present disclosure as described herein. These components may be coupled (e.g., operatively, communicatively, functionally, electronically, electrically) via one or more interfaces.

The processor 2302, the memory 2304, the controller 2306, or the transceiver 2308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2302 may include an intelligent hardware device (e.g., a general-purpose processor, a DSP, a CPU, an ASIC, an FPGA, or any combination thereof). In some implementations, the processor 2302 may be configured to operate the memory 2304. In some other implementations, the memory 2304 may be integrated into the processor 2302. The processor 2302 may be configured to execute computer-readable instructions stored in the memory 2304 to cause the UE 2300 to perform various functions of the present disclosure.

The memory 2304 may include volatile or non-volatile memory. The memory 2304 may store computer-readable, computer-executable code including instructions when executed by the processor 2302 cause the UE 2300 to perform various functions described herein. The code may be stored in a non-transitory computer-readable medium such as the memory 2304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2302 and the memory 2304 coupled with the processor 2302 may be configured to cause the UE 2300 to perform one or more of the functions described herein (e.g., executing, by the processor 2302, instructions stored in the memory 2304). For example, the processor 2302 may support wireless communication at the UE 2300 in accordance with examples as disclosed herein. The UE 2300 may be configured to or operable to support a means for receiving signaling that indicates a subset of resources of a set of resources allocated for a reference signal transmission is associated with zero transmit power, where the reference signal transmission is associated with a first service corresponding to communications at the UE and a second service corresponding to a location determination of the UE and/or one or more sensing targets, performing, based on the set of resources, one or more measurements associated with the second service, and transmitting the one or more measurements associated with the second service.

Additionally, the UE 2300 may be configured to support any one or combination of receiving additional signaling that indicates the reference signal transmission is scheduled within respective slots of a set of slots in a time domain, where the respective slots are associated with a single beam, and where the signaling indicates one or more REs of the respective slots including the subset of resources are associated with the zero transmit power and one or more slots of the set of slots including the subset of resources are associated with the zero transmit power. Additionally, or alternatively, the UE 2300 may be configured to support at least one of one or more additional REs of the respective slots or one or more additional slots of the set of slots include an additional subset of resources of the set of resources that is associated with a non-zero transmit power, where the one or more additional REs are nonoverlapping with the one or more REs and the one or more additional slots are nonoverlapping with the one or more slots.

Additionally, or alternatively, the UE 2300 may be configured to support receiving additional signaling that indicates the reference signal transmission is scheduled across respective slots of a set of slots in a time domain, where the respective slots are associated with a set of beams, and where the signaling indicates one or more slots of the respective slots including the subset of resources are associated with the zero transmit power. Additionally, or alternatively, the UE 2300 may be configured to support one or more additional slots of the set of slots include an additional subset of resources of the set of resources that is associated with a non-zero transmit power, where the one or more additional slots are nonoverlapping with the one or more slots. Additionally, or alternatively, the UE 2300 may be configured to support transmitting an indication of a capability of the UE to support at least one of the reference signal transmission being scheduled within respective slots of a set of slots in a time domain or the reference signal transmission being scheduled across the respective slots. Additionally, or alternatively, the UE 2300 may be configured to support the signaling indicates respective priority values corresponding to an order to perform the one or more measurements, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources.

Additionally, or alternatively, the UE 2300 may be configured to support determining respective priority values corresponding to an order to perform the one or more measurements based on the reference signal transmission including a set of identifiers, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources. Additionally, or alternatively, the UE 2300 may be configured to support the set of identifiers includes a reference signal identifier corresponding to the respective resources, a PCI corresponding to the respective resources, a CGI identifier corresponding to the respective resources, a CSI-RS resource identifier, an ARFCN, and a resource set identifier. Additionally, or alternatively, the UE 2300 may be configured to support the reference signal transmission is from a first NE, and performing, based on an additional set of resources allocated for an additional reference signal transmission from a second NE, one or more additional measurements, where a subset of resources of the additional set of resources is within a threshold duration from the subset of resources of the set of resources, and where the subset of resources of the additional set of resources is associated with a non-zero transmit power, and transmitting, to the second NE, the one or more additional measurements.

Additionally, or alternatively, the UE 2300 may be configured to support the first service includes at least one of a channel estimation service or a beamforming service, and where the second service includes at least one of a positioning service corresponding to a position of one or more target UEs or a sensing service corresponding to one or more objects in an environment of the UE 2300 or in an absence of any UE. Additionally, or alternatively, the UE 2300 may be configured to support the reference signal transmission includes at least one of a CSI-RS transmission, an SSB transmission, or an SRS transmission. Additionally, or alternatively, the UE 2300 may be configured to support the signaling is received from an NE, and where the signaling includes at least one of DCI, RRC signaling, a MAC-CE, an LPP signaling, an NRPPa signaling, a new sensing protocol signaling, or an NE to NE interface protocol signaling.

Additionally, or alternatively, the UE 2300 may support at least one memory (e.g., the memory 2304) and at least one processor (e.g., the processor 2302) coupled with the at least one memory and configured to cause the UE to receive signaling that indicates a subset of resources of a set of resources allocated for a reference signal transmission is associated with zero transmit power, where the reference signal transmission is associated with a first service corresponding to communications at the UE and a second service corresponding to a location determination of the UE and/or one or more sensing targets, perform, based on the set of resources, one or more measurements associated with the second service, and transmit the one or more measurements associated with the second service.

Additionally, the UE 2300 may be configured to support any one or combination of receive additional signaling that indicates the reference signal transmission is scheduled within respective slots of a set of slots in a time domain, where the respective slots are associated with a single beam, and where the signaling indicates one or more REs of the respective slots including the subset of resources are associated with the zero transmit power and one or more slots of the set of slots including the subset of resources are associated with the zero transmit power. Additionally, or alternatively, the UE 2300 may be configured to support at least one of one or more additional REs of the respective slots or one or more additional slots of the set of slots include an additional subset of resources of the set of resources that is associated with a non-zero transmit power, where the one or more additional REs are nonoverlapping with the one or more REs and the one or more additional slots are nonoverlapping with the one or more slots. Additionally, or alternatively, the UE 2300 may be configured to support to receive additional signaling that indicates the reference signal transmission is scheduled across respective slots of a set of slots in a time domain, where the respective slots are associated with a set of beams, and where the signaling indicates one or more slots of the respective slots including the subset of resources are associated with the zero transmit power.

Additionally, or alternatively, the UE 2300 may be configured to support one or more additional slots of the set of slots include an additional subset of resources of the set of resources that is associated with a non-zero transmit power, where the one or more additional slots are nonoverlapping with the one or more slots. Additionally, or alternatively, the UE 2300 may be configured to support transmit an indication of a capability of the UE to support at least one of the reference signal transmission being scheduled within respective slots of a set of slots in a time domain or the reference signal transmission being scheduled across the respective slots. Additionally, or alternatively, the UE 2300 may be configured to support the signaling indicates respective priority values corresponding to an order to perform the one or more measurements, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources.

Additionally, or alternatively, the UE 2300 may be configured to support determine respective priority values corresponding to an order to perform the one or more measurements based on the reference signal transmission including a set of identifiers, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources. Additionally, or alternatively, the UE 2300 may be configured to support the set of identifiers includes a reference signal identifier corresponding to the respective resources, a PCI corresponding to the respective resources, a CGI identifier corresponding to the respective resources, a CSI-RS resource identifier, an ARFCN, and a resource set identifier.

Additionally, or alternatively, the UE 2300 may be configured to support the reference signal transmission is from a first NE, and perform, based on an additional set of resources allocated for an additional reference signal transmission from a second NE, one or more additional measurements, where a subset of resources of the additional set of resources is within a threshold duration from the subset of resources of the set of resources, and where the subset of resources of the additional set of resources is associated with a non-zero transmit power, and transmit, to the second NE, the one or more additional measurements. Additionally, or alternatively, the UE 2300 may be configured to support the first service includes at least one of a channel estimation service or a beamforming service, and where the second service includes at least one of a positioning service corresponding to a position of one or more target UEs or a sensing service corresponding to one or more objects in an environment of the UE 2300 or in an absence of any UE. Additionally, or alternatively, the UE 2300 may be configured to support the reference signal transmission includes at least one of a CSI-RS transmission, an SSB transmission, or an SRS transmission. Additionally, or alternatively, the UE 2300 may be configured to support the signaling is received from an NE, and where the signaling includes at least one of DCI, RRC signaling, a MAC-CE, an LPP signaling, an NRPP signaling, a new sensing protocol signaling, or an NE to NE interface protocol signaling.

The controller 2306 may manage input and output signals for the UE 2300. The controller 2306 may also manage peripherals not integrated into the UE 2300. In some implementations, the controller 2306 may utilize an operating system such as iOS®, ANDROID®, WINDOWS®, or other operating systems. In some implementations, the controller 2306 may be implemented as part of the processor 2302.

In some implementations, the UE 2300 may include at least one transceiver 2308. In some other implementations, the UE 2300 may have more than one transceiver 2308. The transceiver 2308 may represent a wireless transceiver. The transceiver 2308 may include one or more receiver chains 2310, one or more transmitter chains 2312, or a combination thereof.

A receiver chain 2310 may be configured to receive signals (e.g., control information, data, packets) over a wireless medium. For example, the receiver chain 2310 may include one or more antennas to receive a signal over the air or wireless medium. The receiver chain 2310 may include at least one amplifier (e.g., an LNA) configured to amplify the received signal. The receiver chain 2310 may include at least one demodulator configured to demodulate the receive signal and obtain the transmitted data by reversing the modulation technique applied during transmission of the signal. The receiver chain 2310 may include at least one decoder for decoding the demodulated signal to receive the transmitted data.

A transmitter chain 2312 may be configured to generate and transmit signals (e.g., control information, data, packets). The transmitter chain 2312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2312 may also include at least one power amplifier configured to amplify the modulated signal to an appropriate power level suitable for transmission over the wireless medium. The transmitter chain 2312 may also include one or more antennas for transmitting the amplified signal into the air or wireless medium.

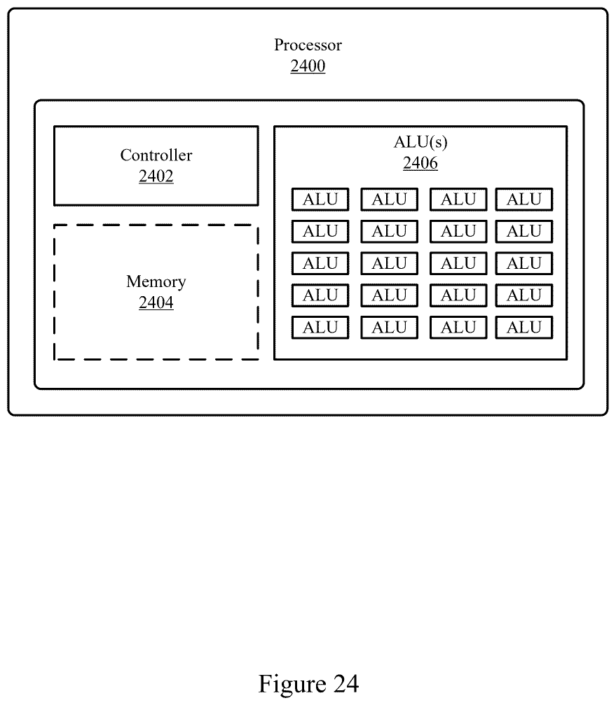

FIG. 24 illustrates an example of a processor 2400 in accordance with aspects of the present disclosure. The processor 2400 may be an example of a processor configured to perform various operations in accordance with examples as described herein. The processor 2400 may include a controller 2402 configured to perform various operations in accordance with examples as described herein. The processor 2400 may optionally include at least one memory 2404, which may be, for example, an L1/L2/L3 cache. Additionally, or alternatively, the processor 2400 may optionally include one or more arithmetic-logic units (ALUs) 2406. One or more of these components may be in electronic communication or otherwise coupled (e.g., operatively, communicatively, functionally, electronically, electrically) via one or more interfaces (e.g., buses).

The processor 2400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 2400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 2402 may be configured to manage and coordinate various operations (e.g., signaling, receiving, obtaining, retrieving, transmitting, outputting, forwarding, storing, determining, identifying, accessing, writing, reading) of the processor 2400 to cause the processor 2400 to support various operations in accordance with examples as described herein. For example, the controller 2402 may operate as a control unit of the processor 2400, generating control signals that manage the operation of various components of the processor 2400. These control signals include enabling or disabling functional units, selecting data paths, initiating memory access, and coordinating timing of operations.

The controller 2402 may be configured to fetch (e.g., obtain, retrieve, receive) instructions from the memory 2404 and determine subsequent instruction(s) to be executed to cause the processor 2400 to support various operations in accordance with examples as described herein. The controller 2402 may be configured to track memory addresses of instructions associated with the memory 2404. The controller 2402 may be configured to decode instructions to determine the operation to be performed and the operands involved. For example, the controller 2402 may be configured to interpret the instruction and determine control signals to be output to other components of the processor 2400 to cause the processor 2400 to support various operations in accordance with examples as described herein. Additionally, or alternatively, the controller 2402 may be configured to manage flow of data within the processor 2400. The controller 2402 may be configured to control transfer of data between registers, ALUs 2406, and other functional units of the processor 2400.

The memory 2404 may include one or more caches (e.g., memory local to or included in the processor 2400 or other memory, such as RAM, ROM, DRAM, SDRAM, SRAM, MRAM, flash memory, etc. In some implementations, the memory 2404 may reside within or on a processor chipset (e.g., local to the processor 2400). In some other implementations, the memory 2404 may reside external to the processor chipset (e.g., remote to the processor 2400).

The memory 2404 may store computer-readable, computer-executable code including instructions that, when executed by the processor 2400, cause the processor 2400 to perform various functions described herein. The code may be stored in a non-transitory computer-readable medium such as system memory or another type of memory. The controller 2402 and/or the processor 2400 may be configured to execute computer-readable instructions stored in the memory 2404 to cause the processor 2400 to perform various functions. For example, the processor 2400 and/or the controller 2402 may be coupled with or to the memory 2404, the processor 2400, and the controller 2402, and may be configured to perform various functions described herein. In some examples, the processor 2400 may include multiple processors and the memory 2404 may include multiple memories. One or more of the multiple processors may be coupled with one or more of the multiple memories, which may, individually or collectively, be configured to perform various functions herein.

The one or more ALUs 2406 may be configured to support various operations in accordance with examples as described herein. In some implementations, the one or more ALUs 2406 may reside within or on a processor chipset (e.g., the processor 2400). In some other implementations, the one or more ALUs 2406 may reside external to the processor chipset (e.g., the processor 2400). One or more ALUs 2406 may perform one or more computations such as addition, subtraction, multiplication, and division on data. For example, one or more ALUs 2406 may receive input operands and an operation code, which determines an operation to be executed. One or more ALUs 2406 may be configured with a variety of logical and arithmetic circuits, including adders, subtractors, shifters, and logic gates, to process and manipulate the data according to the operation. Additionally, or alternatively, the one or more ALUs 2406 may support logical operations such as AND, OR, exclusive-OR (XOR), not-OR (NOR), and not-AND (NAND), enabling the one or more ALUs 2406 to handle conditional operations, comparisons, and bitwise operations.

The processor 2400 may be configured to or operable to support at least one controller (e.g., the controller 2402) coupled with at least one memory (e.g., the memory 2404) and configured to cause the processor to receive signaling that indicates a subset of resources of a set of resources allocated for a reference signal transmission is associated with zero transmit power, where the reference signal transmission is associated with a first service corresponding to communications at the processor 2400 and a second service corresponding to a location determination of the processor 2400 and/or one or more sensing targets, perform, based on the set of resources, one or more measurements associated with the second service, and transmit the one or more measurements associated with the second service.

Additionally, the processor 2400 may be configured to or operable to support any one or combination of receive additional signaling that indicates the reference signal transmission is scheduled within respective slots of a set of slots in a time domain, where the respective slots are associated with a single beam, and where the signaling indicates one or more REs of the respective slots including the subset of resources are associated with the zero transmit power and one or more slots of the set of slots including the subset of resources are associated with the zero transmit power. Additionally, or alternatively, the processor 2400 may be configured to support at least one of one or more additional REs of the respective slots or one or more additional slots of the set of slots include an additional subset of resources of the set of resources that is associated with a non-zero transmit power, where the one or more additional REs are nonoverlapping with the one or more REs and the one or more additional slots are nonoverlapping with the one or more slots. Additionally, or alternatively, the processor 2400 may be configured to support to receive additional signaling that indicates the reference signal transmission is scheduled across respective slots of a set of slots in a time domain, where the respective slots are associated with a set of beams, and where the signaling indicates one or more slots of the respective slots including the subset of resources are associated with the zero transmit power.

Additionally, or alternatively, the processor 2400 may be configured to support one or more additional slots of the set of slots include an additional subset of resources of the set of resources that is associated with a non-zero transmit power, where the one or more additional slots are nonoverlapping with the one or more slots. Additionally, or alternatively, the processor 2400 may be configured to support to transmit an indication of a capability of the processor 2400 to support at least one of the reference signal transmission being scheduled within respective slots of a set of slots in a time domain or the reference signal transmission being scheduled across the respective slots. Additionally, or alternatively, the processor 2400 may be configured to support the signaling indicates respective priority values corresponding to an order to perform the one or more measurements, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources.

Additionally, or alternatively, the processor 2400 may be configured to support to determine respective priority values corresponding to an order to perform the one or more measurements based on the reference signal transmission including a set of identifiers, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources. Additionally, or alternatively, the processor 2400 may be configured to support the set of identifiers includes a reference signal identifier corresponding to the respective resources, a PCI corresponding to the respective resources, a CGI identifier corresponding to the respective resources, a CSI-RS resource identifier, an ARFCN, and a resource set identifier.

Additionally, or alternatively, the processor 2400 may be configured to support the reference signal transmission is from a first NE, and perform, based on an additional set of resources allocated for an additional reference signal transmission from a second NE, one or more additional measurements, where a subset of resources of the additional set of resources is within a threshold duration from the subset of resources of the set of resources, and where the subset of resources of the additional set of resources is associated with a non-zero transmit power, and transmit, to the second NE, the one or more additional measurements. Additionally, or alternatively, the processor 2400 may be configured to support the first service includes at least one of a channel estimation service or a beamforming service, and where the second service includes at least one of a positioning service corresponding to a position of one or more target UEs or a sensing service corresponding to one or more objects in an environment of the processor 2400 or in an absence of any UE. Additionally, or alternatively, the processor 2400 may be configured to support the reference signal transmission includes at least one of a CSI-RS transmission, an SSB transmission, or an SRS transmission. Additionally, or alternatively, the processor 2400 may be configured to support the signaling is received from an NE, and where the signaling includes at least one of DCI, RRC signaling, a MAC-CE, an LPP signaling, an NRPPa signaling, a new sensing protocol signaling, or an NE to NE interface protocol signaling.

The processor 2400 may be configured to or operable to support at least one controller (e.g., the controller 2402) coupled with at least one memory (e.g., the memory 2404) and configured to cause the processor to transmit signaling that indicates a subset of resources of a set of resources allocated for a reference signal transmission is associated with zero transmit power, where the reference signal transmission is associated with a first service corresponding to communications at a UE and a second service corresponding to a location determination of the UE and/or one or more sensing targets, transmit, responsive to the signaling, the reference signal transmission using the set of resources allocated for the reference signal transmission, and receive, based on the set of resources, one or more measurements associated with the second service.

Additionally, the processor 2400 may be configured to or operable to support any one or combination of select, prior to transmitting the signaling, at least one of to transmit the reference signal transmission within respective slots of a set of slots in a time domain or to transmit the reference signal transmission across the respective slots. Additionally, or alternatively, the processor 2400 may be configured to support to transmit additional signaling that indicates the reference signal transmission is scheduled within respective slots of a set of slots in a time domain, where the respective slots are associated with a single beam, and where the signaling indicates one or more REs of the respective slots including the subset of resources are associated with the zero transmit power and one or more slots of the set of slots including the subset of resources are associated with the zero transmit power. Additionally, or alternatively, the processor 2400 may be configured to support at least one of one or more additional REs of the respective slots or one or more additional slots of the set of slots include an additional subset of resources of the set of resources that is associated with a non-zero transmit power, where the one or more additional REs are nonoverlapping with the one or more REs and the one or more additional slots are nonoverlapping with the one or more slots.

Additionally, or alternatively, the processor 2400 may be configured to support to transmit additional signaling that indicates the reference signal transmission is scheduled across respective slots of a set of slots in a time domain, where the respective slots are associated with a set of beams, and where the signaling indicates one or more slots of the respective slots including the subset of resources are associated with the zero transmit power. Additionally, or alternatively, the processor 2400 may be configured to support one or more additional slots of the set of slots include an additional subset of resources of the set of resources that is associated with a non-zero transmit power, where the one or more additional slots are nonoverlapping with the one or more slots. Additionally, or alternatively, the processor 2400 may be configured to support to receive, from the UE, an indication of a capability of the UE to support at least one of the reference signal transmission being scheduled within respective slots of a set of slots in a time domain or the reference signal transmission being scheduled across the respective slots. Additionally, or alternatively, the processor 2400 may be configured to support the signaling indicates respective priority values corresponding to an order to perform the one or more measurements, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources.

Additionally, or alternatively, the processor 2400 may be configured to support the reference signal transmission includes a set of identifiers, where the one or more measurements are associated with an angle of departure of the reference signal transmission, and where the set of identifiers includes a reference signal identifier corresponding to respective resources of the set of resources, a PCI corresponding to the respective resources, a CGI identifier corresponding to the respective resources, a CSI-RS resource identifier, an ARFCN, and a resource set identifier. Additionally, or alternatively, the processor 2400 may be configured to support the first service includes at least one of a channel estimation service or a beamforming service, and where the second service includes at least one of a positioning service corresponding to a position of one or more target UEs or a sensing service corresponding to one or more objects in an environment of the UE or in an absence of any UE. Additionally, or alternatively, the processor 2400 may be configured to support the reference signal transmission includes at least one of a CSI-RS transmission, an SSB transmission, or an SRS transmission. Additionally, or alternatively, the processor 2400 may be configured to support the signaling includes at least one of DCI, RRC signaling, a MAC-CE, an LPP signaling, an NRPPa signaling, a new sensing protocol signaling, or an NE to NE interface protocol signaling.

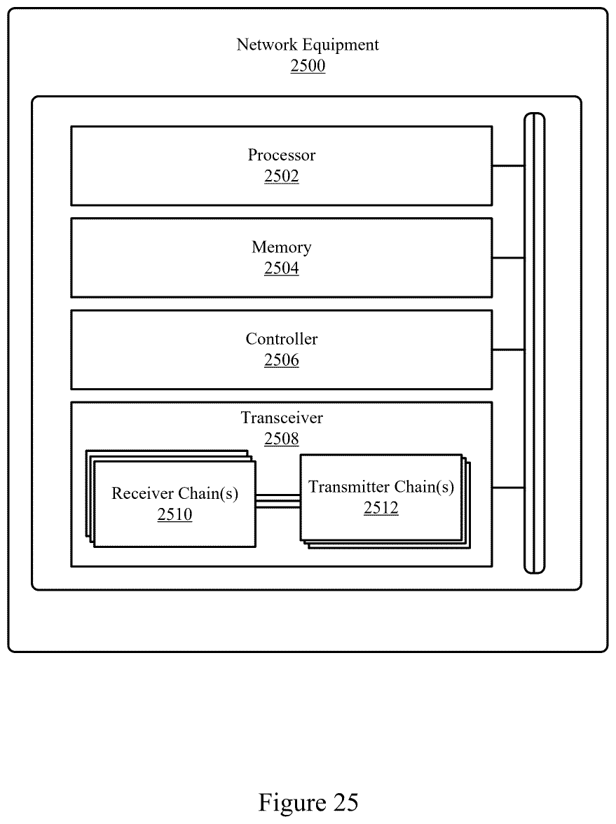

FIG. 25 illustrates an example of an NE 2500 in accordance with aspects of the present disclosure. The NE 2500 may include a processor 2502, a memory 2504, a controller 2506, and a transceiver 2508. The processor 2502, the memory 2504, the controller 2506, or the transceiver 2508, or various combinations thereof or various components thereof may be examples of means for performing various aspects of the present disclosure as described herein. These components may be coupled (e.g., operatively, communicatively, functionally, electronically, electrically) via one or more interfaces.

The processor 2502, the memory 2504, the controller 2506, or the transceiver 2508, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 2502 may include an intelligent hardware device (e.g., a general-purpose processor, a DSP, a CPU, an ASIC, an FPGA, or any combination thereof). In some implementations, the processor 2502 may be configured to operate the memory 2504. In some other implementations, the memory 2504 may be integrated into the processor 2502. The processor 2502 may be configured to execute computer-readable instructions stored in the memory 2504 to cause the NE 2500 to perform various functions of the present disclosure.

The memory 2504 may include volatile or non-volatile memory. The memory 2504 may store computer-readable, computer-executable code including instructions when executed by the processor 2502 cause the NE 2500 to perform various functions described herein. The code may be stored in a non-transitory computer-readable medium such as the memory 2504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

The NE 2500 may be configured to or operable to support a means for transmitting signaling that indicates a subset of resources of a set of resources allocated for a reference signal transmission is associated with zero transmit power, where the reference signal transmission is associated with a first service corresponding to communications at a UE and a second service corresponding to a location determination of the UE and/or one or more sensing targets, transmitting, responsive to the signaling, the reference signal transmission using the set of resources allocated for the reference signal transmission, and receiving, based on the set of resources, one or more measurements associated with the second service.

Additionally, the NE 2500 may be configured to support any one or combination of selecting, prior to transmitting the signaling, at least one of to transmit the reference signal transmission within respective slots of a set of slots in a time domain or to transmit the reference signal transmission across the respective slots. Additionally, or alternatively, the NE 2500 may be configured to support transmitting additional signaling that indicates the reference signal transmission is scheduled within respective slots of a set of slots in a time domain, where the respective slots are associated with a single beam, and where the signaling indicates one or more REs of the respective slots including the subset of resources are associated with the zero transmit power and one or more slots of the set of slots including the subset of resources are associated with the zero transmit power. Additionally, or alternatively, the NE 2500 may be configured to support at least one of one or more additional REs of the respective slots or one or more additional slots of the set of slots include an additional subset of resources of the set of resources that is associated with a non-zero transmit power, where the one or more additional REs are nonoverlapping with the one or more REs and the one or more additional slots are nonoverlapping with the one or more slots.

Additionally, or alternatively, the NE 2500 may be configured to support transmitting additional signaling that indicates the reference signal transmission is scheduled across respective slots of a set of slots in a time domain, where the respective slots are associated with a set of beams, and where the signaling indicates one or more slots of the respective slots including the subset of resources are associated with the zero transmit power. Additionally, or alternatively, the NE 2500 may be configured to support one or more additional slots of the set of slots include an additional subset of resources of the set of resources that is associated with a non-zero transmit power, where the one or more additional slots are nonoverlapping with the one or more slots. Additionally, or alternatively, the NE 2500 may be configured to support receiving, from the UE, an indication of a capability of the UE to support at least one of the reference signal transmission being scheduled within respective slots of a set of slots in a time domain or the reference signal transmission being scheduled across the respective slots. Additionally, or alternatively, the NE 2500 may be configured to support the signaling indicates respective priority values corresponding to an order to perform the one or more measurements, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources.

Additionally, or alternatively, the NE 2500 may be configured to support the reference signal transmission includes a set of identifiers, where the one or more measurements are associated with an angle of departure of the reference signal transmission, and where the set of identifiers includes a reference signal identifier corresponding to respective resources of the set of resources, a PCI corresponding to the respective resources, a CGI identifier corresponding to the respective resources, a CSI-RS resource identifier, an ARFCN, and a resource set identifier. Additionally, or alternatively, the NE 2500 may be configured to support the first service includes at least one of a channel estimation service or a beamforming service, and where the second service includes at least one of a positioning service corresponding to a position of one or more target UEs or a sensing service corresponding to one or more objects in an environment of the UE or in an absence of any UE. Additionally, or alternatively, the NE 2500 may be configured to support the reference signal transmission includes at least one of a CSI-RS transmission, an SSB transmission, or an SRS transmission. Additionally, or alternatively, the NE 2500 may be configured to support the signaling includes at least one of DCI, RRC signaling, a MAC-CE, an LPP signaling, an NRPPa signaling, a new sensing protocol signaling, or an NE to NE interface protocol signaling.

Additionally, or alternatively, the NE 2500 may support at least one memory (e.g., the memory 2504) and at least one processor (e.g., the processor 2502) coupled with the at least one memory and configured to cause the NE to transmit signaling that indicates a subset of resources of a set of resources allocated for a reference signal transmission is associated with zero transmit power, where the reference signal transmission is associated with a first service corresponding to communications at a UE and a second service corresponding to a location determination of the UE and/or one or more sensing targets, transmit, responsive to the signaling, the reference signal transmission using the set of resources allocated for the reference signal transmission, and receive, based on the set of resources, one or more measurements associated with the second service.

Additionally, the NE 2500 may be configured to support any one or combination of select, prior to transmitting the signaling, at least one of to transmit the reference signal transmission within respective slots of a set of slots in a time domain or to transmit the reference signal transmission across the respective slots. Additionally, or alternatively, the NE 2500 may be configured to support to transmit additional signaling that indicates the reference signal transmission is scheduled within respective slots of a set of slots in a time domain, where the respective slots are associated with a single beam, and where the signaling indicates one or more REs of the respective slots including the subset of resources are associated with the zero transmit power and one or more slots of the set of slots including the subset of resources are associated with the zero transmit power. Additionally, or alternatively, the NE 2500 may be configured to support at least one of one or more additional REs of the respective slots or one or more additional slots of the set of slots include an additional subset of resources of the set of resources that is associated with a non-zero transmit power, where the one or more additional REs are nonoverlapping with the one or more REs and the one or more additional slots are nonoverlapping with the one or more slots.

Additionally, or alternatively, the NE 2500 may be configured to support to transmit additional signaling that indicates the reference signal transmission is scheduled across respective slots of a set of slots in a time domain, where the respective slots are associated with a set of beams, and where the signaling indicates one or more slots of the respective slots including the subset of resources are associated with the zero transmit power. Additionally, or alternatively, the NE 2500 may be configured to support one or more additional slots of the set of slots include an additional subset of resources of the set of resources that is associated with a non-zero transmit power, where the one or more additional slots are nonoverlapping with the one or more slots. Additionally, or alternatively, the NE 2500 may be configured to support to receive, from the UE, an indication of a capability of the UE to support at least one of the reference signal transmission being scheduled within respective slots of a set of slots in a time domain or the reference signal transmission being scheduled across the respective slots. Additionally, or alternatively, the NE 2500 may be configured to support the signaling indicates respective priority values corresponding to an order to perform the one or more measurements, where the one or more measurements are associated with an angle of departure of the reference signal transmission, and where the respective priority values are associated with at least one of respective resources of the set of resources, respective subsets of resources of the set of resources, or one or more NE associated with the respective resources of the set of resources.

Additionally, or alternatively, the NE 2500 may be configured to support the reference signal transmission includes a set of identifiers, where the one or more measurements are associated with an angle of departure of the reference signal transmission, and where the set of identifiers includes a reference signal identifier corresponding to respective resources of the set of resources, a PCI corresponding to the respective resources, a CGI identifier corresponding to the respective resources, a CSI-RS resource identifier, an ARFCN, and a resource set identifier. Additionally, or alternatively, the NE 2500 may be configured to support the first service includes at least one of a channel estimation service or a beamforming service, and where the second service includes at least one of a positioning service corresponding to a position of one or more target UEs or a sensing service corresponding to one or more objects in an environment of the UE or in an absence of any UE. Additionally, or alternatively, the NE 2500 may be configured to support the reference signal transmission includes at least one of a CSI-RS transmission, an SSB transmission, or an SRS transmission. Additionally, or alternatively, the NE 2500 may be configured to support the signaling includes at least one of DCI, RRC signaling, a MAC-CE, an LPP signaling, an NRPPa signaling, a new sensing protocol signaling, or an NE to NE interface protocol signaling.

The controller 2506 may manage input and output signals for the NE 2500. The controller 2506 may also manage peripherals not integrated into the NE 2500. In some implementations, the controller 2506 may utilize an operating system such as iOS®, ANDROID®, WINDOWS®, or other operating systems. In some implementations, the controller 2506 may be implemented as part of the processor 2502.

In some implementations, the NE 2500 may include at least one transceiver 2508. In some other implementations, the NE 2500 may have more than one transceiver 2508. The transceiver 2508 may represent a wireless transceiver. The transceiver 2508 may include one or more receiver chains 2510, one or more transmitter chains 2512, or a combination thereof.

A receiver chain 2510 may be configured to receive signals (e.g., control information, data, packets) over a wireless medium. For example, the receiver chain 2510 may include one or more antennas to receive a signal over the air or wireless medium. The receiver chain 2510 may include at least one amplifier (e.g., an LNA) configured to amplify the received signal. The receiver chain 2510 may include at least one demodulator configured to demodulate the receive signal and obtain the transmitted data by reversing the modulation technique applied during transmission of the signal. The receiver chain 2510 may include at least one decoder for decoding the demodulated signal to receive the transmitted data.

A transmitter chain 2512 may be configured to generate and transmit signals (e.g., control information, data, packets). The transmitter chain 2512 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 2512 may also include at least one power amplifier configured to amplify the modulated signal to an appropriate power level suitable for transmission over the wireless medium. The transmitter chain 2512 may also include one or more antennas for transmitting the amplified signal into the air or wireless medium.

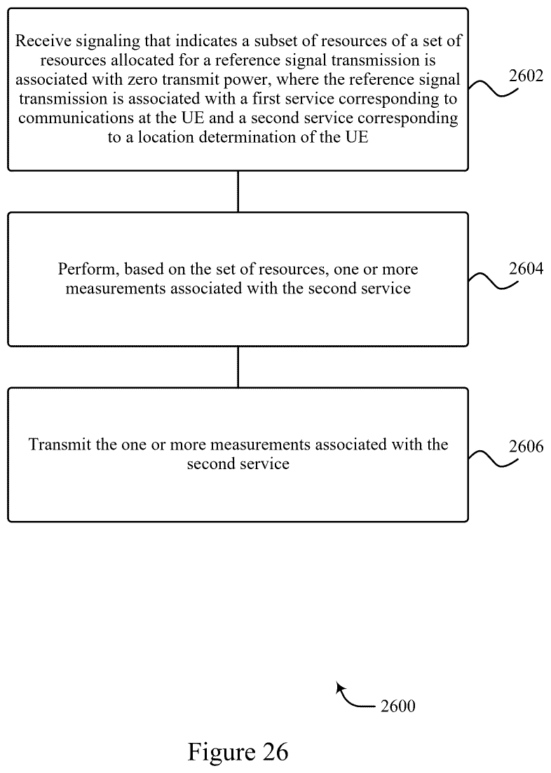

FIG. 26 illustrates a flowchart of a method 2600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 2602, the method may include receiving signaling that indicates a subset of resources of a set of resources allocated for a reference signal transmission is associated with zero transmit power, where the reference signal transmission is associated with a first service corresponding to communications at the UE and a second service corresponding to a location determination of the UE and/or one or more sensing targets. The operations of 2602 may be performed in accordance with examples as described herein. In some implementations, aspects of the operations of 2602 may be performed by a UE as described with reference to FIG. 23.

At 2604, the method may include performing, based on the set of resources, one or more measurements associated with the second service. The operations of 2604 may be performed in accordance with examples as described herein. In some implementations, aspects of the operations of 2604 may be performed by a UE as described with reference to FIG. 23.

At 2606, the method may include transmitting the one or more measurements associated with the second service. The operations of 2606 may be performed in accordance with examples as described herein. In some implementations, aspects of the operations of 2606 may be performed a UE as described with reference to FIG. 23.

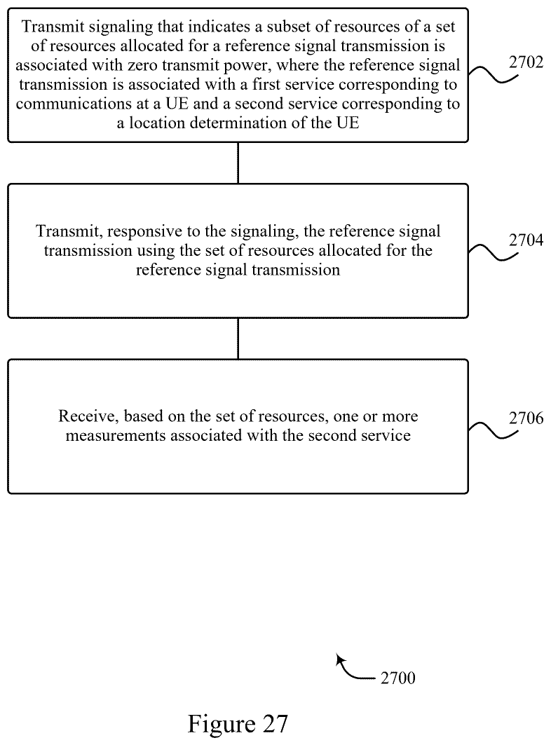

FIG. 27 illustrates a flowchart of a method 2700 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 2702, the method may include transmitting signaling that indicates a subset of resources of a set of resources allocated for a reference signal transmission is associated with zero transmit power, where the reference signal transmission is associated with a first service corresponding to communications at a UE and a second service corresponding to a location determination of the UE and/or one or more sensing targets. The operations of 2702 may be performed in accordance with examples as described herein. In some implementations, aspects of the operations of 2702 may be performed by an NE as described with reference to FIG. 25.

At 2704, the method may include transmitting, responsive to the signaling, the reference signal transmission using the set of resources allocated for the reference signal transmission. The operations of 2704 may be performed in accordance with examples as described herein. In some implementations, aspects of the operations of 2704 may be performed by an NE as described with reference to FIG. 25.

At 2706, the method may include receiving, based on the set of resources, one or more measurements associated with the second service. The operations of 2706 may be performed in accordance with examples as described herein. In some implementations, aspects of the operations of 2706 may be performed an NE as described with reference to FIG. 25.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive signaling that indicates a subset of resources of a plurality of resources allocated for a reference signal transmission is associated with zero transmit power, wherein the reference signal transmission is associated with a first service corresponding to communications at the UE and a second service corresponding to a location determination of the UE;
perform, based at least in part on the plurality of resources, one or more measurements associated with the second service; and
transmit the one or more measurements associated with the second service.

2. The UE of claim 1, wherein the at least one processor is further operable to cause the UE to receive additional signaling that indicates the reference signal transmission is scheduled within respective slots of a plurality of slots in a time domain, wherein the respective slots are associated with a single beam, and wherein the signaling indicates one or more resource elements of the respective slots comprising the subset of resources are associated with the zero transmit power and one or more slots of the plurality of slots comprising the subset of resources are associated with the zero transmit power.

3. The UE of claim 2, wherein at least one of one or more additional resource elements of the respective slots or one or more additional slots of the plurality of slots comprise an additional subset of resources of the plurality of resources that is associated with a non-zero transmit power, wherein the one or more additional resource elements are nonoverlapping with the one or more resource elements and the one or more additional slots are nonoverlapping with the one or more slots.

4. The UE of claim 1, wherein the at least one processor is further operable to cause the UE to receive additional signaling that indicates the reference signal transmission is scheduled across respective slots of a plurality of slots in a time domain, wherein the respective slots are associated with a plurality of beams, and wherein the signaling indicates one or more slots of the respective slots comprising the subset of resources are associated with the zero transmit power.

5. The UE of claim 4, wherein one or more additional slots of the plurality of slots comprise an additional subset of resources of the plurality of resources that is associated with a non-zero transmit power, wherein the one or more additional slots are nonoverlapping with the one or more slots.

6. The UE of claim 1, wherein to receive the signaling, the at least one processor is further operable to cause the UE to transmit an indication of a capability of the UE to support at least one of the reference signal transmission being scheduled within respective slots of a plurality of slots in a time domain or the reference signal transmission being scheduled across the respective slots.

7. The UE of claim 1, wherein the signaling indicates respective priority values corresponding to an order to perform the one or more measurements, wherein the one or more measurements are associated with an angle of departure of the reference signal transmission, and wherein the respective priority values are associated with at least one of respective resources of the plurality of resources, respective subsets of resources of the plurality of resources, or one or more network equipment (NE) associated with the respective resources of the plurality of resources.

8. The UE of claim 1, wherein the at least one processor is further operable to cause the UE to determine respective priority values corresponding to an order to perform the one or more measurements based at least in part on the reference signal transmission comprising a plurality of identifiers, wherein the one or more measurements are associated with an angle of departure of the reference signal transmission, and wherein the respective priority values are associated with at least one of respective resources of the plurality of resources, respective subsets of resources of the plurality of resources, or one or more network equipment (NE) associated with the respective resources of the plurality of resources.

9. The UE of claim 8, wherein the plurality of identifiers comprises a reference signal identifier corresponding to the respective resources, a physical cell identity (PCI) corresponding to the respective resources, a cell global identity (CGI) identifier corresponding to the respective resources, a channel state information-reference signal (CSI-RS) resource identifier, an absolute radio frequency channel number (ARFCN), and a resource set identifier.

10. The UE of claim 1, wherein the reference signal transmission is from a first network equipment (NE), and wherein the at least one processor is further operable to cause the UE to:
perform, based at least in part on an additional plurality of resources allocated for an additional reference signal transmission from a second NE, one or more additional measurements, wherein a subset of resources of the additional plurality of resources is within a threshold duration from the subset of resources of the plurality of resources, and wherein the subset of resources of the additional plurality of resources is associated with a non-zero transmit power; and
transmit, to the second NE, the one or more additional measurements.

11. The UE of claim 1, wherein the first service comprises at least one of a channel estimation service or a beamforming service, and wherein the second service comprises at least one of a positioning service corresponding to a position of one or more target UEs or a sensing service corresponding to one or more objects in an environment of the UE or in an absence of any UE.

12. The UE of claim 1, wherein the reference signal transmission comprises at least one of a channel state information-reference signal (CSI-RS) transmission, a synchronization signal block (SSB) transmission, or a sounding reference signal (SRS) transmission.

13. The UE of claim 1, wherein the signaling is received from a network equipment (NE), and wherein the signaling comprises at least one of downlink control information (DCI), radio resource control (RRC) signaling, a medium access control-control element (MAC-CE), a long-term evolution positioning protocol (LPP) signaling, a new radio positioning protocol (NRPPa) signaling, a new sensing protocol signaling, or an NE to NE interface protocol signaling.

14. A method performed by a user equipment (UE), the method comprising:
receiving signaling that indicates a subset of resources of a plurality of resources allocated for a reference signal transmission is associated with zero transmit power, wherein the reference signal transmission is associated with a first service corresponding to communications at the UE and a second service corresponding to a location determination of the UE;
performing, based at least in part on the plurality of resources, one or more measurements associated with the second service; and
transmitting the one or more measurements associated with the second service.

15. A network equipment (NE) for wireless communication, comprising:
at least one memory; and
at least one processor coupled with the at least one memory and operable to cause the NE to:
transmit signaling that indicates a subset of resources of a plurality of resources allocated for a reference signal transmission is associated with zero transmit power, wherein the reference signal transmission is associated with a first service corresponding to communications at a user equipment (UE) and a second service corresponding to a location determination of the UE;
transmit, responsive to the signaling, the reference signal transmission using the plurality of resources allocated for the reference signal transmission; and
receive, based at least in part on the plurality of resources, one or more measurements associated with the second service.

16. The NE of claim 15, wherein the at least one processor is further operable to cause the NE to select, prior to transmitting the signaling, at least one of to transmit the reference signal transmission within respective slots of a plurality of slots in a time domain or to transmit the reference signal transmission across the respective slots.

17. The NE of claim 15, wherein the at least one processor is further operable to cause the NE to transmit additional signaling that indicates the reference signal transmission is scheduled within respective slots of a plurality of slots in a time domain, wherein the respective slots are associated with a single beam, and wherein the signaling indicates one or more resource elements of the respective slots comprising the subset of resources are associated with the zero transmit power and one or more slots of the plurality of slots comprising the subset of resources are associated with the zero transmit power.

18. The NE of claim 15, wherein the at least one processor is further operable to cause the NE to transmit additional signaling that indicates the reference signal transmission is scheduled across respective slots of a plurality of slots in a time domain, wherein the respective slots are associated with a plurality of beams, and wherein the signaling indicates one or more slots of the respective slots comprising the subset of resources are associated with the zero transmit power.

19. The NE of claim 15, wherein to transmit the signaling, the at least one processor is further operable to cause the NE to receive, from the UE, an indication of a capability of the UE to support at least one of the reference signal transmission being scheduled within respective slots of a plurality of slots in a time domain or the reference signal transmission being scheduled across the respective slots.

20. A method performed by a network equipment (NE), the method comprising:
transmitting signaling that indicates a subset of resources of a plurality of resources allocated for a reference signal transmission is associated with zero transmit power, wherein the reference signal transmission is associated with a first service corresponding to communications at a user equipment (UE) and a second service corresponding to a location determination of the UE;
transmitting, responsive to the signaling, the reference signal transmission using the plurality of resources allocated for the reference signal transmission; and
receiving, based at least in part on the plurality of resources, one or more measurements associated with the second service.
